(19) United States
(12) Patent Application Publication
(10) Pub. No.: US 2019/0108191 A1
(43) Pub. Date: Apr. 11, 2019

(54) Affective response-based recommendation of a repeated experience

(71) Applicant: Affectomatics Ltd., Kiryat Tivon (IL)

(72) Inventors: Ari M. Frank, Haifa (IL); Gil Thieberger, Kiryat Tivon (IL)

(73) Assignee: Affectomatics Ltd., Kiryat Tivon (IL)

(21) Appl. No.: 16/210,282

(22) Filed: Dec. 5, 2018

Related U.S. Application Data
(63) Continuation-in-part of application No. 14/833,035, filed on Aug. 21, 2015, now Pat. No. 10,198,505.
Application No. 14/833,035 is a continuation-in-part of application No. 15/051,892, filed on Feb. 24, 2016.
Application No. 15/051,892 is a continuation-in-part of application No. 14/833,035, filed on Aug. 21, 2015, now Pat. No. 10,198,505.
Application No. 15/051,892 is a continuation-in-part of application No. 15/010,412, filed on Jan. 29, 2016.
(60) Provisional application No. 62/040,345, filed on Aug. 21, 2014.
(60) Provisional application No. 62/040,355, filed on Aug. 21, 2014.
(60) Provisional application No. 62/040,358, filed on Aug. 21, 2014.
(60) Provisional application No. 62/040,345, filed on Aug. 21, 2014.
(60) Provisional application No. 62/040,355, filed on Aug. 21, 2014.
(60) Provisional application No. 62/040,358, filed on Aug. 21, 2014.
(60) Provisional application No. 62/109,456, filed on Jan. 29, 2015.
(60) Provisional application No. 62/185,304, filed on Jun. 26, 2015.

(51) Int. Cl. G06F 16/9535; G06F 11/34; G06F 11/30

(52) U.S. Cl. CPC G06F 16/9535; G06F 11/3006; G06F 11/3409

(57) ABSTRACT

Described herein are systems, methods and computer-readable media for recommending a repeated experience. One embodiment includes collecting a subset of the measurements that includes measurements of at least five of the users who had an experience; each measurement of a user is associated with a value indicative of an extent to which the user had previously experienced the experience. Calculating parameters of a function based on the measurements in the subset and their associated values, where the function describes, for different extents to which the experience had been previously experienced, an expected affective response to experiencing the experience again. And responsive to determining that an expected affective response to experiencing the experience again after having experiencing it for at least a certain extent reaches a threshold, recommending the experience.

### CROSS-REFERENCE TO RELATED APPLICATIONS

This Application is a Continuation-In-Part of U.S. application Ser. No. 14/833,035, filed Aug. 21, 2015, which claims the benefits of U.S. Provisional Patent Application Ser. No. 62/040,345, filed on Aug. 21, 2014, and U.S. Provisional Patent Application Ser. No. 62/040,355, filed on Aug. 21, 2014, and U.S. Provisional Patent Application Ser. No. 62/040,358, filed on Aug. 21, 2014.

This Application is a Continuation-In-Part of U.S. application Ser. No. 15/051,892, filed Feb. 24, 2016, which is a Continuation-In-Part of U.S. application Ser. No. 14/833,035, filed Aug. 21, 2015, which claims the benefits of U.S. Provisional Patent Application Ser. No. 62/040,345, filed on Aug. 21, 2014, and U.S. Provisional Patent Application Ser. No. 62/040,355, filed on Aug. 21, 2014, and U.S. Provisional Patent Application Ser. No. 62/040,358, filed on Aug. 21, 2014. U.S. Ser. No. 15/051,892 is also a Continuation-In-Part of U.S. application Ser. No. 15/010,412, filed Jan. 29, 2016, which claims the benefits of U.S. Provisional Patent Application Ser. No. 62/109,456, filed on Jan. 29, 2015, and U.S. Provisional Patent Application Ser. No. 62/185,304, filed on Jun. 26, 2015.

### BACKGROUND

Users may have various experiences in their day-to-day lives, which can be of various types. Some examples of experiences include utilizing products, playing games, participating in activities, receiving a treatment, and more. Some of the experiences may be repeated experiences, i.e., experiences that the users may have multiple times (e.g., a game may be played on multiple days and a product may be used multiple times). For different experiences, repeating the experience multiple times may have different effects on users. For example, a user may quickly tire from a first game after playing it a few times, but another game may keep the same user riveted for tens of hours of gameplay. Having such knowledge about how a user is expected to feel about a repeated experience may help determine what experience a user should have and/or how often to repeat it.

### SUMMARY

Some embodiments described herein include systems, methods, and/or computer-readable media that may be utilized to learn parameters of a function that describes a relationship between an extent to which an experience had been previously experienced, and an expected affective response to experiencing it again. The function may then be utilized to recommend experiences to a user. In some embodiments, a function describing expected affective response to an experience based an extent to which the experience had been previously experienced may be considered to behave like a function of the form ƒ(e)=v, where e represents an extent to which the experience had already been experienced and v represents the value of the expected affective response when having the experience again (after it had already been experienced to the extent e). In one example, v may be a value indicative of the extent the user is expected to have a certain emotional response, such as being happy, relaxed, and/or excited when having the experience again.

Various approaches may be utilized, in embodiments described herein, to learn parameters of the function mentioned above from the measurements of affective response. In some embodiments, the parameters of the function may be learned utilizing an algorithm for training a predictor. For example, the algorithm may be one of various known machine learning-based training algorithms that may be used to create a model for a machine learning-based predictor that may be used to predict target values of the function (e.g., v mentioned above) for different domain values of the function (e.g., e mentioned above). Some examples of algorithmic approaches that may be used involve training algorithms for predictors that use regression models, neural networks, nearest neighbor predictors, support vector machines for regression, and/or decision trees. In other embodiments, the parameters of the function may be learned using a binning-based approach. For example, the measurements (or values derived from the measurements) may be placed in bins based on their corresponding domain values. Thus, for example, each training sample of the form (e,v), the value of e may be used to determine in which bin to place the sample. After the training data is placed in bins, a representative value is computed for each bin; this value is computed from the v values of the samples in the bin, and typically represents some form of score for the experience.

Some aspects of this disclosure involve learning personalized functions, such as the one described above, for different users utilizing profiles of the different users. Given a profile of a certain user, similarities between the profile of the certain user and profiles of other users are used to select and/or weight measurements of affective response of other users, from which parameters of a function are learned. Thus, different users may have different functions created for them, which are learned from the same set of measurements of affective response.

Some aspects of this disclosure involve obtaining measurements of affective response of users and utilizing the measurements to generate crowd-based results, such as learning parameters of the function that describes a relationship between an extent to which the experience had been previously experienced, and an expected affective response to experiencing it again. In some embodiments, the measurements of affective response of the users are collected with one or more sensors coupled to the users. A sensor may be coupled to a user in various ways. For example, a sensor may be a device that is implanted in the user's body, attached to the user's body, embedded in an item carried and/or worn by the user (e.g., a sensor may be embedded in a smartphone, smartwatch, and/or clothing), and/or remote from the user (e.g., a camera taking images of the user). In one example, a sensor coupled to a user may be used to obtain a value that is indicative of a physiological signal of the user (e.g., a heart rate, skin temperature, or a level of certain brainwave activity). In another example, a sensor coupled to a user may be used to obtain a value indicative of a behavioral cue of the user (e.g., a facial expression, body language, or a level of stress in the user's voice). In some embodiments, measurements of affective response of a user may be used to determine how the user feels while having an experience. In one example, the measurements may be indicative of the extent the users feel one or more of the following emotions: pain, anxiety, annoyance, stress, aggression, aggravation, fear, sadness, drowsiness, apathy, anger, happiness, contentment, calmness, attentiveness, affection, and excitement.

This disclosure describes a wide range of types of experiences for which functions of affective response may be learned. Following are some non-limiting examples of what an “experience” in this disclosure may involve. In some embodiments described herein, having an experience involves one or more of the following: visiting a certain location, visiting a certain virtual environment, partaking in a certain activity, having a social interaction, receiving a certain service, utilizing a certain product, dining at a certain restaurant, traveling in vehicle of a certain type, utilizing an electronic device of a certain type, receiving a certain treatment, and wearing an apparel item of a certain type.

Various embodiments described herein utilize systems whose architecture includes a plurality of sensors and a plurality of user interfaces. This architecture supports various forms of crowd-based recommendation systems in which users may receive information, such as scores, recommendations and/or alerts, which are determined based on measurements of affective response of users (and/or based on results obtained from measurements of affective response, such as the functions mentioned above). In some embodiments, being crowd-based means that the measurements of affective response are taken from a plurality of users, such as at least three, five, ten, one hundred, or more users. In such embodiments, it is possible that the recipients of information generated from the measurements may not be the same people from whom the measurements were taken.

Crowd-based recommendation systems described herein may confer several advantages that are available in current implementations of recommender systems. In particular, the fact that the measurements of affective response used herein may be collected unobtrusively and over large periods of time from a large number of users means that the crowd-based recommendation systems may provide accurate results that are less prone to manipulation than current approaches. For example, current recommendation systems are often based on manual reviews, sales figures, and/or digital media, which are all susceptible to manipulation and are often only available to a limited extent. Measurements of affective response may be collected on a much larger scale, and are generally more difficult to manipulate (e.g., compared to a written review or released sale figures). Thus, embodiments described herein can provide a novel source of data and enable recommender systems (e.g., e-commerce sites or software agents) to provide better recommendations to users.

### BRIEF DESCRIPTION OF THE DRAWINGS

The embodiments are herein described by way of example only, with reference to the following drawings:

FIG. 1a illustrates an embodiment of a system configured to learn a function that describes, for different extents to which the experience had been previously experienced, an expected affective response to experiencing the experience again;

FIG. 1b illustrates an example of a representation of a function that describes changes in the excitement from playing a game over the course of many hours;

FIG. 2 different personalized functions describing a relationship between an extent to which an experience had been previously experienced and affective response to experiencing it again;

FIG. 3 illustrates an example of an architecture that includes sensors and user interfaces that may be utilized to compute and report crowd-based results;

FIG. 4a illustrates a user and a sensor;

FIG. 4b illustrates a user and a user interface;

FIG. 4c illustrates a user, a sensor, and a user interface;

FIG. 5 illustrates a system configured to compute a score for a certain experience;

FIG. 6 illustrates a system configured to compute scores for experiences;

FIG. 7a illustrates one embodiment in which a collection module does at least some, if not most, of the processing of measurements of affective response of a user;

FIG. 7b illustrates one embodiment in which a software agent does at least some, if not most, of the processing of measurements of affective response of a user;

FIG. 8 illustrates one embodiment of the Emotional State Estimator (ESE);

FIG. 9 illustrates one embodiment of a baseline normalizer;

FIG. 10a illustrates one embodiment of a scoring module that utilizes a statistical test module and personalized models to compute a score for an experience;

FIG. 10b illustrates one embodiment of a scoring module that utilizes a statistical test module and general models to compute a score for an experience;

FIG. 10c illustrates one embodiment in which a scoring module utilizes an arithmetic scorer in order to compute a score for an experience;

FIG. 11 illustrates one embodiment in which measurements of affective response are provided via a network to a system that computes personalized scores for experiences;

FIG. 12 illustrates a system configured to utilize comparison of profiles of users to compute personalized scores for an experience based on measurements of affective response of the users;

FIG. 13 illustrates a system configured to utilize clustering of profiles of users to compute personalized scores for an experience based on measurements of affective response of the users;

FIG. 14 illustrates a system configured to utilize comparison of profiles of users and/or selection of profiles based on attribute values, in order to compute personalized scores for an experience;

FIG. 15a illustrates one embodiment in which a machine learning-based trainer is utilized to learn a function representing an expected affective response (y) that depends on a numerical value (x);

FIG. 15b illustrates one embodiment in which a binning approach is utilized for learning function parameters; and

FIG. 16 illustrates a computer system architecture that may be utilized in various embodiments in this disclosure.

### DETAILED DESCRIPTION

A measurement of affective response of a user is obtained by measuring a physiological signal of the user and/or a behavioral cue of the user. A measurement of affective response may include one or more raw values and/or processed values (e.g., resulting from filtration, calibration, and/or feature extraction). Measuring affective response may be done utilizing various existing, and/or yet to be invented, measurement devices such as sensors. Optionally, any device that takes a measurement of a physiological signal of a user and/or of a behavioral cue of a user may be considered a sensor. A sensor may be coupled to the body of a user in various ways. For example, a sensor may be a device that is implanted in the user's body, attached to the user's body, embedded in an item carried and/or worn by the user (e.g., a sensor may be embedded in a smartphone, smartwatch, and/or clothing), and/or remote from the user (e.g., a camera taking images of the user). Additional information regarding sensors may be found in this disclosure at least in the section “Sensors and Measurements of Affective Response”.

Herein, “affect” and “affective response” refer to physiological and/or behavioral manifestation of an entity's emotional state. The manifestation of an entity's emotional state may be referred to herein as an “emotional response”, and may be used interchangeably with the term “affective response”. Affective response typically refers to values obtained from measurements and/or observations of an entity, while emotional states are typically predicted from models and/or reported by the entity feeling the emotions. For example, according to how terms are typically used herein, one might say that a person's emotional state may be determined based on measurements of the person's affective response. In addition, the terms “state” and “response”, when used in phrases such as “emotional state” or “emotional response”, may be used herein interchangeably. However, in the way the terms are typically used, the term “state” is used to designate a condition which a user is in, and the term “response” is used to describe an expression of the user due to the condition the user is in and/or due to a change in the condition the user is in.

It is to be noted that as used herein in this disclosure, a “measurement of affective response” may comprise one or more values describing a physiological signal and/or behavioral cue of a user which were obtained utilizing a sensor. Optionally, this data may be also referred to as a “raw” measurement of affective response. Thus, for example, a measurement of affective response may be represented by any type of value returned by a sensor, such as a level of electrical activity of the heart, a brainwave pattern, an image of a facial expression, etc.

Additionally, as used herein, a “measurement of affective response” may refer to a product of processing of the one or more values describing a physiological signal and/or behavioral cue of a user (i.e., a product of the processing of the raw measurements data). The processing of the one or more values may involve one or more of the following operations: normalization, filtering, feature extraction, image processing, compression, encryption, and/or any other techniques described further in the disclosure and/or that are known in the art and may be applied to measurement data. Optionally, a measurement of affective response may be a value that describes an extent and/or quality of an affective response (e.g., a value indicating positive or negative affective response such as a level of happiness on a scale of 1 to 10, and/or any other value that may be derived from processing of the one or more values).

It is to be noted that since both raw data and processed data may be considered measurements of affective response, it is possible to derive a measurement of affective response (e.g., a result of processing raw measurement data) from another measurement of affective response (e.g., a raw value obtained from a sensor). Similarly, in some embodiments, a measurement of affective response may be derived from multiple measurements of affective response. For example, the measurement may be a result of processing of the multiple measurements.

In some embodiments, a measurement of affective response may be referred to as an “affective value” which, as used in this disclosure, is a value generated utilizing a module, function, estimator, and/or predictor based on an input comprising the one or more values describing a physiological signal and/or behavioral cue of a user, which are in either a raw or processed form, as described above. As such, in some embodiments, an affective value may be a value representing one or more measurements of affective response. Optionally, an affective value represents multiple measurements of affective response of a user taken over a period of time. An affective value may represent how the user felt while utilizing a product (e.g., based on multiple measurements taken over a period of an hour while using the product), or how the user felt during a vacation (e.g., the affective value is based on multiple measurements of affective response of the user taken over a week-long period during which the user was on the vacation).

In some embodiments, measurements of affective response of a user are primarily unsolicited, i.e., the user is not explicitly requested to initiate and/or participate in the process of measuring. Thus, measurements of affective response of a user may be considered passive in the sense that it is possible that the user will not be notified when the measurements are taken, and/or the user may not be aware that measurements are being taken. Additional discussion regarding measurements of affective response and affective values may be found in this disclosure at least in Section 6 (“Measurements of Affective Response”) in U.S. application Ser. No. 15/051,892, published as U.S. 2016/0170996, which is incorporated herein by reference in its entirety.

Herein, when it is stated that a score and/or function parameters are computed based on measurements of affective response, it means that the score and/or function parameters have their value set based on the measurements and possibly other measurements of affective response and/or other types of data. For example, a score computed based on a measurement of affective response may also be computed based on other data that is used to set the value of the score (e.g., a manual rating, data derived from semantic analysis of a communication, and/or a demographic statistic of a user). Additionally, computing the score may be based on a value computed from a previous measurement of the user (e.g., a baseline affective response value described further below).

An experience, as used herein, involves something that happens to a user and/or that the user does, which may affect the physiological and/or emotional state of the user in a manner that may be detected by measuring the affective response of the user. An experience is typically characterized as being of a certain type. Examples of types of events include things like being in certain locations, traveling in certain routes, partaking in certain activities, receiving certain services from a service provider, utilizing certain products, and more. Various properties of experiences are discussed in this disclosure further below (in the section “Experiences and Events”) and in further detail in Section 7 (“Experiences”) in U.S. application Ser. No. 15/051,892, published as U.S. 2016/0170996, which is incorporated herein by reference in its entirety.

In some embodiments, an experience is something a user actively chooses and is aware of. For example, the user chooses to take a vacation. While in other embodiments, an experience may be something that happens to the user, of which the user may not be aware. A user may have the same experience multiple times during different periods. For example, the experience of being at school may happen to certain users almost every weekday except for holidays. Each time a user has an experience, this may be considered an “event”. Each event has a corresponding experience and a corresponding user (who had the corresponding experience). Additionally, an event may be referred to as being an “instantiation” of an experience and the time during which an instantiation of an event takes place may be referred to herein as the “instantiation period” of the event. That is, the instantiation period of an event is the period of time during which the user corresponding to the event had the experience corresponding to the event. Optionally, an event may have a corresponding measurement of affective response, which is a measurement of the corresponding user to having the corresponding experience (during the instantiation of the event or shortly after it). For example, a measurement of affective response of a user that corresponds to an experience of being at a location may be taken while the user is at the location and/or shortly after that time. Further details regarding events and their identification may be found in this disclosure further below (in the section “Experiences and Events”) and in further detail in Section 8 (“Events”) and in Section 9 (“Identifying Events”) in U.S. application Ser. No. 15/051,892, published as U.S. 2016/0170996, which is incorporated herein by reference in its entirety.

Various embodiments described in this disclosure utilize approaches that may be characterized as involving machine learning methods. Herein, “machine learning” methods refer to learning from examples using one or more approaches. Optionally, the approaches may be considered supervised, semi-supervised, and/or unsupervised methods. Examples of machine learning approaches include: decision tree learning, association rule learning, regression models, nearest neighbors classifiers, artificial neural networks, deep learning, inductive logic programming, support vector machines, clustering, Bayesian networks, reinforcement learning, representation learning, similarity and metric learning, sparse dictionary learning, genetic algorithms, rule-based machine learning, and/or learning classifier systems.

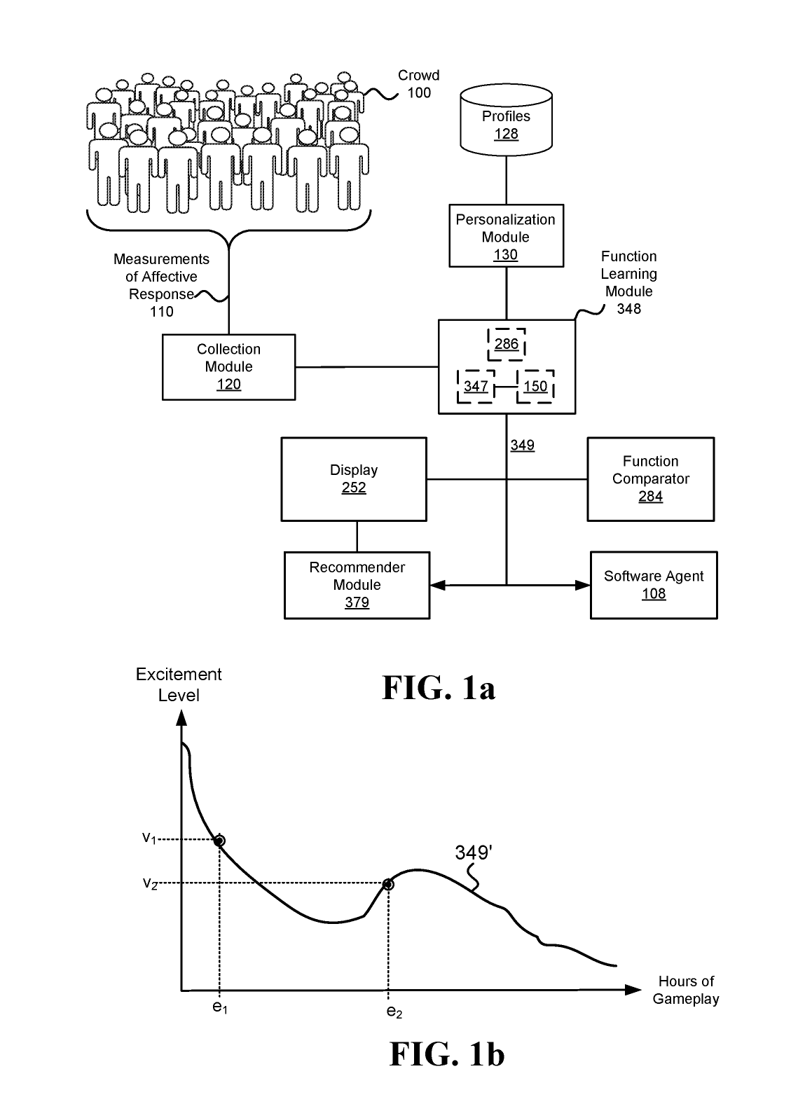

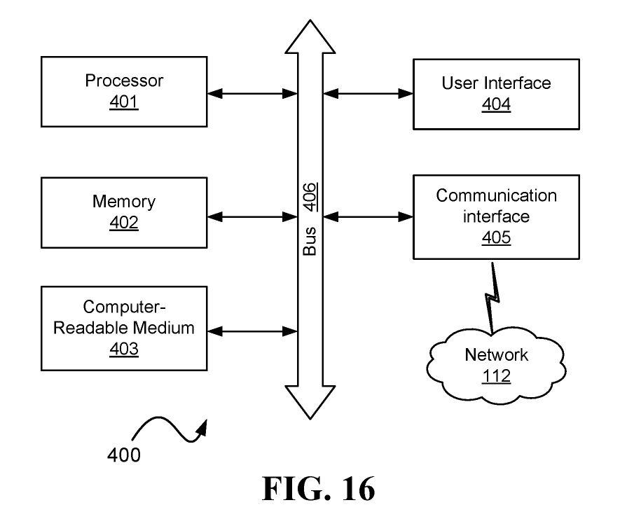

FIG. 1a illustrates a system configured to learn a function that describes, for different extents to which an experience had been previously experienced, an expected affective response to experiencing the experience again. The system includes at least sensors and a computer (such as computer 400 illustrated in FIG. 16). In some embodiments, the computer may be used to implement various computer implemented modules such as collection module 120, function learning module 348, and recommender module 379. The computer may optionally be used to implement additional modules, such as personalization module 130 or function comparator 284. Optionally, the system may include additional components such as display 252.

The collection module 120 is configured, in one embodiment, to receive measurements 110 of affective response of users belonging to crowd 100. The measurements 110 are taken utilizing sensors coupled to the users (as discussed in more detail at least in the section “Sensors and Measurements of Affective Response”). In one embodiment, a subset of the measurements 110 includes measurements of affective response of at least five of the users and each measurement of a user belonging to the subset is taken by a sensor coupled to the user while the user has the experience and/or shortly thereafter. In one example, “shortly thereafter” may refer to taking a measurement within up to ten minutes after having the experience. In another example, such as when an experience involves a treatment, “shortly thereafter” may refer to several hours after having the experience. Optionally, the subset may include measurements of some other minimal number of users, such as at least ten of the users from the crowd 100. Optionally, each measurement of a user may be normalized with respect to a prior measurement of the user, taken before the user started having the experience and/or a baseline value of the user. Optionally, each measurement belonging to the subset is associated with a value indicative of the extent to which the user had already previously experienced the experience, before experiencing it again when the measurement was taken. In some embodiments, the measurements received by the collection module 120 include multiple measurements of a user who had the experience, where each of the multiple measurements of the user corresponds to a different event in which the user had the experience.

Depending on the embodiment, values indicative of the extent to which a user had already experienced an experience may comprise various types of values. The following are some non-limiting examples of what the “extent” may mean, other types of values may also be used in some of the embodiments described herein. In one embodiment, the value of the extent to which a user had previously experienced the experience is a value indicative of the time that had elapsed since the user first had the experience (or since some other incident that may be used for reference). For example, the value may be indicative of how long a user has been going to a certain gym, the date a user started playing a certain game, and/or when the user purchased a certain product. In another embodiment, the value indicative of the extent to which a user had previously experienced the experience is indicative of a number of times the user had already had the experience (e.g., the number of times a user received a certain type of treatment). In yet another embodiment, the value indicative of the extent to which a user had previously experienced the experience is indicative of a number of hours spent by the user having the experience since having it for the first time (or since some other incident that may be used for reference).

In some embodiments, the measurements 110 include measurements of users who had the experience after having previously experienced the experience to different extents. In one example, the measurements 110 include a first measurement of a first user, taken after the first user had already experienced the experience to a first extent, and a second measurement of a second user, taken after the second user had already experienced the experience to a second extent. In this example, the second extent is significantly greater than the first extent. Optionally, by “significantly greater” it may mean that the second extent is at least 25% greater than the first extent (e.g., the second extent represents 15 hours of prior playing of a game and the first extent represents 10 hours of prior playing of the game). In some cases, being “significantly greater” may mean that the second extent is at least double the first extent (or even greater than that).

A more comprehensive discussion of how the collection module 120 may collect the subset of measurements from among the measurements 110 is provided in this disclosure in the section “Crowd-Based Applications” and is discussed in further detail in section 13 (“Collecting Measurements”), in U.S. application Ser. No. 15/051,892, published as U.S. 2016/0170996, which is incorporated herein by reference in its entirety.

In one embodiment, the collection module 120 collects at least some of the measurements in the subset as follows. For each measurement of a user from among the at least some measurements, the collection module 120: (i) receives information indicative of when the user had the experience from at least one of a financial account of a user and/or from a social media account of the user; and (ii) selects, based on the information, at least one measurement of affective response of the user, from among the measurements 110, to include in the subset of measurements utilized by the function learning module 348, as described below.

In another embodiment, the collection module 120 sends to software agents operating on behalf of one or more of the users a request for measurements of affective response of users who had the experience. The collection module 120 then includes in the subset measurements of affective response of the one or more the users, which were sent by the software agents because the software agents determined these measurements satisfy the request.

The function learning module 348 is configured, in one embodiment, to receive data comprising the subset comprising the measurements of the at least five of the users and the associated values of the measurements in the subset, and to utilize the data to learn function 349. Optionally, the function 349 describes, for different extents to which the experience had been previously experienced, an expected affective response to experiencing the experience again. Optionally, the function 349 may be described via its parameters, thus, learning the function 349, may involve learning the parameters that describe the function 349. Optionally, the function 349 may be learned using one or more of the approaches described further below.

In one embodiment, each measurement of a user, from among the measurements in the subset, was taken while the user had the experience. In this embodiment, the function 349 describes, for different extents to which the experience had been previously experienced, an expected affective response while having the experience again.

In another embodiment, each measurement of a user, from among the measurements in the subset, was taken at least ten minutes after the user had the experience. In this embodiment, the function 349 may describe, for different extents to which the experience had been previously experienced, an expected affective response after having the experience again. For example, the subset of measurements may include measurements taken after receiving a treatment and the function may describe how a user feels after receiving the treatment.

In some embodiments, the function 349 may be considered to perform a computation of the form ƒ(e)=v, where the input e is an extent to which an experience had already been experienced, and the output v is an expected affective response (to having the experience again after it had already been experienced to the extent e). Optionally, the output of the function 349 may be expressed as an affective value. In one example, the output of the function 349 is an affective value indicative of an extent of feeling at least one of the following emotions: pain, anxiety, annoyance, stress, aggression, aggravation, fear, sadness, drowsiness, apathy, anger, happiness, contentment, calmness, attentiveness, affection, and excitement. In some embodiments, the function 349 is not a constant function that assigns the same output value to all input values. Optionally, the function 349 is at least indicative of values v₁ and v₂ of expected affective response corresponding to having the experience again after it had been experienced before to the extents e₁ and e₂, respectively. That is, the function 349 is such that there are at least two values, e₁ and e₂, for which ƒ(e₁)=v₁ and ƒ(e₂)=v₂. And additionally, e₁≠e₂ and v₁≠v₂. Optionally, e₂ is at least 25% greater than e₁. FIG. 1b illustrates an example of a representation of the function 349 with an example of the values v₁ and v₂ at the corresponding respective extents e₁ and e₂. The figure illustrates changes in the excitement from playing a game over the course of many hours. The plot 349′ illustrates how initial excitement in the game withers, until some event like discovery of new levels increases interest for a while, but following that, the excitement continues to decline.

Following is a description of different configurations of the function learning module 348 that may be used to learn the function 349. Additional details about the function learning module 348 may be found in this disclosure at least in the section “Learning Function Parameters”, which appears further below.

In one embodiment, the function learning module 348 utilizes machine learning-based trainer 286 to learn parameters of the function 349. Optionally, the machine learning-based trainer 286 utilizes the subset comprising the measurements of the at least five users to train a model for a predictor that is configured to predict a value of affective response of a user based on an input indicative of an extent to which the user had already experienced the experience. In one example, each measurement of the user taken while having the experience again, after having experienced it before to an extent e, is converted to a sample (e,v), which may be used to train the predictor (here v is an affective value determined based on the measurement). Optionally, when the trained predictor is provided inputs indicative of the extents e₁ and e₂ (mentioned above), the predictor utilizes the model to predict the values v₁ and v₂, respectively. Optionally, the model comprises parameters of at least one of the following: a regression model, a model utilized by a neural network, a nearest neighbor model, a model for a support vector machine for regression, and a model utilized by a decision tree. Optionally, the parameters of the function 349 comprise the parameters of the model and/or other data utilized by the predictor.

In an alternative embodiment, the function learning module 348 may utilize binning module 347, which is configured, in this embodiment, to assign a measurement of a user to a bin from among a plurality of bins based on the extent to which the user had experienced the experience before the measurement was taken. Additionally, in this embodiment, the function learning module 348 may utilize scoring module 150 to compute a plurality of scores corresponding to the plurality of bins. A score corresponding to a bin is computed based on the measurements assigned to the bin which comprise measurements of more than one user, from among the at least five of the users. Optionally, with respect to the values e₁, e₂, v₁, and v₂ mentioned above, e₁ falls within a range of extents corresponding to a first bin, e₂ falls within a range of extents corresponding to a second bin, which is different from the first bin, and the values v₁ and v₂ are based on the scores corresponding to the first and second bins, respectively. Additional details regarding binning are provided herein in the section “Learning Function Parameters”. Additional details regarding scoring and calculation of scores using the scoring module 150 is provided herein in the section “Crowd-Based Applications” and the section “Scoring and Personalization”.

In one example, the experience related to the function 349 involves playing a game. In this example, the plurality of bins may correspond to various extents of previous game play which are measured in hours that the game has already been played. For example, the first bin may contain measurements taken when a user only played the game for 0-5 hours, the second bin may contain measurements taken when the user already played 5-10 hours, etc. In another example, the experience related to the function 349 involves taking a yoga class. In this example, the plurality of bins may correspond to various extents of previous yoga classes that a user had. For example, the first bin may contain measurements taken during the first week of yoga class, the second bin may contain measurements taken during the second week of yoga class, etc.

Users may have various types of experiences for which embodiments described herein may calculate parameters of the function 349 using the system illustrated in FIG. 1a. The following are a few examples of such experiences.

Game—In one embodiment, the experience involves playing a game, the subset comprises measurements of affective response taken while the at least five of the users played the game, and the function 349 describes, for different extents of having previously played the game, an expected affective response to playing the game again.

Device—In one embodiment, the experience involves utilizing a device (e.g., a tool or an appliance), the subset comprises measurements of affective response taken while the at least five of the users utilized the device, and the function 349 describes, for different extents of having previously utilized the device, an expected affective response to utilizing the device again.

Apparel Item—In one embodiment, the experience involves wearing an apparel item, the subset includes measurements of affective response taken while the at least five of the users wore the apparel item, and the function 349 describes, for different extents of having previously worn the apparel item, an expected affective response to wearing the apparel item again.

Activity—In one embodiment, the experience involves an activity involving at least one of a certain physical exercise session and a certain biofeedback session, the subset includes measurements of affective response the at least five of the users taken after they had the activity, and the function 349 describes, for different extents of having performed the activity, an expected affective response after having performed the activity again.

Visiting a Location—In one embodiment, the experience involves visiting a location such as a bar, night club, vacation destination, and/or a park. In this embodiment, the function 349 describes a relationship between the number of times a user previously visited a location, and the affective response corresponding to visiting the location again. In one example, the function 349 may describe to what extent a user feels relaxed and/or happy (e.g., on a scale from 1 to 10) when returning to the location again.

The function 349 may be used, in some embodiments, to make recommendations for a user. Optionally, making the recommendation may be done by the recommender module 379. Optionally, the recommendation of the experience is done by a software agent (which may optionally utilize the recommender module 379), such as software agent 108. Optionally, the recommendation is presented on the display 252, which may be a display of a device of the user, such as a smartphone, a smartwatch, or an extended reality display (i.e., a display of an augmented/virtual/mixed reality device). In one example, recommender module 379 may provide a user with a suggestion to have the experience based on results obtained using the parameters of the function 349. Optionally, recommending the experience to the user involves selecting the experience for the user to have, such that unless the user takes explicit action to counter the selection, the user will be provided with the experience. In one example, the software agent 108 may select the experience for the user (e.g., a select a certain treatment for the user) based on results obtained using the parameters of the function 349.

In one embodiment, the computer (e.g., the computer 400 which may be used to implement at least some of the modules illustrated in FIG. 1a) receives an indication of a certain extent to which an experience has been experienced and based on parameters of the function 349 calculates a value indicative of an expected affective response to experiencing the experience again after having experiencing it for at least the certain extent. Responsive to determining that the expected affective response reaches a threshold, the computer recommends the experience to a certain user (e.g., using the recommender module 379). Optionally, reaching the threshold indicates that having the experience again after having had it previously for the certain extent is still expected to achieve a certain affective response. For example, the function 349 may be helpful to determine whether a certain computer game is expected to cause a certain level of excitement after 5, 10, 20, 100, or 200 hours of game play. In this example, the expected level of excitement can be displayed as a graph, which may assist a user to determine whether to choose to start playing the game. In another example, the function 349 may be used to determine how relaxed a user is expected to be after various numbers of sessions of a certain class (e.g., yoga). Thus, the class may be recommended if after a certain number of times it is attended, the results (in terms of expected relaxation) are expected to be at least at a certain threshold level.

In some embodiments, recommending an experience to a user, e.g., by the recommender module 379, involves providing a recommendation in a first or second manner, where in the first manner, the recommender module 379 provides a stronger recommendation for the experience, compared to a recommendation for the experience that the recommender module 379 provides when recommending in the second manner. Various ways in which the first and second manner may differ are described below in the section “Crowd-Based Applications”. Optionally, if the expected affective response reaches a threshold then the experience is recommended in the first manner, otherwise it is recommended in the second manner (or not recommended at all).

Functions computed by the function learning module 348 for different experiences may be compared, in some embodiments. For example, such a comparison may help determine what experience is better in terms of expected affective response after already having had it to a certain extent. Comparison of functions may be done, in some embodiments, utilizing the function comparator 284, which is configured, in one embodiment, to receive descriptions of at least first and second functions that involve having respective first and second experiences, after having had the respective experiences previously to a certain extent. Optionally, a description of a function includes one or more values of parameters calculated by the function learning module 348 for that function. The function comparator 284 is also configured, in this embodiment, to compare the first and second functions and to provide an indication of at least one of the following: (i) the experience, from among the first and second experiences, for which the average affective response to having the respective experience again, after having had it previously at most to the certain extent e, is greatest; (ii) the experience, from among the first and second experiences, for which the average affective response to having the respective experience again, after having had it previously at least to the certain extent e, is greatest; and (iii) the experience, from among the first and second experiences, for which the affective response to having the respective experience again, after having had it previously to the certain extent e, is greatest. Optionally, comparing the first and second functions may involve computing integrals of the functions, as described in more detail herein in the section “Learning Function Parameters”.

In some embodiments, the personalization module 130 may be utilized, by the function learning module 348, to learn parameters of personalized functions for different users utilizing profiles of the different users. Given a profile of a certain user, the personalization module 130 may generate an output indicative of similarities between the profile of the certain user and the profiles from among the profiles 128 of the at least five users. The function learning module 348 may be configured to utilize the output to learn parameters of a personalized function for the certain user (i.e., a personalized version of the function 349), which describes, for different extents to which the experience had been previously experienced, an expected affective response of the certain user to experiencing the experience again.

It is to be noted that personalized functions are not necessarily the same for all users. That is, at least a first certain user and a second certain user, who have different profiles, the function learning module 348 learns parameters of different functions, denoted ƒ₁ and ƒ₂, respectively. In one example, the function ƒ₁ is indicative of values v₁ and v₂ of expected affective response corresponding to having the experience again after it had been previously experienced to extents e₁ and e₂, respectively, and ƒ₂ is indicative of values v₃ and v₄ of expected affective response corresponding to having the experience again after it had been previously experienced to extents the e₁ and e₂, respectively. And additionally, e₁≠e₂, v₁≠v₂, v₁≠v₄, and v₁≠v₃.

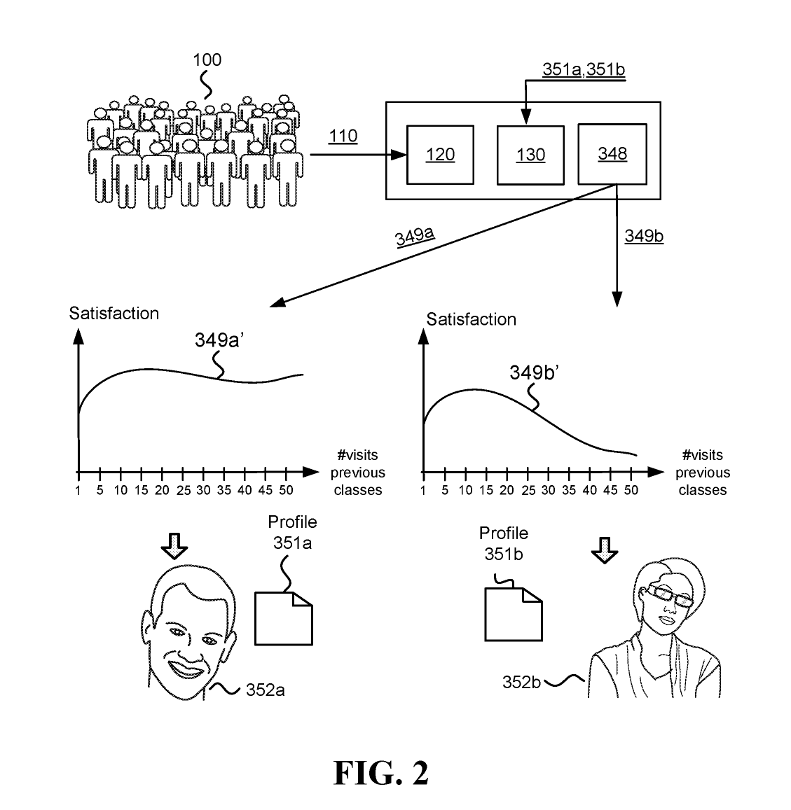

FIG. 2 illustrates such a scenario where personalized functions are generated for different users. In this illustration, first certain user 352a and second certain user 352b have different profiles 351a and 351b, respectively. Given these profiles, the personalization module 130 generates different outputs that are utilized by the function learning module 348 to learn functions 349a and 349b for the first certain user 352a and the second certain user 352b, respectively. The different functions are represented in FIG. 2 by different-shaped graphs for the functions 349a and 349b (graphs 349a′ and 349b′, respectively). The different functions indicate different expected affective response trends for the different users, indicative of values of expected affective response after having previously experienced the experience to different extents. In the figure, the graphs show different trends of expected satisfaction from taking a class (e.g., yoga). In FIG. 2, the affective response of the second certain user 352b is expected to taper off more quickly as the second certain user has the experience more and more times, while the first certain user 352a is expected to have a more positive affective response, which is expected to decrease at a slower rate compared to the second certain user 352b.

Following is a description of steps that may be performed in a method for recommending a repeated experience. The method involves learning parameters of a function such as the function 349 that describes, for different extents to which the experience had been previously experienced, an expected affective response to experiencing the experience again. The steps described below may be part of the steps performed by an embodiment of the system described above (illustrated in FIG. 1a). In some embodiments, instructions for implementing the method may be stored on a computer-readable medium, which may optionally be a non-transitory computer-readable medium. In response to execution by a system including a processor and memory, the instructions cause the system to perform operations that are part of the method.

In one embodiment, the method for recommending a repeated experience includes at least the following steps:

In Step 1, taking, utilizing sensors, measurements of at least five users who had the (repeated) experience; each measurement of a user is associated with a value indicative of an extent to which the user had previously experienced the experience. Optionally, the measurements are received by the collection module 120. Optionally, Step 1 may involve taking multiple measurements of a user that had the experience, corresponding to different events in which the user had the experience.

In Step 2, calculating parameters of a function based on the measurements received in Step 1 and their associated values. Optionally, the function describes, for different extents to which the experience had been previously experienced, an expected affective response to experiencing the experience again. Optionally, the function is at least indicative of values is values v₁ and v₂ of expected affective response corresponding to extents e₁ and e₂, respectively; v₁ describes an expected affective response to experiencing the experience again, after having previously experienced the experience to the extent e₁; and v₂ describes an expected affective response to experiencing the experience again, after having previously experienced the experience to the extent e₂. Additionally, e₁≠e₂ and v₁≠v₂. Optionally, e₂ is at least 25% greater than e₁.

And in Step 3, responsive to determining that an expected affective response to experiencing the experience again after having experiencing it for at least a certain extent reaches a threshold, recommending the experience to a certain user. For example, a computer may receive an indication of the certain extent and utilize parameters of the function calculated in Step 2 to determine the expected affective response to experiencing the experience again. The computer may compare this value to the threshold and determine, based on the value reaching the threshold, to recommend the experience to the certain user.

In some embodiments, the method may optionally include a step that involves presenting the function learned in Step 2 on a display such as the display 252. Optionally, presenting the function involves rendering a representation of the function and/or its parameters. For example, the function may be rendered as a graph, plot, and/or any other image that represents values given by the function and/or parameters of the function.

As discussed above, parameters of a function may be learned from measurements of affective response utilizing various approaches. Therefore, Step 2 may involve performing different operations in different embodiments.

In one embodiment, learning the parameters of the function in Step 2 involves utilizing a machine learning-based trainer that is configured to utilize the measurements and their associated values to train a model for a predictor that is used to predict a value of affective response of a user based on an input indicative of an extent to which a user had previously experienced the experience. Optionally, the values in the model are such that responsive to being provided inputs indicative of the extents e₁ and e₂, the predictor predicts the affective response values v₁ and v₂, respectively.

In another embodiment, learning the parameters of the function in Step 2 involves the following operations: (i) assigning measurements of affective response to a plurality of bins based on their associated values; and (ii) computing a plurality of scores corresponding to the plurality of bins. Optionally, a score corresponding to a bin is computed based on measurements of more than one user, from the at least five users, for which the associated values fall within the range corresponding to the bin. Optionally, e₁ falls within a range of extents corresponding to a first bin, and e₂ falls within a range of extents corresponding to a second bin, which is different from the first bin. Optionally, the values v₁ and v₂ are the scores corresponding to the first and second bins, respectively.

In some embodiments, functions learned by the method described above may be compared (e.g., utilizing the function comparator 284). Optionally, performing such a comparison involves the following steps: (i) receiving descriptions of first and second functions that describe, for different extents to which an experience had been previously experienced, an expected affective response to experiencing respective first and second experiences again; (ii) comparing the first and second functions using the descriptions; and (iii) providing an indication derived from the comparison. Optionally, the indication indicates least one of the following: (i) the experience, from among the first and second experiences, for which the average affective response to having the respective experience again, after having previously experienced it at most to a certain extent e, is greatest; (ii) the experience, from among the first and second experiences, for which the average affective response to having the respective experience again, after having previously experienced it at least to a certain extent e, is greatest; and (iii) the experience, from among the first and second experiences, for which the affective response to having the respective experience again, after having previously experienced it to a certain extent e, is greatest.

In some embodiments, a function learned by a method described above may be personalized for a certain user. In such a case, the method may include the following steps: (i) receiving a profile of a certain user and profiles of at least some of the users who contributed measurements used for learning the personalized functions; (ii) generating an output indicative of similarities between the profile of the certain user and the profiles; and (iii) utilizing the output to learn a function, personalized for the certain user, that describes for different extents to which the experience had been previously experienced, an expected affective response to experiencing the experience again. Optionally, the output is generated utilizing the personalization module 130. Depending on the type of personalization approach used and/or the type of function learning approach used, the output may be utilized in various ways to learn the function, as discussed in further detail above. Optionally, for at least a first certain user and a second certain user, who have different profiles, different functions are learned, denoted ƒ₁ and ƒ₂, respectively. In one example, ƒ₁ is indicative of values v₁ and v₂ of expected affective response corresponding to having the experience again after having previously experienced the experience to extents e₁ and e₂, respectively, and ƒ₂ is indicative of values v₃ and v₄ of expected affective response corresponding to having the experience again after having previously experienced the experience to the extents e₁ and e₂, respectively. Additionally, in this example, e₁≠e₂, v₁≠v₂, v₁≠v₄, and v₁≠v₃.

Personalization of functions can lead to the learning of different functions for different users who have different profiles, as illustrated in FIG. 2. Obtaining the different functions for the different users may involve performing the steps described below, which include steps that may be carried out in order to learn a personalized function such as the functions 349a and 349b described above. In some embodiments, the steps described below may be part of the steps performed by systems modeled according to FIG. 1a. In some embodiments, instructions for implementing the method may be stored on a computer-readable medium, which may optionally be a non-transitory computer-readable medium. In response to execution by a system including a processor and memory, the instructions cause the system to perform operations that are part of the method.

In one embodiment, the method for learning a personalized function describing a relationship between repetitions of an experience and affective response to the experience includes the following steps:

In Step 1, receiving, by a system comprising a processor and memory, measurements of affective response of at least ten users. Each measurement of a user is taken while the user has the experience, and is associated with a value indicative of an extent to which the user had previously experienced the experience. Optionally, the measurements are received by the collection module 120.

In Step 2, receiving profiles of at least some of the users who contributed measurements in Step 1.

In Step 3, receiving a profile of a first certain user.

In Step 4, generating a first output indicative of similarities between the profile of the first certain user and the profiles received in Step 2. Optionally, the first output is generated by the personalization module 130.

In Step 5, learning parameters of a first function based on the measurements received in Step 1, the values associated with those measurements, and the first output. Optionally, ƒ₁ describes, for different extents to which the experience had been previously experienced, an expected affective response to experiencing the experience again. Optionally, ƒ₁ is at least indicative of values v₁ and v₂ expected affective response to experiencing the experience again, after having previously experienced the experience to extents e₁ and e₂, respectively (here e₁≠e₂ and v₁≠v₂). Optionally, the first function ƒ₁ is learned utilizing the function learning module 348.

In Step 7 receiving a profile of a second certain user, which is different from the profile of the first certain user.

In Step 8, generating a second output, which is different from the first output, and is indicative of similarities between the profile of the second certain user and the profiles received in Step 2. Optionally, the second output is generated by the personalization module 130.

And in Step 9, learning parameters of a second function ƒ₂ based on the measurements received in Step 1, the values associated with those measurements, and the second output. Optionally, ƒ₂ describes, for different extents to which the experience had been previously experienced, an expected affective response to experiencing the experience again. Optionally, ƒ₂ is at least indicative of values v₃ and v₄ of expected affective response to experiencing the experience again, after having previously experienced the experience to the extents e₁ and e₂, respectively, (here v₃≠v₄). Optionally, the second function ƒ₂ is learned utilizing the function learning module 348. In some embodiments, ƒ₁ is different from ƒ₂, thus, in the example above, the values v₁≠v₃ and/or v₂≠v₄.

In one embodiment, the method may optionally include a step of recommending the experience to the first certain user and/or to the second certain user based on an expected affective response to having the experience again (after having it to a certain extent) reaches a threshold. In one example, the expected affective response of the first certain user reaches the threshold, and the expected affective response of the second certain user does not reach the threshold. Consequently, the experience is recommended to the first certain user and not recommend to the second certain user.

In one embodiment, the method may optionally include steps that involve displaying a function on a display such as the display 252 and/or rendering the function for a display (e.g., by rendering a representation of the function and/or its parameters). In one example, the method may include Step 6, which involves rendering a representation of ƒ₁ and/or displaying the representation of ƒ₁ on a display of the first certain user. In another example, the method may include Step 10, which involves rendering a representation of ƒ₂ and/or displaying the representation of ƒ₂ on a display of the second certain user.

In one embodiment, generating the first output and/or the second output may involve computing weights based on profile similarity. For example, generating the first output in Step 4 may involve the performing the following steps: (i) computing a first set of similarities between the profile of the first certain user and the profiles of the at least ten users; and (ii) computing, based on the first set of similarities, a first set of weights for the measurements of the at least ten users. Optionally, each weight for a measurement of a user is proportional to the extent of a similarity between the profile of the first certain user and the profile of the user (e.g., as determined by the profile comparator 133), such that a weight generated for a measurement of a user whose profile is more similar to the profile of the first certain user is higher than a weight generated for a measurement of a user whose profile is less similar to the profile of the first certain user. Generating the second output in Step 8 may involve similar steps, mutatis mutandis, to the ones described above.

In another embodiment, the first output and/or the second output may involve clustering of profiles. For example, generating the first output in Step 4 may involve the performing the following steps: (i) clustering the at least some of the users into clusters based on similarities between the profiles of the at least some of users, with each cluster comprising a single user or multiple users with similar profiles; (ii) selecting, based on the profile of the first certain user, a subset of clusters comprising at least one cluster and at most half of the clusters, on average, the profile of the first certain user is more similar to a profile of a user who is a member of a cluster in the subset, than it is to a profile of a user, from among the at least ten users, who is not a member of any of the clusters in the subset; and (iii) selecting at least eight users from among the users belonging to clusters in the subset. Here, the first output is indicative of the identities of the at least eight users. Generating the second output in Step 8 may involve similar steps, mutatis mutandis, to the ones described above.

In some embodiments, the method may optionally include additional steps involved in comparing the functions ƒ₁ and ƒ₂: (i) receiving descriptions of the functions ƒ₁ and ƒ₂; (ii) making a comparison between the functions ƒ₁ and ƒ₂; and (iii) providing, based on the comparison, an indication of at least one of the following: (i) the function, from among ƒ₁ and ƒ₂, for which the average affective response predicted for having the experience again, after having previously experienced the experience at least to an extent e, is greatest; (ii) the function, from among ƒ₁ and ƒ₂, for which the average affective response predicted for having the experience again, after having previously experienced the experience at most to the extent e, is greatest; and (iii) the function, from among ƒ₁ and ƒ₂, for which the affective response predicted for having the experience again, after having previously experienced the experience to the extent e, is greatest.

Sensors and Measurements of Affective Response

As used herein, a sensor is a device that detects and/or responds to some type of input from the physical environment. Herein, “physical environment” is a term that includes the human body and its surroundings.

In some embodiments, a sensor that is used to measure affective response of a user may include, without limitation, one or more of the following: a device that measures a physiological signal of the user, an image-capturing device (e.g., a visible light camera, a near infrared (NIR) camera, a thermal camera (useful for measuring wavelengths larger than 2500 nm), a microphone used to capture sound, a movement sensor, a pressure sensor, a magnetic sensor, an electro-optical sensor, and/or a biochemical sensor. When a sensor is used to measure the user, the input from the physical environment detected by the sensor typically originates and/or involves the user. For example, a measurement of affective response of a user taken with an image capturing device comprises an image of the user. In another example, a measurement of affective response of a user obtained with a movement sensor typically detects a movement of the user. In yet another example, a measurement of affective response of a user taken with a biochemical sensor may measure the concentration of chemicals in the user (e.g., nutrients in blood) and/or by-products of chemical processes in the body of the user (e.g., composition of the user's breath).

Sensors used in embodiments described herein may have different relationships to the body of a user. In one example, a sensor used to measure affective response of a user may include an element that is attached to the user's body (e.g., the sensor may be embedded in gadget in contact with the body and/or a gadget held by the user, the sensor may comprise an electrode in contact with the body, and/or the sensor may be embedded in a film or stamp that is adhesively attached to the body of the user). In another example, the sensor may be embedded in, and/or attached to, an item worn by the user, such as a glove, a shirt, a shoe, a bracelet, a ring, a head-mounted display, and/or helmet or other form of headwear. In yet another example, the sensor may be implanted in the user's body, such a chip or other form of implant that measures the concentration of certain chemicals, and/or monitors various physiological processes in the body of the user. And in still another example, the sensor may be a device that is remote of the user's body (e.g., a camera or microphone).

As used herein, a “sensor” may refer to a whole structure housing a device used for detecting and/or responding to some type of input from the physical environment, or to one or more of the elements comprised in the whole structure. For example, when the sensor is a camera, the word sensor may refer to the entire structure of the camera, or just to its CMOS detector.

In some embodiments, a sensor may store data it collects and/processes (e.g., in electronic memory). Additionally or alternatively, the sensor may transmit data it collects and/or processes. Optionally, to transmit data, the sensor may use various forms of wired communication and/or wireless communication, such as Wi-Fi signals, Bluetooth, cellphone signals, and/or near-field communication (NFC) radio signals.

In some embodiments, a sensor may require a power supply for its operation. In one embodiment, the power supply may be an external power supply that provides power to the sensor via a direct connection involving conductive materials (e.g., metal wiring and/or connections using other conductive materials). In another embodiment, the power may be transmitted to the sensor wirelessly. Examples of wireless power transmissions that may be used in some embodiments include inductive coupling, resonant inductive coupling, capacitive coupling, and magnetodynamic coupling. In still another embodiment, a sensor may harvest power from the environment. For example, the sensor may use various forms of photoelectric receptors to convert electromagnetic waves (e.g., microwaves or light) to electric power. In another example, radio frequency (RF) energy may be picked up by a sensor's antenna and converted to electrical energy by means of an inductive coil. In yet another example, harvesting power from the environment may be done by utilizing chemicals in the environment. For example, an implanted (in vivo) sensor may utilize chemicals in the body of the user that store chemical energy such as ATP, sugars, and/or fats.

In some embodiments, a sensor may receive at least some of the energy required for its operation from a battery. Such a sensor may be referred to herein as being “battery-powered”. Herein, a battery refers to an object that can store energy and provide it in the form of electrical energy. In one example, a battery includes one or more electrochemical cells that convert stored chemical energy into electrical energy. In another example, a battery includes a capacitor that can store electrical energy. In one embodiment, the battery may be rechargeable; for example, the battery may be recharged by storing energy obtained using one or more of the methods mentioned above. Optionally, the battery may be replaceable. For example, a new battery may be provided to the sensor in cases where its battery is not rechargeable, and/or does not recharge with the desired efficiency.

In some embodiments, a measurement of affective response of a user comprises, and/or is based on, a physiological signal of the user, which reflects a physiological state of the user. Following are some non-limiting examples of physiological signals that may be measured. Some of the example below include types of techniques and/or sensors that may be used to measure the signals; those skilled in the art will be familiar with various sensors, devices, and/or methods that may be used to measure these signals:

(A) Heart Rate (HR), Heart Rate Variability (HRV), and Blood-Volume Pulse (BVP), and/or other parameters relating to blood flow, which may be determined by various means such as electrocardiogram (ECG), photoplethysmogram (PPG), and/or impedance cardiography (ICG).

(B) Skin conductance (SC), which may be measured via sensors for Galvanic Skin Response (GSR), which may also be referred to as Electrodermal Activity (EDA).

(C) Skin Temperature (ST) may be measured, for example, with various types of thermometers.

(D) Brain activity and/or brainwave patterns, which may be measured with electroencephalography (EEG). Additional discussion about EEG is provided below.

(E) Brain activity determined based on functional magnetic resonance imaging (fMRI).

(F) Brain activity based on Magnetoencephalography (MEG).

(G) Muscle activity, which may be determined via electrical signals indicative of activity of muscles, e.g., measured with electromyography (EMG). In one example, surface electromyography (sEMG) may be used to measure muscle activity of frontalis and corrugator supercilii muscles, indicative of eyebrow movement, and from which an emotional state may be recognized.

(H) Eye movement, e.g., measured with electrooculography (EOG).

(I) Blood oxygen levels that may be measured using hemoencephalography (HEG).

(J) CO₂ levels in the respiratory gases that may be measured using capnography.

(K) Concentration of various volatile compounds emitted from the human body (referred to as the Volatome), which may be detected from the analysis of exhaled respiratory gasses and/or secretions through the skin using various detection tools that utilize nanosensors.

(L) Temperature of various regions of the body and/or face may be determined utilizing thermal Infra-Red (IR) cameras. For example, thermal measurements of the nose and/or its surrounding region may be utilized to estimate physiological signals such as respiratory rate and/or occurrence of allergic reactions.

In some embodiments, a measurement of affective response of a user comprises, and/or is based on, a behavioral cue of the user. A behavioral cue of the user is obtained by monitoring the user in order to detect things such as facial expressions of the user, gestures made by the user, tone of voice, and/or other movements of the user's body (e.g., fidgeting, twitching, or shaking). The behavioral cues may be measured utilizing various types of sensors. Some non-limiting examples include an image capturing device (e.g., a camera), a movement sensor, a microphone, an accelerometer, a magnetic sensor, and/or a pressure sensor. In one example, a behavioral cue may involve prosodic features of a user's speech such as pitch, volume, tempo, tone, and/or stress (e.g., stressing of certain syllables), which may be indicative of the emotional state of the user. In another example, a behavioral cue may be the frequency of movement of a body (e.g., due to shifting and changing posture when sitting, laying down, or standing). In this example, a sensor embedded in a device such as accelerometers in a smartphone or smartwatch may be used to take the measurement of the behavioral cue.

In some embodiments, a measurement of affective response of a user may be obtained by capturing one or more images of the user with an image-capturing device, such as a camera. Optionally, the one or more images of the user are captured with an active image-capturing device that transmits electromagnetic radiation (such as radio waves, millimeter waves, or near visible waves) and receives reflections of the transmitted radiation from the user. Optionally, the one or more captured images are in two dimensions and/or in three dimensions. Optionally, the one or more captured images comprise one or more of the following: a single image, sequences of images, a video clip. In one example, images of a user captured by the image capturing device may be utilized to determine the facial expression and/or the posture of the user. In another example, images of a user captured by the image capturing device depict an eye of the user. Optionally, analysis of the images can reveal the direction of the gaze of the user and/or the size of the pupils. Such images may be used for eye tracking applications, such as identifying what the user is paying attention to, and/or for determining the user's emotions (e.g., what intentions the user likely has). Additionally, gaze patterns, which may involve information indicative of directions of a user's gaze, the time a user spends gazing at fixed points, and/or frequency at which the user changes points of interest, may provide information that may be utilized to determine the emotional response of the user.

In some embodiments, a measurement of affective response of a user may include a physiological signal derived from a biochemical measurement of the user. For example, the biochemical measurement may be indicative of the concentration of one or more chemicals in the body of the user (e.g., electrolytes, metabolites, steroids, hormones, neurotransmitters, and/or products of enzymatic activity). In one example, a measurement of affective response may describe the glucose level in the bloodstream of the user. In another example, a measurement of affective response may describe the concentration of one or more stress-related hormones such as adrenaline and/or cortisol. In yet another example, a measurement of affective response may describe the concentration of one or more substances that may serve as inflammation markers such as C-reactive protein (CRP). In one embodiment, a sensor that provides a biochemical measurement may be an external sensor (e.g., a sensor that measures glucose from a blood sample extracted from the user). In another embodiment, a sensor that provides a biochemical measurement may be in physical contact with the user (e.g., contact lens in the eye of the user that measures glucose levels). In yet another embodiment, a sensor that provides a biochemical measurement may be a sensor that is in the body of the user (an “in vivo” sensor). Optionally, the sensor may be implanted in the body (e.g., by a chirurgical procedure), injected into the bloodstream, and/or enter the body via the respiratory and/or digestive system. Some examples of types of in vivo sensors that may be used are given in Eckert et al. (2013), “Novel molecular and nanosensors for in vivo sensing”, in Theranostics, 3.8:583.

Sensors used to take measurements of affective response may be considered, in some embodiments, to be part of a Body Area Network (BAN) also called a Body Sensor Networks (BSN). Such networks enable monitoring of user physiological signals, actions, health status, and/or motion patterns. Further discussion about BANs may be found in Chen et al., “Body area networks: A survey” in Mobile networks and applications 16.2 (2011): 171-193.

EEG is a common method for recording brain signals in humans because it is safe, affordable, and easy to use; it also has a high temporal resolution (of the order of milliseconds). EEG electrodes, placed on the scalp, can be either “passive” or “active”. Passive electrodes, which are metallic, are connected to an amplifier, e.g., by a cable. Active electrodes may have an inbuilt preamplifier to make them less sensitive to environmental noise and cable movements. Some types of electrodes may need gel or saline liquid to operate, in order to reduce the skin-electrode contact impedance. While other types of EEG electrodes can operate without a gel or saline and are considered “dry electrodes”. There are various brain activity patterns that may be measured by EEG. Some of the popular ones often used in affective computing include: Event Related Desynchronization/Synchronization, Event Related Potentials (e.g., P300 wave and error potentials), and Steady State Evoked Potentials. Measurements of EEG electrodes are typically subjected to various feature extraction techniques which aim to represent raw or preprocessed EEG signals by an ideally small number of relevant values, which describe the task-relevant information contained in the signals. For example, these features may be the power of the EEG over selected channels, and specific frequency bands. Various feature extraction techniques are discussed in more detail in Bashashati, et al., “A survey of signal processing algorithms in brain-computer interfaces based on electrical brain signals”, in Journal of Neural Engineering, 4(2):R32, 2007. Additional discussion about using EEG in affective computing and brain computer interfaces (BCI) can be found in Lotte, et al., “Electroencephalography (EEG)-based Brain Computer Interfaces”, in Wiley Encyclopedia of Electrical and Electronics Engineering, pp. 44, 2015, and the references cited therein.

The aforementioned examples involving sensors and/or measurements of affective response represent an exemplary sample of possible physiological signals and/or behavioral cues that may be measured. Embodiments described in this disclosure may utilize measurements of additional types of physiological signals and/or behavioral cues, and/or types of measurements taken by sensors, which are not explicitly listed above. Additionally, in some examples given above some of the sensors and/or techniques may be presented in association with certain types of values that may be obtained utilizing those sensors and/or techniques. This is not intended to be limiting description of what those sensors and/or techniques may be used for. In particular, a sensor and/or a technique listed above, which is associated in the examples above with a certain type of value (e.g., a certain type of physiological signal and/or behavioral cue) may be used, in some embodiments, in order to obtain another type of value, not explicitly associated with the sensor and/or technique in the examples given above.

In various embodiments, a measurement of affective response of a user comprises, and/or is based on, one or more values acquired with a sensor that measures a physiological signal and/or a behavioral cue of the user.

In some embodiments, an affective response of a user to an event is expressed as absolute values, such as a value of a measurement of an affective response (e.g., a heart rate level, or GSR value), and/or emotional state determined from the measurement (e.g., the value of the emotional state may be indicative of a level of happiness, excitement, and/or contentedness). Alternatively, the affective response of the user may be expressed as relative values, such as a difference between a measurement of an affective response (e.g., a heart rate level, or GSR value) and a baseline value, and/or a change to emotional state (e.g., a change to the level of happiness). Depending on the context, one may understand whether the affective response referred to is an absolute value (e.g., heart rate and/or level of happiness), or a relative value (e.g., change to heart rate and/or change to the level of happiness). For example, if the embodiment describes an additional value to which the measurement may be compared (e.g., a baseline value), then the affective response may be interpreted as a relative value. In another example, if an embodiment does not describe an additional value to which the measurement may be compared, then the affective response may be interpreted as an absolute value. Unless stated otherwise, embodiments described herein that involve measurements of affective response may involve values that are either absolute and/or relative.

As used herein, a “measurement of affective response” is not limited to representing a single value (e.g., scalar); a measurement may comprise multiple values. In one example, a measurement may be a vector of co-ordinates, such as a representation of an emotional state as a point on a multidimensional plane. In another example, a measurement may comprise values of multiple signals taken at a certain time (e.g., heart rate, temperature, and a respiration rate at a certain time). In yet another example, a measurement may include multiple values representing signal levels at different times. Thus, a measurement of affective response may be a time-series, pattern, or a collection of wave functions, which may be used to describe a signal that changes over time, such as brainwaves measured at one or more frequency bands. Thus, a “measurement of affective response” may comprise multiple values, each of which may also be considered a measurement of affective response. Therefore, using the singular term “measurement” does not imply that there is a single value. For example, in some embodiments, a measurement may represent a set of measurements, such as multiple values of heart rate and GSR taken every few minutes during a duration of an hour.

A measurement of affective response may comprise raw values describing a physiological signal and/or behavioral cue of a user. For example, the raw values are the values provided by a sensor used to measure, possibly after minimal processing, as described below. Additionally or alternatively, a measurement of affective response may comprise a product of processing of the raw values. The processing of one or more raw values may involve performing one or more of the following operations: normalization, filtering, feature extraction, image processing, compression, encryption, and/or any other techniques described further in this disclosure, and/or that are known in the art and may be applied to measurement data.

In some embodiments, processing raw values, and/or processing minimally processed values, involves providing the raw values and/or products of the raw values to a module, function, and/or predictor, to produce a value that is referred to herein as an “affective value”. As typically used herein, an affective value is a value that describes an extent and/or quality of an affective response. For example, an affective value may be a real value describing how good an affective response is (e.g., on a scale from 1 to 10), or whether a user is attracted to something or repelled by it (e.g., by having a positive value indicate attraction and a negative value indicate repulsion). In some embodiments, the use of the term “affective value” is intended to indicate that certain processing might have been applied to a measurement of affective response. Optionally, the processing is performed by a software agent. Optionally, the software agent has access to a model of the user that is utilized in order to compute the affective value from the measurement. In one example, an affective value may be a prediction of an Emotional State Estimator (ESE) and/or derived from the prediction of the ESE. In some embodiments, measurements of affective response may be represented by affective values.

It is to be noted that, though affective values are typically results of processing measurements, they may be represented by any type of value that a measurement of affective response may be represented by. Thus, an affective value may, in some embodiments, be a value of a heart rate, brainwave activity, skin conductance levels, etc.

In some embodiments, a measurement of affective response may involve a value representing an emotion (also referred to as an “emotional state” or “emotional response”). Emotions and/or emotional responses may be represented in various ways.

In some embodiments, emotions are represented using discrete categories. For example, the categories may include three emotional states: negatively excited, positively excited, and neutral. In another example, the emotions may be selected from the following set that includes basic emotions, including a range of positive and negative emotions such as Amusement, Contempt, Contentment, Embarrassment, Excitement, Guilt, Pride in achievement, Relief, Satisfaction, Sensory pleasure, and Shame, as described by Ekman P. (1999), “Basic Emotions”, in Dalgleish and Power, Handbook of Cognition and Emotion, Chichester, UK: Wiley.

In some embodiments, emotions are represented using a multidimensional representation, which typically characterizes the emotion in terms of a small number of dimensions. In one example, emotional states are represented as points in a two dimensional space of Arousal and Valence. Arousal describes the physical activation, and valence the pleasantness or hedonic value. Each detectable experienced emotion is assumed to fall in a specified region in that two-dimensional space. Other dimensions that are typically used to represent emotions include potency/control (refers to the individual's sense of power or control over the eliciting event), expectation (the degree of anticipating or being taken unaware), and intensity (how far a person is away from a state of pure, cool rationality).

In some embodiments, emotions are represented using a numerical value that represents the intensity of the emotional state with respect to a specific emotion. For example, a numerical value stating how much the user is enthusiastic, interested, and/or happy. Optionally, the numeric value for the emotional state may be derived from a multidimensional space representation of emotion.

A measurement of affective response may be referred to herein as being positive or negative. A positive measurement of affective response, as the term is typically used herein, reflects a positive emotion indicating one or more qualities such as desirability, happiness, content, and the like, on the part of the user of whom the measurement is taken. Similarly, a negative measurement of affective response, as typically used herein, reflects a negative emotion indicating one or more qualities such as repulsion, sadness, anger, and the like on the part of the user of whom the measurement is taken. Optionally, when a measurement is neither positive nor negative, it may be considered neutral.

Some embodiments may involve a reference to the time at which a measurement of affective response of a user is taken. Depending on the embodiment, this time may have various interpretations. For example, in one embodiment, this time may refer to the time at which one or more values describing a physiological signal and/or behavioral cue of the user were obtained utilizing one or more sensors. Optionally, the time may correspond to one or more periods during which the one or more sensors operated in order to obtain the one or more values describing the physiological signal and/or the behavioral cue of the user. For example, a measurement of affective response may be taken during a single point in time and/or refer to a single point in time (e.g., skin temperature corresponding to a certain time). In another example, a measurement of affective response may be taken during a contiguous stretch of time (e.g., brain activity measured using EEG over a period of one minute). In still another example, a measurement of affective response may be taken during multiple points and/or multiple contiguous stretches of time (e.g., brain activity measured every waking hour for a few minutes each time).

Various embodiments described herein involve measurements of affective response of users to having experiences. A measurement of affective response of a user to having an experience may also be referred to herein as a “measurement of affective response of the user to the experience”. In order to reflect the affective response of a user to having an experience, the measurement is typically taken in temporal proximity to when the user had the experience (so the affective response may be determined from the measurement). Herein, temporal proximity means nearness in time. Thus, stating that a measurement of affective response of a user is taken in temporal proximity to when the user has/had an experience means that the measurement is taken while the user has/had the experience and/or shortly after the user finishes having the experience. Optionally, a measurement of affective response of a user taken in temporal proximity to having an experience may involve taking at least some of the measurement shortly before the user started having the experience (e.g., for calibration and/or determining a baseline).

What window in time constitutes being “shortly before” and/or “shortly after” having an experience may vary in embodiments described herein, and may depend on various factors such as the length of the experience, the type of sensor used to acquire the measurement, and/or the type of physiological signal and/or behavioral cue being measured. In one example, with a short experience (e.g., and experience lasting 10 seconds), “shortly before” and/or “shortly after” may mean at most 10 seconds before and/or after the experience; though in some cases it may be longer (e.g., a minute or more). However, with a long experience (e.g., an experience lasting hours or days), “shortly before” and/or “shortly after” may correspond even to a period of up to a few hours before and/or after the experience (or more). In another example, when measuring a signal that is quick to change, such as brainwaves measured with EEG, “shortly before” and/or “shortly after” may correspond to a period of a few seconds or even up to a minute. However, with a signal that changes slower, such as heart rate or skin temperature, “shortly before” and/or “shortly after” may correspond to a longer period such as even up to ten minutes or more. In still another example, what constitutes “shortly after” an experience may depend on the nature of the experience and how long the affective response to it may last. For example, in one embodiment, measuring affective response to a short segment of content (e.g., viewing a short video clip) may comprise heart-rate measurements taken up to 30 seconds after the segment had been viewed. However, in another embodiment, measuring affective response to eating a meal may comprise measurements taken even possibly hours after the meal, to reflect the effects digesting the meal had on the user's physiology.

The duration in which a sensor operates in order to measure an affective response of a user may differ depending on one or more of the following factors: (i) the type of event involving the user, (ii) the type of physiological and/or behavioral signal being measured, and (iii) the type of sensor utilized for the measurement. In some cases, the affective response may be measured by the sensor substantially continually throughout the period corresponding to the event (e.g., while the user interacts with a service provider). However, in other cases, the duration in which the affective response of the user is measured need not necessarily overlap, or be entirely contained in, a period corresponding to an event (e.g., an affective response to a meal may be measured hours after the meal).

In some embodiments, determining the affective response of a user to an event may utilize measurement taking during a fraction of the time corresponding to the event. The affective response of the user may be measured by obtaining values of a physiological signal of the user that in some cases may be slow to change, such as skin temperature, and/or slow to return to baseline values, such as heart rate. In such cases, measuring the affective response does not have to involve continually measuring the user throughout the duration of the event. Since such physiological signals are slow to change, reasonably accurate conclusions regarding the affective response of the user to an event may be reached from samples of intermittent measurements taken at certain periods during the event and/or after it. In one example, measuring the affective response of a user to a vacation destination may involve taking measurements during short intervals spaced throughout the user's stay at the destination (and possibly during the hours or days after it), such as taking a GSR measurement lasting a few seconds, every few minutes or hours.

Furthermore, when a user has an experience over a certain period of time, it may be sufficient to sample values of physiological signals and/or behavioral cues during the certain period in order to obtain the value of a measurement of affective response (without the need to continuously obtain such values throughout the time the user had the experience). Thus, in some embodiments, a measurement of affective response of a user to an experience is based on values acquired by a sensor during at least a certain number of non-overlapping periods of time during the certain period of time during which the user has the experience (i.e., during the instantiation of an event in which the user has the experience). Optionally, between each pair of non-overlapping periods there is a period time during which the user is not measured with a sensor in order to obtain values upon which to base the measurement of affective response. Optionally, the sum of the lengths of the certain number of non-overlapping periods of time amounts to less than a certain proportion of the length of time during which the user had the experience. Optionally, the certain proportion is less than 50%, i.e., a measurement of affective response of a user to an experience is based on values acquired by measuring the user with a sensor during less than 50% of the time the user had the experience. Optionally, the certain proportion is some other value such as less than 25%, less than 10%, less than 5%, or less than 1% of the time the user had the experience.

Measurements of affective response of users may be taken, in the embodiments, at different extents and/or frequency, depending on the characteristics of the embodiments. In some embodiments, measurements of affective response of users are routinely taken; for example, measurements are taken according to a preset protocol set by the user, an operating system of a device of the user that controls a sensor, and/or a software agent operating on behalf of a user. In some embodiments, measurements may be taken in order to gauge the affective response of users to certain events. Optionally, a protocol may dictate that measurements to certain experiences are to be taken automatically. For example, a protocol governing the operation of a sensor may dictate that every time a user exercises, certain measurements of physiological signals of the user are to be taken throughout the exercise (e.g., heart rate and respiratory rate), and possibly a short duration after that (e.g., during a recuperation period). Alternatively or additionally, measurements of affective response may be taken “on demand”. For example, a software agent operating on behalf of a user may decide that measurements of the user should be taken in order to establish a baseline for future measurements.

As used herein, a “baseline affective response value of a user” (or “baseline value of a user” when the context is clear) refers to a value that may represent a typically slowly changing affective response of the user, such as the mood of the user. Optionally, the baseline affective response value is expressed as a value of a physiological signal of the user and/or a behavioral cue of the user, which may be determined from a measurement taken with a sensor. Optionally, the baseline affective response value may represent an affective response of the user under typical conditions. For example, typical conditions may refer to times when the user is not influenced by a certain event that is being evaluated. In another example, baseline affective response values of the user are typically exhibited by the user at least 50% of the time during which affective response of the user may be measured. In still another example, a baseline affective response value of a user represents an average of the affective response of the user, such as an average of measurements of affective response of the user taken during periods spread over hours, days, weeks, and possibly even years. Herein, a module that computes a baseline value may be referred to herein as a “baseline value predictor”.

In one embodiment, normalizing a measurement of affective response utilizing a baseline involves subtracting the value of the baseline from the measurement. Thus, after normalizing with respect to the baseline, the measurement becomes a relative value, reflecting a difference from the baseline. In one example, if the measurement includes a certain value, normalization with respect to a baseline may produce a value that is indicative of how much the certain value differs from the value of the baseline (e.g., how much is it above or below the baseline). In another example, if the measurement includes a sequence of values, normalization with respect to a baseline may produce a sequence indicative of a divergence between the measurement and a sequence of values representing the baseline.

In one embodiment, a baseline affective response value may be derived from one or more measurements of affective response taken before and/or after a certain event that may be evaluated to determine its influence on the user. For example, the event may involve visiting a location, and the baseline affective response value is based on a measurement taken before the user arrives at the location. In another example, the event may involve the user interacting with a service provider, and the baseline affective response value is based on a measurement of the affective response of the user taken before the interaction takes place.

In another embodiment, a baseline affective response value may correspond to a certain event, and represent an affective response of the user corresponding to the event would typically have to the certain event. Optionally, the baseline affective response value is derived from one or more measurements of affective response of a user taken during previous instantiations of events that are similar to the certain event (e.g., involve the same experience and/or similar conditions of instantiation). For example, the event may involve visiting a location, and the baseline affective response value is based on measurements taken during previous visits to the location. In another example, the event may involve the user interacting with a service provider, and the baseline affective response value may be based on measurements of the affective response of the user taken while interacting with other service providers.

In yet another embodiment, a baseline affective response value may correspond to a certain period in a periodic unit of time (also referred to as a recurring unit of time). Optionally, the baseline affective response value is derived from measurements of affective response taken during the certain period during the periodic unit of time. For example, a baseline affective response value corresponding to mornings may be computed based on measurements of a user taken during the mornings. In this example, the baseline will include values of an affective response a user typically has during the mornings.

As used herein, a periodic unit of time, which may also be referred to as a recurring unit of time, is a period of time that repeats itself. For example, an hour, a day, a week, a month, a year, two years, four years, or a decade. A periodic unit of time may correspond to the time between two occurrences of a recurring event, such as the time between two world cup tournaments. Optionally, a certain periodic unit of time may correspond to a recurring event. For example, the recurring event may be the Cannes film festival, Labor Day weekend, or the NBA playoffs.

There are various ways, in different embodiments described herein, in which data comprising measurements of affective response, and/or data on which measurements of affective response are based, may be processed. The processing of the data may take place before, during, and/or after the data is acquired by a sensor (e.g., when the data is stored by the sensor and/or transmitted from it). Optionally, at least some of the processing of the data is performed by the sensor that measured it. Additionally or alternatively, at least some of the processing of the data is performed by a processor that receives the data in a raw (unprocessed) form, or in a partially processed form. Examples of various ways in which data obtained from a sensor may be processed in some of the different embodiments described herein include: signal processing (e.g. analog signal processing and/or digital signal processing), normalization (e.g., conversion to z-values or various statistics), and/or feature extraction and/or dimensionality reduction techniques (e.g., Fisher projections, Principal Component Analysis, and/or techniques for the selection of subsets of features). In some embodiments, data that includes images and/or video may undergo processing that may be done in various ways utilizing algorithms for identifying cues like movement, smiling, laughter, concentration, body posture, and/or gaze, are used in order to detect high-level image features. Additionally, the images and/or video clips may be analyzed using algorithms and/or filters for detecting and/or localizing facial features such as the location of the eyes, the brows, and/or the shape of the mouth. Additionally, the images and/or video clips may be analyzed using algorithms for detecting facial expressions and/or micro-expressions. In another example, images are processed with algorithms for detecting and/or describing local features such as Scale-Invariant Feature Transform (SIFT), Speeded Up Robust Features (SURF), scale-space representation, and/or other types of low-level image features.

In some embodiments, processing measurements of affective response of users involves removal of at least some of the personal information about the users from the measurements prior to measurements being transmitted (e.g., to a collection module) or prior to them be utilized by modules to generate crowd-based results. Herein, personal information of a user may include information that teaches specific details about the user such as the identity of the user, activities the user engages in, and/or preferences, account information of the user, inclinations, and/or a worldview of the user.

The literature describes various algorithmic approaches that can be used for processing measurements of affective response. Some embodiments may utilize these known, and possibly other yet to be discovered, methods for processing measurements of affective response. Some examples include: (i) a variety of physiological measurements may be preprocessed according to the methods and references listed in van Broek, E. L., et al. (2009), “Prerequisites for Affective Signal Processing (ASP)”, in “Proceedings of the International Joint Conference on Biomedical Engineering Systems and Technologies”, INSTICC Press; (ii) a variety of acoustic and physiological signals may be preprocessed and have features extracted from them according to the methods described in the references cited in Tables 2 and 4, Gunes, H., & Pantic, M. (2010), “Automatic, Dimensional and Continuous Emotion Recognition”, International Journal of Synthetic Emotions, 1 (1), 68-99; (iii) preprocessing of audio and visual signals may be performed according to the methods described in the references cited in Tables 2-4 in Zeng, Z., et al. (2009), “A survey of affect recognition methods: audio, visual, and spontaneous expressions”, IEEE Transactions on Pattern Analysis and Machine Intelligence, 31 (1), 39-58; and (iv) preprocessing and feature extraction of various data sources such as images, physiological measurements, voice recordings, and text based-features, may be performed according to the methods described in the references cited in Tables 1, 2, 3, 5 in Calvo, R. A., & D'Mello, S. (2010) “Affect Detection: An Interdisciplinary Review of Models, Methods, and Their Applications”, IEEE Transactions on Affective Computing 1(1), 18-37.

As part of processing measurements of affective response, the measurements may be provided, in some embodiments, to various modules for making determinations according to values of the measurements. Optionally, the measurements are provided to one or more various functions that generate values based on the measurements. For example, the measurements may be provided to estimators of emotional states from measurement data (ESEs described below) in order to estimate an emotional state (e.g., level of happiness). The results obtained from the functions and/or predictors may also be considered measurements of affective response.

As discussed above, a value of a measurement of affective response corresponding to an event may be based on a plurality of values obtained by measuring the user with one or more sensors at different times during the event's instantiation period or shortly after it. Optionally, the measurement of affective response is a value that summarizes the plurality of values. It is to be noted that, in some embodiments, each of the plurality of values may be considered a measurement of affective response on its own merits. However, in order to distinguish between a measurement of affective response and the values it is based on, the latter may be referred to in the discussion below as “a plurality of values” and the like. Optionally, when a measurement of affective response is a value that summarizes a plurality of values, it may, but not necessarily, be referred to in this disclosure as an “affective value”.

Combining a plurality of values obtained utilizing a sensor that measured a user in order to a measurement of affective response corresponding to an event, as described in the examples above, may be performed, in some embodiments, by an affective value scorer. Herein, an affective value scorer is a module that computes an affective value based on input comprising a measurement of affective response. Thus, the input to an affective value scorer may comprise a value obtained utilizing a sensor that measured a user and/or multiple values obtained by the sensor. Additionally, the input to the affective value scorer may include various values related to the user corresponding to the event, the experience corresponding to the event, and/or to the instantiation corresponding to the event. In one example, input to an affective value scorer may comprise a description of mini-events comprises in the event (e.g., their instantiation periods, durations, and/or corresponding attributes). In another example, input to an affective value scorer may comprise dominance levels of events (or mini-events). Thus, the examples given above describing computing a measurement of affective response corresponding to an event as an average, and/or weighted average of a plurality of values, may be considered examples of function computed by an affective value scorer. In some embodiments, input provided to an affective value scorer may include private information of a user. For example, the information may include portions of a profile of the user. Optionally, the private information is provided by a software agent operating on behalf of the user. Alternatively, the affective values scorer itself may be a module of a software agent operating on behalf of the user. In some embodiments, an affective value scorer may be implemented by a predictor, which may utilize an Emotional State Estimator (ESE) and/or itself be an ESE.

Section 6 (“Measurements of Affective Response”) in U.S. application Ser. No. 15/051,892, published as U.S. 2016/0170996, which is incorporated herein by reference in its entirety, includes additional details regarding various aspects described in this section, such as representing emotional responses, taking measurements of affective response, processing measurements of affective response, and calculating of affective values.

Experiences and Events

Some embodiments described herein may involve users having “experiences”. An experience is typically characterized as being of a certain type. Below is a description comprising non-limiting examples of various categories of types of experiences to which experiences in different embodiments may correspond. This description is not intended to be a partitioning of experiences; e.g., various experiences described in embodiments may fall into multiple categories listed below. This description is not comprehensive; e.g., some experiences in embodiments may not belong to any of the categories listed below. A more complete discussion of experiences and their properties that may be relevant to various embodiments may be found in Section 7 (“Experiences”) in U.S. application Ser. No. 15/051,892, published as U.S. 2016/0170996, which is incorporated herein by reference in its entirety.

One example of a type of experience involves being in a location. A location in the physical world may occupy various areas in, and/or volumes of, the physical world. For example, a location may be a continent, country, region, city, park, or a business (e.g., a restaurant). In one example, a location is a travel destination (e.g., Paris). In another example, a location may be a portion of another location, such as a specific room in a hotel or a seat in a specific location in a theatre. In another example, a location may be a virtual environment such as a virtual world, with at least one instantiation of the virtual environment stored in a memory of a computer.

In some embodiments, an experience may involve traversing a certain route. Optionally, a route is a collection of two or more locations that a user may visit. Optionally, at least some of the two or more locations in the route are places in the physical world. Optionally, at least some of the two or more locations in the route are places in a virtual world. In one embodiment, a route is characterized by the order in which the locations are visited. In another embodiment, a route is characterized by a mode of transportation used to traverse it.

In other embodiments, an experience may involve an activity that a user does. In one example, an experience involves a recreational activity (e.g., traveling, going out to a restaurant, visiting the mall, or playing games on a gaming console). In another example, an experience involves a day-to-day activity (e.g., getting dressed, driving to work, talking to another person, sleeping, and/or making dinner).

In yet other embodiments, an experience may involve some sort of social interaction a user has. Optionally, the social interaction may be between the user and another person and/or between the user and a software-based entity (e.g., a software agent or physical robot). Optionally, the social interaction the user has is with a service provider providing a service to the user. Optionally, the service provider may be a human service provider or a virtual service provider (e.g., a robot, a chatbot, a web service, and/or a software agent). In some embodiments, a human service provider may be any person with whom a user interacts (that is not the user). Optionally, at least part of an interaction between a user and a service provider may be performed in a physical location (e.g., a user interacting with a waiter in a restaurant, where both the user and the waiter are in the same room).

In still other embodiments, utilizing a product may be considered an experience. A product may be any object that a user may utilize. Examples of products include appliances, clothing items, footwear, wearable devices, gadgets, jewelry, cosmetics, cleaning products, vehicles, sporting gear and musical instruments.

And in yet other embodiments, spending time in an environment characterized by certain environmental conditions may also constitute an experience. Optionally, different environmental conditions may be characterized by a certain value or range of values of an environmental parameter.

The examples given above illustrate some of the different types of experiences users may have in embodiments described herein. In addition to a characterization according to a type of experience, and in some embodiments instead of such a characterization, different experiences may be characterized according to other attributes. In one embodiment, experiences may be characterized according to the length of time in which a user has them. For example, “short experiences” may be experiences lasting less than five minutes, while “long experiences” may take more than an hour (possibly with a category of “intermediate experiences” for experiences lasting between five minutes and an hour). In another embodiment, experiences may be characterized according to an expense associated with having them. For example, “free experiences” may have no monetary expense associated with them, while “expensive experiences” may be experiences that cost at least a certain amount of money (e.g., at least a certain portion of a budget a user has). In yet another embodiment, experiences may be characterized according to their age-appropriateness (e.g., an R-rated movie vs. a PG-rated movie).

Characterizations of experiences may be done in additional ways. In some embodiments, experiences may be considered to by corresponding attributes (e.g., type of experience, length, cost, quality, etc.) Depending on the embodiments, different subsets of attributes may be considered, which amount to different ways in which experiences may be characterized.

The possibility to characterize experiences with subsets of corresponding attributes may lead to the fact that depending on the embodiment, the same collection of occurrences (e.g., actions by a user at a location) may correspond to different experiences and/or a different number of experiences. For example, when a user takes a bike ride in the park, it may correspond to multiple experiences, such as “exercising”, “spending time outdoors”, “being at the park”, “being exposed to the sun”, “taking a bike ride”, and possibly other experience. Furthermore, in some embodiments, experiences may be characterized according to attributes involving different levels of specificity. For example, when considering an experience involving being in a location, in one embodiment, the location may be a specific location such as room 1214 in the Grand Budapest Hotel, or seat 10 row 4 in the Left Field Pavilion 303 at Dodger Stadium. In another embodiment, the location may refer to multiple places in the physical world. For example, the location “fast food restaurant” may refer to any fast food restaurant, while the location “hotel” may refer to any hotel.

In some embodiments, attributes used to characterize experiences may be considered to belong to hierarchies. For example, when a user rides a bike in the park, this may be associated with multiple experiences that have a hierarchical relationship between them. For example, riding the bike may correspond to an experience of “riding a bike in Battery park on a weekend”, which belongs to a group of experiences that may be described as “riding a bike in Battery park”, which belongs to a larger group of experiences that may be characterized as “riding a bike in a park”, which in turn may belong to a larger group “riding a bike”, which in turn may belong to an experience called “exercising”. Additionally, in some embodiments, an experience may comprise multiple (“smaller”) experiences, and depending on the embodiment, the multiple experiences may be considered jointly (e.g., as a single experience) or individually. For example, “going out to a movie” may be considered a single experience that is comprised of multiple experiences such as “driving to the theatre”, “buying a ticket”, “eating popcorn”, “going to the bathroom”, “watching the movie”, and “driving home”.

When a user has an experience, this defines an “event”. An event may be characterized according to certain attributes. For example, every event may have a corresponding experience and a corresponding user (who had the corresponding experience). An event may have additional corresponding attributes that describe the specific instantiation of the event in which the user had the experience. Examples of such attributes may include the event's duration (how long the user had the experience in that instantiation), the event's starting and/or ending time, and/or the event's location (where the user had the experience in that instantiation).

An event may be referred to as being an “instantiation” of an experience and the time during which an instantiation of an event takes place may be referred to herein as the “instantiation period” of the event. This relationship between an experience and an event may be considered somewhat conceptually similar to the relationship in programming between a class and an object that is an instantiation of the class. The experience may correspond to some general attributes (that are typically shared by all events that are instantiations of the experience), while each event may have attributes that correspond to its specific instantiation (e.g., a certain user who had the experience, a certain time the experience was experienced, a certain location the certain user had the experience, etc.) Therefore, when the same user has the same experience but at different times, these may be considered different events (with different instantiations periods). For example, a user eating breakfast on Sunday, Feb. 1, 2015 is a different event than the user eating breakfast on Monday, Feb. 2, 2015.

Though in some embodiments it may be easy to determine who the users corresponding to the events are (e.g., via knowledge of which sensors, devices, and/or software agents provide the data), it may not always be easy to determine what are the corresponding experiences the users had. Thus, in some embodiments, it is necessary to identify the experiences users have and to be able to associate measurements of affective response of the users with respective experiences to define events. In general, determining who the user corresponding to an event and/or the experience corresponding to an event are referred to herein as identifying the event.

In some embodiments, events are identified by a module referred to herein as an event annotator. Optionally, an event annotator is a predictor, and/or utilizes a predictor, to identify events. Identifying an event may involve various computational approaches applied to data from various sources that may be used to provide context that can help identify at least one of the following: the user corresponding to the event, the experience corresponding to the event, and/or other properties corresponding to the event (e.g., characteristics of the instantiation of the experience involved in the event and/or situations of the user that are relevant to the event). Following are some examples of types of information and/or information sources that may be used; other sources may be utilized in some embodiments in addition to, or instead of, the examples given below.

Location Information.

Data about a location a user is in and/or data about the change in location of the user (such as the velocity of the user and/or acceleration of the user) may be used in some embodiments to determine what experience the user is having. Optionally, the information may be obtained from a device of the user (e.g., the location may be determined by GPS). Optionally, the information may be obtained from a vehicle the user is in (e.g., from a computer related to an autonomous vehicle the user is in). Optionally, the information may be obtained from monitoring the user; for example, via cameras such as CCTV and/or devices of the user (e.g., detecting signals emitted by a device of the user such as Wi-Fi, Bluetooth, and/or cellular signals). In some embodiments, a location of a user may refer to a place in a virtual world, in which case, information about the location may be obtained from a computer that hosts the virtual world and/or may be obtained from a user interface that presents information from the virtual world to the user.

Images and Other Sensor Information.

Images taken from a device of a user, such as a smartphone or a wearable device such as a smart watch or a head-mounted augmented or virtual reality glasses may be analyzed to determine various aspects of an event. For example, the images may be used to determine what experience the user is having (e.g., exercising, eating a certain food, watching certain content). Additionally or alternatively, images may be used to determine where a user is, and a situation of the user, such as whether the user is alone and/or with company. Additionally or alternatively, detecting who the user is with may be done utilizing transmissions of devices of the people the user is with (e.g., Wi-Fi or Bluetooth signals their devices transmit).

There are various ways in which camera based systems may be utilized to identify events and/or factors of events. In one example, camera based systems such as OrCam (http://www.orcam.com/) may be utilized to identify various objects, products, faces, and/or recognizes text. In some embodiments, images may be utilized to determine the nutritional composition of food a user consumes. In another example, photos of meals may be utilized to generate estimates of food intake and meal composition, such as the approach described in Noronha, et al., “Platemate: crowdsourcing nutritional analysis from food photographs”, Proceedings of the 24th annual ACM symposium on User interface software and technology, ACM, 2011.

In some embodiments, other sensors may be used to identify events, in addition to, or instead of, cameras. Examples of such sensors include microphones, accelerometers, thermometers, pressure sensors, and/or barometers may be used to identify aspects of users' experiences, such as what they are doing (e.g., by analyzing movement patterns) and/or under what conditions (e.g., by analyzing ambient noise, temperature, and/or pressure).

Motion Patterns.

The growing number of sensors (e.g., accelerometers, sensor pressures, or gyroscopes) embedded in devices that are worn, carried, and/or implanted in users, may provide information that can help identify experiences the users are having (e.g., what activity a user is doing at the time). Optionally, this data may be expressed as time series data in which characteristic patterns for certain experiences may be sought. Optionally, the patterns are indicative of certain repetitive motion (e.g., motion patterns characteristic of running, biking, typing, eating, or drinking). Various approaches for inferring an experience from motion data are known in the art. For example, US patent application US20140278219 titled “System and Method for Monitoring Movements of a User”, describes how motion patterns may be used to determine an activity the user is engaged in.

Measurements of the Environment.

Information that is indicative of the environment a user is in may also provide information about an experience the user is having. Optionally, at least some of the measurements of the environment are performed using a device of the user that contains one or more sensors that are used to measure or record the environment. Optionally, at least some of the measurements of the environment are received from sensors that do not belong to devices of the user (e.g., CCTV cameras, or air quality monitors). In one example, measurements of the environment may include taking sound bites from the environment (e.g., to determine whether the user is in a club, restaurant, or in a mall). In another example, images of the environment may be analyzed using various image analysis techniques such as object recognition, movement recognition, and/or facial recognition to determine where the user is, what the user is doing, and/or who the user is with. In yet another example, various measurements of the environment such as temperature, pressure, humidity, and/or particle counts for various types of chemicals or compounds (e.g. pollutants and/or allergens) may be used to determine where the user is, what the user is doing, and/or what the user is exposed to.

Objects/Devices with the User.

Information about objects and/or devices in the vicinity of a user may be used to determine what experience a user is having. Knowing what objects and/or devices are in the vicinity of a user may provide context relevant to identifying the experience. For example, if a user packs fishing gear in the car, it means that the user will likely be going fishing while if the user puts a mountain bike on the car, it is likely the user is going biking. Information about the objects and/or devices in the vicinity of a user may come from various sources. In one example, at least some of this information is provided actively by objects and/or devices that transmit information identifying their presence. For example, the objects or devices may transmit information via Wi-Fi or Bluetooth signals. Optionally, some of the objects and/or devices may be connected via the Internet (e.g., as part of the Internet of Things). In another example, at least some of this information is received by transmitting signals to the environment and detecting response signals (e.g., signals from RFID tags embedded in the objects and/or devices). In yet another example, at least some of the information is provided by a software agent that monitors the belongings of a user. In still another example, at least some of the information is provided by analyzing the environment in which a user is in (e.g., image analysis and/or sound analysis). Optionally, image analysis may be used to gain specific characteristics of an experience. For example, a system of Noronha et al., described in “Platemate: crowdsourcing nutritional analysis from food photographs” in Proceedings of the 24th annual ACM symposium on User interface software and technology (2011), enables a user to identify and receive nutritional information involving food the user is about to eat based on images of the food.

Communications of the User.

Information derived from communications of a user (e.g., email, text messages, voice conversations, and/or video conversations) may be used, in some embodiments, to provide context and/or to identify experiences the user has, and/or other aspects of events. These communications may be analyzed, e.g., using semantic analysis in order to determine various aspects corresponding to events, such as what experience a user has, a situation of a user (e.g., the user's mood and/or state of mind).

User Calendar/Schedule.

A user's calendar that lists activities the user had in the past and/or will have in the future may provide context and/or to identify experiences the user has. Optionally, the calendar includes information such as a period, location, and/or other contextual information for at least some of the experiences the user had or will have.

Account Information.

Information in various accounts maintained by a user (e.g., digital wallets, bank accounts, or social media accounts) may be used to provide context, identify events, and/or certain aspects of the events. Information on those accounts may be used to determine various aspects of events such as what experiences the user has (possibly also determining when, where, and with whom), situations the user is in at the time (e.g., determining that the user is in a new relationship and/or after a breakup). For example, transactions in a digital wallet may provide information of venues visited by a user, products purchased, and/or content consumed by the user. Optionally, the accounts involve financial transactions such as a digital wallet, or a bank account. Optionally, the accounts involve content provided to the user (e.g., an account with a video streaming service and/or an online game provider). In some embodiments, an account may include medical records including genetic records of a user (e.g., a genetic profile that includes genotypic and/or phenotypic information). Optionally, the genetic information may be used to determine certain situations the user is in which may correspond to certain genetic dispositions (e.g., likes or dislikes of substances, a tendency to be hyperactive, or a predisposition for certain diseases).

Experience Providers.

An experience provider may provide information about an experience a user is having, such as the type of experience and/or other related information (e.g., specific details of attributes of events and/or attributes that are relevant). For example, a game console and/or system hosting a virtual world may provide information related to actions of the user and/or other things that happen to the user in the game and/or the virtual world (e.g., the information may relate to virtual objects the user is interacting with, the identity of other characters, and the occurrence of certain events such as losing a life or leveling up). In another example, a system monitoring and/or managing the environment in a “smart house” house may provide information regarding the environment the user is in.

There are various approaches known in the art for identifying, indexing, and/or searching events of one or more users, which may be utilized in embodiments described herein (e.g., to create event annotators described below). In one example, identifying events may be done according to the teachings described in U.S. Pat. No. 9,087,058 titled “Method and apparatus for enabling a searchable history of real-world user experiences”, which describes a searchable history of real-world user experiences of a user utilizing data captured by a mobile computing device. In another example, identifying events may be done according to the teachings described in U.S. Pat. No. 8,762,102 titled “Methods and systems for generation and rendering interactive events having combined activity and location information”, which describes identification of events based on sensor data of mobile devices.

In some embodiments, identifying events of a user is done, at least in part, by a software agent operating on behalf of the user. Optionally, the software agent may monitor the user and/or provide information obtained from monitoring the user to other parties. Optionally, the software agent may have access to a model of the user (e.g., a model comprising biases of the user), and utilize the model to analyze and/or process information collected from monitoring the user (where the information may be collected by the software agent or another entity). Thus, in some embodiments, an event annotator used to identify events of a user may be a module of a software agent operating on behalf of the user and/or an event annotator may be in communication with a software agent operating on behalf of the user.

As used herein, “software agent” may refer to one or more computer programs that operate on behalf of an entity. For example, an entity may be a person, a group of people, an institution, a computer, and/or computer program (e.g., an artificial intelligence). Software agents may be sometimes referred to by terms including the words “virtual” and/or “digital”, such as “virtual agents”, “virtual helpers”, “digital assistants”, and the like. Software agents are discussed in further detail in Section 11 (“Software Agents”) in U.S. application Ser. No. 15/051,892, published as U.S. 2016/0170996, which is incorporated herein by reference in its entirety.

In some embodiments, a measurement of affective response corresponding to a certain event may be based on values that are measured with one or more sensors at different times during the certain event's instantiation period or shortly after it (this point is discussed in further detail above in this disclosure and in Section 6—Measurements of Affective Response in U.S. application Ser. No. 15/051,892, published as U.S. 2016/0170996, which is incorporated herein by reference in its entirety). It is to be noted that in the following discussion, the values may themselves be considered measurements of affective response. However, for the purpose of being able to distinguish, in the discussion below, between a measurement of affective response corresponding to an event, and values upon which the measurement is based, the term “measurement of affective response” is not used when referring to the values measured by the one or more sensors. However, this distinction is not meant to rule out the possibility that the measurement of affective response corresponding to the certain event comprises the values.

When there are no other events overlapping with the certain event, the values measured with the one or more sensors may be assumed to represent the affective response corresponding to the certain event. However, when this is not the case, and there are one or more events with instantiation periods overlapping with the instantiation of the certain event, then in some embodiments, that assumption may not hold. For example, if for a certain period during the instantiation of the certain event, there may be another event with an instantiation that overlaps with the instantiation of the certain event, then during the certain period, the user's affective response may be associated with the certain event, the other event, and/or both events. In some cases, if the other event is considered part of the certain event, e.g., the other event is a mini-event corresponds to an experience that is part of a “larger” experience to which the certain event corresponds, then this fact may not matter much (since the affective response may be considered to be directed to both events). However, if the other event is not a mini-event that is part of the certain event, then associating the affective response measured during the certain period with both events may produce an inaccurate measurement corresponding to the certain event. For example, if the certain event corresponds to an experience of eating a meal, and during the meal the user receives an annoying phone call (this is the “other event”), then it may be preferable not to associate the affective response expressed during the phone call with the meal.

It is to be noted that in some embodiments, the fact that unrelated events may have overlapping instantiation periods may be essentially ignored when computing measurements of affective response corresponding to the events. For example, a measurement of affective response corresponding to the certain event may be an average of values acquired by a sensor throughout the instantiation of the certain event, without regard to whether there were other overlapping events at the same time. One embodiment, for example, in which such an approach may be useful is an embodiment in which the certain event has a long instantiation period (e.g., going on a vacation), while the overlapping events are relatively short (e.g., intervening phone calls with other people). In this embodiment, filtering out short periods in which the user's attention was not focused on the experience corresponding to the certain event may not lead to significant changes in the value of the measurement of affective response corresponding to the certain event (e.g., because most of the values upon which the measurement is based still correspond to the certain event and not to other events).

Events can have multiple measurements associated with them that are taken during various times. For example, a measurement corresponding to an event may comprise, and/or be based on, values measured when the user corresponding to the event starts having the experience corresponding to the event, throughout the period during which the user has the experience, and possibly sometime after having the experience. In another example, the measurement may be based on values measured before the user starts having the experience (e.g., in order to measure effects of anticipation and/or in order to establish a baseline value based on the measurement taken before the start). Various aspects concerning how a measurement of affective response corresponding to an event is computed are described in more detail at least in Section 6 (“Measurements of Affective Response”) in U.S. application Ser. No. 15/051,892, published as U.S. 2016/0170996, which is incorporated herein by reference in its entirety.

Events may belong to one or more sets of events. Considering events in the context of sets of events may be done for one or more various purposes, in embodiments described herein. For example, in some embodiments, events may be considered in the context of a set of events in order to compute a crowd-based result, such as a score for an experience, based on measurements corresponding to the events in the set. In other embodiments, events may be considered in the context of a set of events in order to evaluate a risk to the privacy of the users corresponding to the events in the set from disclosing a score computed based on measurements of the users. Optionally, events belonging to a set of events may be related in some way, such as the events in the set of events all taking place during a certain period of time or under similar conditions. Additionally, it is possible in some embodiments, for the same event to belong to multiple sets of events, while in other embodiments, each event may belong to at most a single set of events.

In one embodiment, a set of events may include events corresponding to the same certain experience (i.e., instances where users had the experience). Measurements of affective response corresponding to the set of events comprise measurements of affective response of the users corresponding to the events to having the certain experience, which were taken during periods corresponding to the events (e.g., during the instantiation periods of the events or shortly after them).

In another embodiment, a set of events may be defined by the fact that the measurements corresponding to the set of events are used to compute a crowd-based result, such as a score for an experience. In one example, a set of events may include events involving users who ate a meal in a certain restaurant during a certain day. From measurements of the users corresponding to the events, a score may be derived, which represents the quality of meals served at the restaurant that day. In another example, a set of events may involve users who visited a location, such as a certain hotel, during a certain month, and a score generated from measurements of the affective response corresponding to the set of events may represent the quality of the experience of staying at the hotel during the certain month.

In yet another embodiment, a set of events may include an arbitrary collection of events that are grouped together for a purpose of a certain computation and/or analysis.

Predictors and Emotional State Estimators

In some embodiments, a module that receives a query that includes a sample (e.g., a vector including one or more feature values) and computes a label for that sample (e.g., a class identifier or a numerical value), is referred to as a “predictor” and/or an “estimator”. Optionally, a predictor and/or estimator may utilize a model to assign labels to samples. In some embodiments, a model used by a predictor and/or estimator is trained utilizing a machine learning-based training algorithm. Optionally, when a predictor and/or estimator return a label that corresponds to one or more classes that are assigned to the sample, these modules may be referred to as “classifiers”.

The terms “predictor” and “estimator” may be used interchangeably in this disclosure. Thus, a module that is referred to as a “predictor” may receive the same type of inputs as a module that is called an “estimator”, it may utilize the same type of machine learning-trained model, and/or produce the same type of output. However, as commonly used in this disclosure, the input to an estimator typically includes values that come from measurements, while a predictor may receive samples with arbitrary types of input. For example, a module that identifies what type of emotional state a user was likely in based on measurements of affective response of the user, is referred to herein as an Emotional State Estimator (ESE). Additionally, a model utilized by an ESE may be referred to as an “emotional state model” and/or an “emotional response model”.

A sample provided to a predictor and/or an estimator in order to receive a label for it may be referred to as a “query sample” or simply a “sample”. A value returned by the predictor and/or estimator, which it computed from a sample given to it as an input, may be referred to herein as a “label”, a “predicted value”, and/or an “estimated value”. A pair that includes a sample and a corresponding label may be referred to as a “labeled sample”. A sample that is used for the purpose of training a predictor and/or estimator may be referred to as a “training sample” or simply a “sample”. Similarly, a sample that is used for the purpose of testing a predictor and/or estimator may be referred to as a “testing sample” or simply a “sample”. In typical embodiments, samples used by the same predictor and/or estimator for various purposes (e.g., training, testing, and/or a query) are assumed to have a similar structure (e.g., similar dimensionality) and are assumed to be generated in a similar process (e.g., they undergo the same type of preprocessing).

In some embodiments, a sample for a predictor and/or estimator includes one or more feature values. Optionally, at least some of the feature values are numerical values (e.g., integer and/or real values). Optionally, at least some of the feature values may be categorical values that may be represented as numerical values (e.g., via indices for different categories). Optionally, the one or more feature values comprised in a sample may be represented as a vector of values. Various preprocessing, processing, and/or feature extraction techniques known in the art may be used to generate the one or more feature values comprised in a sample. Additionally, in some embodiments, samples may contain noisy or missing values. There are various methods known in the art that may be used to address such cases.

In some embodiments, a label that is a value returned by a predictor and/or an estimator in response to receiving a query sample, may include one or more types of values. For example, a label may include a discrete categorical value (e.g., a category), a numerical value (e.g., a real number), a set of categories and/or numerical values, and/or a multidimensional value (e.g., a point in multidimensional space, a database record, and/or another sample).

Predictors and estimators may utilize, in various embodiments, different types of models in order to compute labels for query samples. A plethora of machine learning algorithms is available for training different types of models that can be used for this purpose. Some of the algorithmic approaches that may be used for creating a predictor and/or estimator include classification, clustering, function prediction, regression, and/or density estimation. Those skilled in the art can select the appropriate type of model and/or training algorithm depending on the characteristics of the training data (e.g., its dimensionality or the number of samples), and/or the type of value used as labels (e.g., a discrete value, a real value, or a multidimensional value).

In one example, classification methods like Support Vector Machines (SVMs), Naive Bayes, nearest neighbor, decision trees, logistic regression, and/or neural networks can be used to create a model for predictors and/or estimators that predict discrete class labels. In another example, methods like SVMs for regression, neural networks, linear regression, logistic regression, and/or gradient boosted decision trees can be used to create a model for predictors and/or estimators that return real-valued labels, and/or multidimensional labels. In yet another example, a predictor and/or estimator may utilize clustering of training samples in order to partition a sample space such that new query samples can be placed in one or more clusters and assigned labels according to the clusters to which they belong. In a somewhat similar approach, a predictor and/or estimator may utilize a collection of labeled samples in order to perform nearest neighbor classification (in which a query sample is assigned a label according to one or more of the labeled samples that are nearest to it when embedded in some space).

The type and quantity of training data used to train a model utilized by a predictor and/or estimator can have a dramatic influence on the quality of the results they produce. Generally speaking, the more data available for training a model, and the more the training samples are similar to the samples on which the predictor and/or estimator will be used (also referred to as test samples), the more accurate the results for the test samples are likely to be. Therefore, when training a model that will be used with samples involving a specific user, it may be beneficial to collect training data from the user (e.g., data comprising measurements of the specific user). In such a case, a predictor may be referred to as a “personalized predictor”, and similarly, an estimator may be referred to as a “personalized estimator”.

Training a predictor and/or an estimator, and/or utilizing the predictor and/or the estimator, may be done utilizing various computer system architectures. In particular, some architectures may involve a single machine (e.g., a server) and/or single processor, while other architectures may be distributed, involving many processors and/or servers (e.g., possibly thousands or more processors on various machines). For example, some predictors may be trained utilizing distributed architectures such as Hadoop, by running distributed machine learning-based algorithms. In this example, it is possible that each processor will only have access to a portion of the training data. Another example of a distributed architecture that may be utilized in some embodiments is a privacy-preserving architecture in which users process their own data. In this example, a distributed machine learning training algorithm may allow a certain portion of the training procedure to be performed by users, each processing their own data and providing statistics computed from the data rather than the actual data itself. The distributed training procedure may then aggregate the statistics in order to generate a model for the predictor.

It is to be noted that in this disclosure, referring to a module (e.g., a predictor, an estimator, an event annotator, etc.) and/or a model as being “trained on” data means that the data is utilized for training of the module and/or model. Thus, expressions of the form “trained on” may be used interchangeably with expressions such as “trained with”, “trained utilizing”, and the like.

A predictor and/or an estimator that receives a query sample that includes features derived from a measurement of affective response of a user, and returns a value indicative of an emotional state corresponding to the measurement, may be referred to as a predictor and/or estimator of emotional state based on measurements, an Emotional State Estimator, and/or an ESE. Optionally, an ESE may receive additional values as input, besides the measurement of affective response, such as values corresponding to an event to which the measurement corresponds. Optionally, a result returned by the ESE may be indicative of an emotional state of the user that may be associated with a certain emotion felt by the user at the time such as happiness, anger, and/or calmness, and/or indicative of level of emotional response, such as the extent of happiness felt by the user. Additionally or alternatively, a result returned by an ESE may be an affective value, for example, a value indicating how well the user feels on a scale of 1 to 10.

In some embodiments, when a predictor and/or an estimator (e.g., an ESE), is trained on data collected from multiple users, its predictions of emotional states and/or response may be considered predictions corresponding to a representative user. It is to be noted that the representative user may in fact not correspond to an actual single user, but rather correspond to an “average” of a plurality of users.

In some embodiments, a label returned by an ESE may represent an affective value. In particular, in some embodiments, a label returned by an ESE may represent an affective response, such as a value of a physiological signal (e.g., skin conductance level, a heart rate) and/or a behavioral cue (e.g., fidgeting, frowning, or blushing). In other embodiments, a label returned by an ESE may be a value representing a type of emotional response and/or derived from an emotional response. For example, the label may indicate a level of interest and/or whether the response can be classified as positive or negative (e.g., “like” or “dislike”). In another example, a label may be a value between 0 and 10 indicating a level of how much an experience was successful from a user's perspective (as expressed by the user's affective response).

There are various methods that may be used by an ESE to estimate emotional states from a measurement of affective response. Examples of general purpose machine learning algorithms that may be utilized are given above in the general discussion about predictors and/or estimators. In addition, there are various methods specifically designed for estimating emotional states based on measurements of affective response. Some non-limiting examples of methods described in the literature, which may be used in some embodiments include: (i) physiological-based estimators as described in Table 2 in van den Broek, E. L., et al. (2010) “Prerequisites for Affective Signal Processing (ASP)—Part II.” in: Third International Conference on Bio Inspired Systems and Signal Processing, Biosignals 2010; (ii) Audio- and image-based estimators as described in Tables 2-4 in Zeng, Z., et al. (2009) “A Survey of Affect Recognition Methods: Audio, Visual, and Spontaneous Expressions.” in IEEE Transaction on Pattern Analysis and Machine Intelligence, Vol. 31(1), 39-58; (iii) emotional state estimations based on EEG signals may be done utilizing methods surveyed in Kim et al. (2013) “A review on the computational methods for emotional state estimation from the human EEG” in Computational and mathematical methods in medicine, Vol. 2013, Article ID 573734; (iv) emotional state estimations from EEG and other peripheral signals (e.g., GSR) may be done utilizing the teachings of Chanel, Guillaume, et al. “Emotion assessment from physiological signals for adaptation of game difficulty” in IEEE Transactions on Systems, Man and Cybernetics, Part A: Systems and Humans, 41.6 (2011): 1052-1063; and/or (v) emotional state estimations from body language (e.g., posture and/or body movements), may be done using methods described by Dael, et al. (2012), “Emotion expression in body action and posture”, in Emotion, 12(5), 1085.

In some embodiments, an ESE may make estimations based on a measurement of affective response that comprises data from multiple types of sensors (often referred to in the literature as multiple modalities). This may optionally involve fusion of data from the multiple modalities. Different types of data fusion techniques may be employed, for example, feature-level fusion, decision-level fusion, or model-level fusion, as discussed in Nicolaou et al. (2011), “Continuous Prediction of Spontaneous Affect from Multiple Cues and Modalities in Valence-Arousal Space”, IEEE Transactions on Affective Computing. Another example of the use of fusion-based estimators of emotional state may be found in Schels et al. (2013), “Multi-modal classifier-fusion for the recognition of emotions”, Chapter 4 in Coverbal Synchrony in Human Machine Interaction. The benefits of multimodal fusion typically include more resistance to noise (e.g., noisy sensor measurements) and missing data, which can lead to better affect detection when compared to affect detection from a single modality. For example, in meta-analysis described in D'mello and Kory (2015) “A Review and Meta-Analysis of Multimodal Affect Detection Systems” in ACM Computing Surveys (CSUR) 47.3: 43, multimodal affect systems were found to be more accurate than their best unimodal counterparts in 85% of the systems surveyed.

In one embodiment, in addition to a measurement of affective response of a user, an ESE may receive as input a baseline affective response value corresponding to the user. Optionally, the baseline affective response value may be derived from another measurement of affective response of the user (e.g., an earlier measurement) and/or it may be a predicted value (e.g., based on measurements of other users and/or a model for baseline affective response values). Accounting for the baseline affective response value (e.g., by normalizing the measurement of affective response according to the baseline), may enable the ESE, in some embodiments, to more accurately estimate an emotional state of a user based on the measurement of affective response.

In some embodiments, an ESE may receive as part of the input (in addition to a measurement of affective response), additional information comprising feature values related to the user, experience and/or event to which the measurement corresponds. Optionally, additional information is derived from a description of an event to which the measurement corresponds.

In some embodiments, an ESE may be utilized to evaluate, from measurements of affective response of one or more users, whether the one or more users are in an emotional state that may be manifested via a certain affective response. Optionally, the certain affective response is manifested via changes to values of at least one of the following: measurements of physiological signals of the one or more users, and measurements of behavioral cues of the one or more users. Optionally, the changes to the values are manifestations of an increase or decrease, to at least a certain extent, in a level of at least one of the following emotions: pain, anxiety, annoyance, stress, aggression, aggravation, fear, sadness, drowsiness, apathy, anger, happiness, contentment, calmness, attentiveness, affection, and excitement. Optionally, an ESE is utilized to detect an increase, to at least a certain extent, in the level of at least one of the aforementioned emotions.

In one embodiment, determining whether a user experiences a certain affective response is done utilizing a model trained on data comprising measurements of affective response of the user taken while the user experienced the certain affective response (e.g., measurements taken while the user was happy or sad). Optionally, determining whether a user experiences a certain affective response is done utilizing a model trained on data comprising measurements of affective response of other users taken while the other users experienced the certain affective response.

In some embodiments, certain values of measurements of affective response, and/or changes to certain values of measurements of affective response, may be universally interpreted as corresponding to being in a certain emotional state. For example, an increase in heart rate and perspiration (e.g., measured with GSR) may correspond to an emotional state of fear. Thus, in some embodiments, any ESE may be considered “generalized” in the sense that it may be used successfully for estimating emotional states of users who did not contribute measurements of affective response to the training data. In other embodiments, the context information described above, which an ESE may receive, may assist in making the ESE generalizable and useful for interpreting measurements of users who did not contribute measurements to the training data and/or for interpreting measurements of experiences that are not represented in the training data.

In one embodiment, a personalized ESE for a certain user may be utilized to interpret measurements of affective response of the certain user. Optionally, the personalized ESE is utilized by a software agent operating on behalf of the certain user to better interpret the meaning of measurements of affective response of the user. For example, a personalized ESE may better reflect the personal tendencies, idiosyncrasies, unique behavioral patterns, mannerisms, and/or quirks related to how a user expresses certain emotions. By being in position in which it monitors a user over long periods of time, in different situations, and while having different experiences, a software agent may be able to observe affective responses of “its” user (the user on behalf of whom it operates) when the user expresses various emotions. Thus, the software agent can learn a model describing how the user expresses emotion, and use that model for personalized ESE that might, in some cases, “understand” its user better than a “general” ESE trained on data obtained from multiple users.

Training a personalized ESE for a user may require acquiring appropriate training samples. These samples typically comprise measurements of affective response of the user (from which feature values may be extracted) and labels corresponding to the samples, representing an emotional response the user had when the measurements were taken. Inferring what emotional state the user was in, at a certain time measurements were taken, may be done in various ways, such as self-reports from the user, annotations done by an observer (human or automated), semantic analysis of communications of the user, behavioral analysis of the user, and/or analysis of actions of the user (e.g., voting on a social network site or interacting with a media controller).

A software agent may be utilized for training a personalized ESE of a user on behalf of whom the software agent operates. For example, the software agent may monitor the user and at times query the user to determine how the user feels (e.g., represented by an affective value on a scale of 1 to 10). After a while, the software agent may have a model of the user that is more accurate at interpreting “its” user than a general ESE. Additionally, by utilizing a personalized ESE, the software agent may be better capable of integrating multiple values (e.g., acquired by multiple sensors and/or over a long period of time) in order to represent how the user feels at the time using a single value (e.g., an affective value on a scale of 1 to 10).

A more detailed discussion regarding predictors and ESEs may be found in Section 10 (“Predictors and Emotional State Estimators”), n U.S. application Ser. No. 15/051,892, published as U.S. 2016/0170996, which is incorporated herein by reference in its entirety.

Crowd-Based Applications

Various embodiments described herein utilize systems whose architecture includes a plurality of sensors and a plurality of user interfaces. This architecture supports various forms of crowd-based recommendation systems in which users may receive information, such as suggestions and/or alerts, which are determined based on measurements of affective response collected by the sensors (and/or based on results obtained from measurements of affective response, such as the functions describing affective response in different environmental conditions mentioned above). In some embodiments, being crowd-based means that the measurements of affective response are taken from a plurality of users, such as at least three, ten, one hundred, or more users. In such embodiments, it is possible that the recipients of information generated from the measurements may not be the same users from whom the measurements were taken.

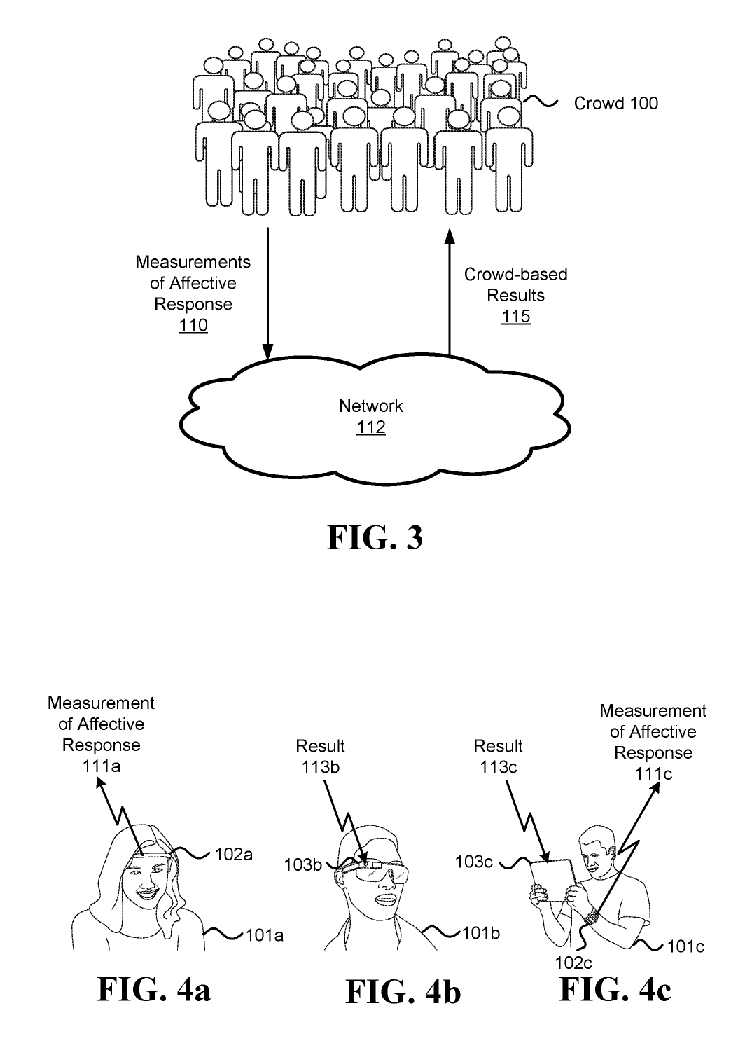

FIG. 3 illustrates one embodiment of an architecture that includes sensors and user interfaces, as described above. The crowd 100 of users comprises sensors coupled to at least some individual users. For example, FIG. 4a and FIG. 4c illustrate cases in which a sensor is coupled to a user. The sensors take the measurements 110 of affective response, which are transmitted via a network 112. Optionally, the measurements 110 are sent to one or more servers that host modules belonging to one or more of the systems described in various embodiments in this disclosure (e.g., systems that compute scores for experiences and/or learn parameters of functions that describe affective response).

A plurality of sensors may be used, in various embodiments described herein, to take the measurements of affective response of the plurality of users. Each of the plurality of sensors (e.g., the sensor 102a) may be a sensor that captures a physiological signal and/or a behavioral cue. Optionally, a measurement of affective response of a user is typically taken by a specific sensor related to the user (e.g., a sensor attached to the body of the user and/or embedded in a device of the user). Optionally, some sensors may take measurements of more than one user (e.g., the sensors may be cameras taking images of multiple users). Optionally, the measurements taken of each user are of the same type (e.g., the measurements of all users include heart rate and skin conductivity measurements). Optionally, different types of measurements may be taken from different users. For example, for some users the measurements may include brainwave activity captured with EEG and heart rate, while for other users the measurements may include only heart rate values.

The network 112 represents one or more networks used to carry the measurements 110 and/or crowd-based results 115 computed based on measurements. It is to be noted that the measurements 110 and/or crowd-based results 115 need not be transmitted via the same network components. Additionally, different portions of the measurements 110 (e.g., measurements of different individual users) may be transmitted using different network components or different network routes. In a similar fashion, the crowd-based results 115 may be transmitted to different users utilizing different network components and/or different network routes.

Herein, a network, such as the network 112, may refer to various types of communication networks, including, but not limited to, a local area network (LAN), a wide area network (WAN), Ethernet, intranet, the Internet, a fiber communication network, a wired communication network, a wireless communication network, and/or a combination thereof.

In some embodiments, the measurements 110 of affective response are transmitted via the network 112 to one or more servers. Each of the one or more servers includes at least one processor and memory. Optionally, the one or more servers are cloud-based servers. Optionally, some of the measurements 110 are stored and transmitted in batches (e.g., stored on a device of a user being measured). Additionally or alternatively, some of the measurements are broadcast within seconds of being taken (e.g., via Wi-Fi transmissions). Optionally, some measurements of a user may be processed prior to being transmitted (e.g., by a device and/or software agent of the user). Optionally, some measurements of a user may be sent as raw data, essentially in the same form as received from a sensor used to measure the user. Optionally, some of the sensors used to measure a user may include a transmitter that may transmit measurements of affective response, while others may forward the measurements to another device capable of transmitting them (e.g., a smartphone belonging to a user).

Depending on the embodiment being considered, the crowd-based results 115 may include various types of values that may be computed by systems described in this disclosure based on measurements of affective response. For example, the crowd-based results 115 may refer to scores for experiences (e.g., score 164), notifications about affective response to experiences, recommendations regarding experiences (e.g., recommendation 179), and/or various rankings of experiences. Additionally or alternatively, the crowd-based results 115 may include, and/or be derived from, parameters of various functions learned from measurements (e.g., function parameters 362).

In some embodiments, the various crowd-based results described above and elsewhere in this disclosure, may be presented to users (e.g., through graphics and/or text on display, or presented by a software agent via a user interface). Additionally or alternatively, the crowd-based results may serve as an input to software systems (e.g., software agents) that make decisions for a user (e.g., what experiences to book for the user and/or suggest to the user). Thus, crowd-based results computed in embodiments described in this disclosure may be utilized (indirectly) by a user via a software agent operating on behalf of a user, even if the user does not directly receive the results or is even aware of their existence.

In some embodiments, the crowd-based results 115 that are computed based on the measurements 110 include a single value or a single set of values that is provided to each user that receives the crowd-based results 115. In such a case, the crowd-based results 115 may be considered general crowd-based results, since each user who receives a result computed based on the measurements 110 receives essentially the same thing. In other embodiments, the crowd-based results 115 that are computed based on the measurements 110 include various values and/or various sets of values that are provided to users that receive the crowd-based results 115. In this case, the crowd-based results 115 may be considered personalized crowd-based results, since a user who receives a result computed based on the measurements 110 may receive a result that is different from the result received by another user. Optionally, personalized results are obtained utilizing an output produced by personalization module 130.

An individual user 101, belonging to the crowd 100, may contribute a measurement of affective response to the measurements 110 and/or may receive a result from among the various types of the crowd-based results 115 described in this disclosure. This may lead to various possibilities involving what users contribute and/or receive in an architecture of a system such as the one illustrated in FIG. 3.

In some embodiments, at least some of the users from the crowd 100 contribute measurements of affective response (as part of the measurements 110), but do not receive results computed based on the measurements they contributed. An example of such a scenario is illustrated in FIG. 4a, where a user 101a is coupled to a sensor 102a (which in this illustration measures brainwave activity via EEG) and contributes a measurement 111a of affective response, but does not receive a result computed based on the measurement 111a.

In a somewhat reverse situation to the one described above, in some embodiments, at least some of the users from the crowd 100 receive a result from among the crowd-based results 115, but do not contribute any of the measurements of affective response used to compute the result they receive. An example of such a scenario is illustrated in FIG. 4b, where a user 101b is coupled to a user interface 103b (which in this illustration are augmented reality glasses) that presents a result 113b, which may be, for example, a score for an experience. However, in this illustration, the user 101b does not provide a measurement of affective response that is used for the generation of the result 113b.

And in some embodiments, at least some of the users from the crowd 100 contribute measurements of affective response (as part of the measurements 110), and receive a result, from among the crowd-based results 115, computed based on the measurements they contributed. An example of such a scenario is illustrated in FIG. 4c, where a user 101c is coupled to a sensor 102c (which in this illustration is a smartwatch that measures heart rate and skin conductance) and contributes a measurement 111c of affective response. Additionally, the user 101c has a user interface 103c (which in this illustration is a tablet computer) that presents a result 113c, which may be for example a ranking of multiple experiences generated utilizing the measurement 111c that the user 101c provided.

A “user interface”, as the term is used in this disclosure, may include various components that may be characterized as being hardware, software, and/or firmware. In some examples, hardware components may include various forms of displays (e.g., screens, monitors, virtual reality displays, augmented reality displays, hologram displays), speakers, scent generating devices, and/or haptic feedback devices (e.g., devices that generate heat and/or pressure sensed by the user). In other examples, software components may include various programs that render images, video, maps, graphs, diagrams, augmented annotations (to appear on images of a real environment), and/or video depicting a virtual environment. In still other examples, firmware may include various software written to persistent memory devices, such as drivers for generating images on displays and/or for generating sound using speakers. In some embodiments, a user interface may be a single device located at one location, e.g., a smart phone and/or a wearable device. In other embodiments, a user interface may include various components that are distributed over various locations. For example, a user interface may include both certain display hardware (which may be part of a device of the user) and certain software elements used to render images, which may be stored and run on a remote server.

It is to be noted that, though FIG. 4a to FIG. 4c illustrate cases in which users have a single sensor device coupled to them and/or a single user interface, the concepts described above in the discussion about FIG. 4a to FIG. 4c may be naturally extended to cases where users have multiple sensors coupled to them (of the various types described in this disclosure or others) and/or multiple user interfaces (of the various types described in this disclosure or others).

Additionally, it is to be noted that users may contribute measurements at one time and receive results at another (which were not computed from the measurements they contributed). Thus, for example, the user 101a in FIG. 4a might have contributed a measurement to compute a score for an experience on one day, and received a score for that experience (or another experience) on her smartwatch (not depicted) on another day. Similarly, the user 101b in FIG. 4b may have sensors embedded in his clothing (not depicted) and might be contributing measurements of affective response to compute a score for an experience the user 101b is having, while the result 113b that the user 101b received, is not based on any of the measurements the user 101b is currently contributing.

In this disclosure, a crowd of users is often designated by the reference numeral 100. The reference numeral 100 is used to designate a general crowd of users. Typically, a crowd of users in this disclosure includes at least three users, but may include more users. For example, in different embodiments, the number of users in the crowd 100 falls into one of the following ranges: 3 to 9, 10 to 24, 25-99, 100-999, 1000-9999, 10000-99999, 100000-1000000, and more than one million users. Additionally, the reference numeral 100 is used to designate users having a general experience, which may involve one or more instances of the various types of experiences described in this disclosure. For example, the crowd 100 may include users that are at a certain location, users engaging in a certain activity, and/or users utilizing a certain product.

When a crowd is designated with another reference numeral (other than 100), this typically signals that the crowd has a certain characteristic. A different reference numeral for a crowd may be used when describing embodiments that involve specific experiences. For example, in an embodiment that describes a system that ranks experiences, the crowd may be referred to by the reference numeral 100. However, in an embodiment that describes ranking of locations, the crowd may be designated by another reference numeral, since in this embodiment, the users in the crowd have a certain characteristic (they are at locations), rather than being a more general crowd of users who are having one or more experiences, which may be any of the experiences described in this disclosure.

In a similar fashion, measurements of affective response are often designated by the reference numeral 110. The reference numeral 110 is used to designate measurements of affective response of users belonging to the crowd 100. Thus, the reference numeral 110 is typically used to designate measurements of affective response in embodiments that involve users having one or more experiences, which may possibly be any of the experiences described in this disclosure.

Unless indicated otherwise when describing a certain embodiment, the one or more experiences may be of various types of experiences described in this disclosure. In one example, an experience from among the one or more experiences may involve one or more of the following: spending time at a certain location, having a social interaction with a certain entity in the physical world, having a social interaction with a certain entity in a virtual world, viewing a certain live performance, performing a certain exercise, traveling a certain route, spending time in an environment characterized by a certain environmental condition, shopping, and going on a social outing with people. In another example, an experience from among the one more experiences may be characterized via various attributes and/or combinations of attributes such as an experience involving engaging in a certain activity at a certain location, an experience involving visiting a certain location for a certain duration, and so on.

In embodiments described herein, measurements of affective response, such as the measurements 110 and/or measurements referred to by other reference numerals, are taken utilizing sensors coupled to the users. A measurement of affective response of a user, taken utilizing a sensor coupled to the user, includes at least one of the following: a value representing a physiological signal of the user, and a value representing a behavioral cue of the user. Optionally, a measurement of affective response corresponding to an event in which a user has an experience is based on values acquired by measuring the user with the sensor during at least three different non-overlapping periods while the user has the experience corresponding to the event. Additional information regarding how measurements of affective response may be obtained from values captured by sensors may be found at least in this disclosure (in the section “Sensors and Measurements of Affective Response”) and in Section 6 (“Measurements of Affective Response”) in U.S. application Ser. No. 15/051,892, published as U.S. 2016/0170996, which is incorporated herein by reference in its entirety.

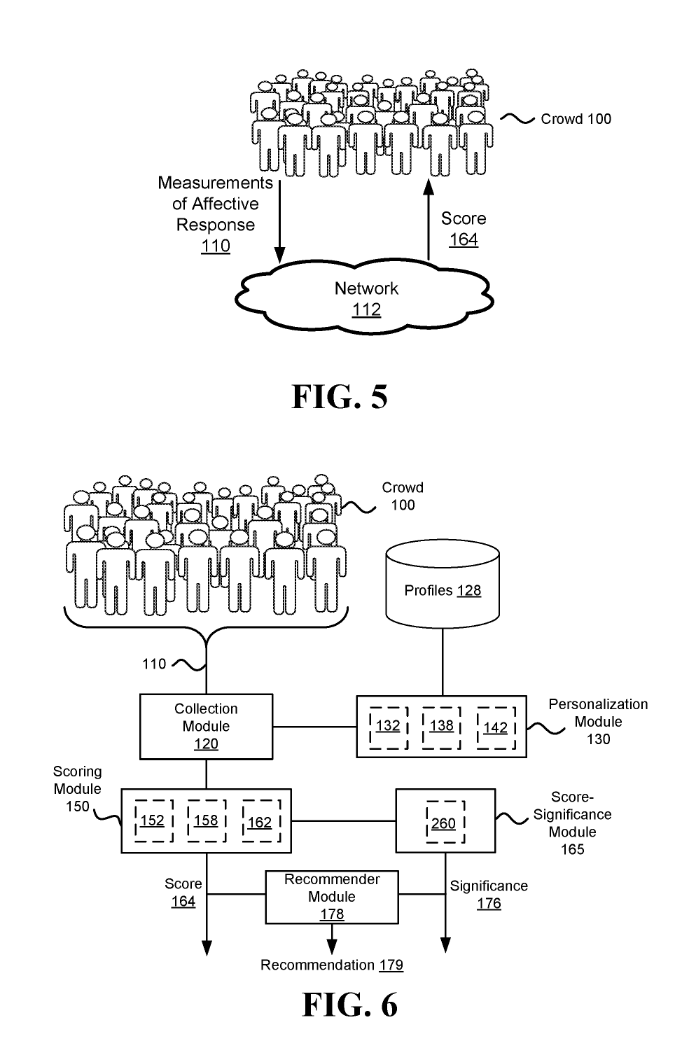

FIG. 3 illustrates an architecture that may be utilized for various embodiments involving acquisition of measurements of affective response and reporting of results computed based on the measurements. One example of a utilization of such an architecture is given in FIG. 5, which illustrates a system configured to compute score 164 for a certain experience. The system computes the score 164 based on measurements 110 of affective response utilizing at least sensors and user interfaces. The sensors are utilized to take the measurements 110, which include measurements of at least ten users from the crowd 100, each of which is coupled to a sensor such as the sensors 102a and/or 102c. Optionally, at least some of the sensors are configured to take measurements of physiological signals of the at least ten users. Additionally or alternatively, at least some of the sensors are configured to take measurements of behavioral cues of the at least ten users.

Each measurement of the user is taken by a sensor coupled to the user, while the user has the certain experience or shortly after. Optionally, “shortly after” refers to a time that is at most ten minutes after the user finishes having the certain experience. Optionally, the measurements may be transmitted via network 112 to one or more servers that are configured to compute a score for the certain experience based on the measurements 110. Optionally, the servers are configured to compute scores for experiences based on measurements of affective response, such as the system illustrated in FIG. 6.

The user interfaces are configured to receive data, via the network 112, describing the score computed based on the measurements 110. Optionally, the score 164 represents the affective response of the at least ten users to having the certain experience. The user interfaces are configured to report the score to at least some of the users belonging to the crowd 100. Optionally, at least some users who are reported the score 164 via user interfaces are users who contributed measurements to the measurements 110 which were used to compute the score 164. Optionally, at least some users who are reported the score 164 via user interfaces are users who did not contribute to the measurements 110.

It is to be noted that stating that a score is computed based on measurements, such as the statement above mentioning “the score computed based on the measurements 110”, is not meant to imply that all of the measurements 110 are used in the computation of the score. When a score is computed based on measurements it means that at least some of the measurements, but not necessarily all of the measurements, are used to compute the score. Some of the measurements may be irrelevant for the computation of the score for a variety of reasons, and therefore are not used to compute the score. For example, some of the measurements may involve experiences that are different from the experience for which the score is computed, may involve users not selected to contribute measurements (e.g., filtered out due to their profiles being dissimilar to a profile of a certain user), and/or some of the measurements might have been taken at a time that is not relevant for the score (e.g., older measurements might not be used when computing a score corresponding to a later time). Thus, the above statement “the score computed based on the measurements 110” should be interpreted as the score computed based on some, but not necessarily all, of the measurements 110.

Various types of sensors may be utilized in order to take measurements of affective response, such as the measurements 110 and/or measurements of affective response designated by other numeral references. Following are various examples of sensors that may be coupled to users, which are used to take measurements of the users. In one example, a sensor used to take a measurement of affective response of a user is implanted in the body of a user. In another example, a sensor used to take a measurement of affective response of a user is embedded in a device used by the user. In yet another example, a sensor used to take a measurement of a user may be embedded in an object worn by the user, which may be at least one of the following: a clothing item, footwear, a piece of jewelry, and a wearable artifact. In still another example, a sensor used to take a measurement of a user may be a sensor that is not in physical contact with the user, such as an image capturing device used to take a measurement that includes one or more images of the user.

In some embodiments, some of the users who contribute to the measurements 110 may have a device that includes both a sensor that may be used to take a measurement of affective response and a user interface that may be used to present a result computed based on the measurements 110, such as the score 164. Optionally, each such device is configured to receive a measurement of affective response taken with the sensor embedded in the device, and to transmit the measurement. The device may also be configured to receive data describing a crowd-based result, such as a score for an experience, and to forward the data for presentation via the user interface.

Reporting a result computed based on measurements of affective response, such as the score 164, via a user interface may be done in various ways in different embodiments. In one embodiment, the score is reported by presenting, on a display of a device of a user (e.g., a smartphone's screen or augmented reality glasses) an indication of the score 164 and/or the certain experience. For example, the indication may be a numerical value, a textual value, an image, and/or video. Optionally, the indication is presented as an alert issued if the score reaches a certain threshold. Optionally, the indication is given as a recommendation generated by a recommender module such as recommender module 178. In another embodiment, the score 164 may be reported via a voice signal and/or a haptic signal (e.g., via vibrations of a device carried by the user). In some embodiments, reporting the score 164 to a user is done by a software agent operating on behalf of the user, which communicates with the user via a user interface.

In some embodiments, along with presenting information, e.g. about a score such as the score 164, the user interfaces may present information related to the significance of the information, such as a significance level (e.g., p-value, q-value, or false discovery rate), information related to the number of users and/or measurements (the sample size) which were used for determining the information, and/or confidence intervals indicating the variability of the data.

FIG. 6 illustrates a system configured to compute scores for experiences. The system illustrated in FIG. 6 is an exemplary embodiment of a system that may be utilized to compute crowd-based results 115 from the measurements 110, as illustrated in FIG. 3. While the system illustrated in FIG. 6 describes a system that computes scores for experiences, the teachings in the following discussion, in particular the roles and characteristics of various modules, may be relevant to other embodiments described herein involving generation of other types of crowd-based results (e.g., learning parameters of functions of affective response).

In one embodiment, a system that computes a score for an experience, such as the one illustrated in FIG. 6, includes at least a collection module (e.g., collection module 120) and a scoring module (e.g., scoring module 150). Optionally, such a system may also include additional modules such as the personalization module 130, score-significance module 165, and/or recommender module 178. The illustrated system includes modules that may optionally be found in other embodiments described in this disclosure. This system, like other systems described in this disclosure, includes at least a memory 402 and a processor 401. The memory 402 stores computer executable modules described below, and the processor 401 executes the computer executable modules stored in the memory 402.

The collection module 120 is configured to receive the measurements 110. Optionally, at least some of the measurements 110 may be processed in various ways prior to being received by the collection module 120. For example, at least some of the measurements 110 may be compressed and/or encrypted.

The collection module 120 is also configured to forward at least some of the measurements 110 to the scoring module 150. Optionally, at least some of the measurements 110 undergo processing before they are received by the scoring module 150. Optionally, at least some of the processing is performed via programs that may be considered software agents operating on behalf of the users who provided the measurements 110.

The scoring module 150 is configured to receive at least some of the measurements 110 of affective response from the crowd 100 of users, and to compute a score 164 based on the measurements 110. At least some of the measurements 110 may correspond to a certain experience, i.e., they are measurements of at least some of the users from the crowd 100 taken in temporal proximity to when those users had the certain experience and represent the affective response of those users to the certain experience. Herein “temporal proximity” means nearness in time. For example, at least some of the measurements 110 are taken while users are having the certain experience and/or shortly after that.

A scoring module, such as scoring module 150, may utilize one or more types of scoring approaches that may optionally involve one more other modules. In one example, the scoring module 150 utilizes modules that perform statistical tests on measurements in order to compute the score 164, such as statistical test module 152 and/or statistical test module 158. In another example, the scoring module 150 utilizes arithmetic scorer 162 to compute the score 164.

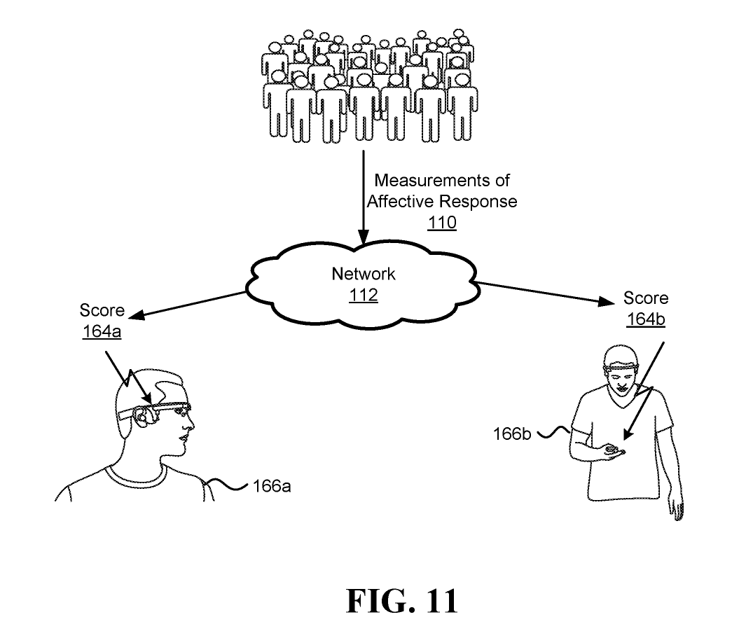

In one embodiment, a score computed by a scoring module, such as scoring module 150, may be considered a personalized score for a certain user and/or for a certain group of users. Optionally, the personalized score is generated by providing the personalization module 130 with a profile of the certain user (or a profile corresponding to the certain group of users). The personalization module 130 compares a provided profile to profiles from among the profiles 128, which include profiles of at least some of the users belonging to the crowd 100, in order to determine similarities between the provided profile and the profiles of at least some of the users belonging to the crowd 100. Based on the similarities, the personalization module 130 produces an output indicative of a selection and/or weighting of at least some of the measurements 110. By providing the scoring module 150 with outputs indicative of different selections and/or weightings of measurements from among the measurements 110, it is possible that the scoring module 150 may compute different scores corresponding to the different selections and/or weightings of the measurements 110, which are described in the outputs, as illustrated in FIG. 11.

In one embodiment, the score 164 may be provided to the recommender module 178, which may utilize the score 164 to generate recommendation 179, which may be provided to a user (e.g., by presenting an indication regarding the experience on a user interface used by the user). Optionally, the recommender module 178 is configured to recommend the experience for which the score 164 is computed, based on the value of the score 164, in a manner that belongs to a set comprising first and second manners, as described below. When the score 164 reaches a threshold, the experience is recommended in the first manner, and when the score 164 does not reach the threshold, the experience is recommended in the second manner, which involves a weaker recommendation than a recommendation given when recommending in the first manner.

References to a “threshold” herein typically relate to a value to which other values may be compared. For example, in this disclosure scores are often compared to threshold in order to determine certain system behavior (e.g., whether to issue a notification or not based on whether a threshold is reached). When a threshold's value has a certain meaning it may be given a specific name based on the meaning. For example, a threshold indicating a certain level of satisfaction of users may be referred to as a “satisfaction-threshold” or a threshold indicating a certain level of well-being of users may be referred to as “wellness-threshold”, etc.

Herein, a threshold is typically considered to be reached by a value if the value equals the threshold or exceeds it. Similarly, a value does not reach the threshold (i.e., the threshold is not reached) if the value is below the threshold. However, some thresholds may behave the other way around, i.e., a value above the threshold is considered not to reach the threshold, and when the value equals the threshold, or is below the threshold, it is considered to have reached the threshold. The context in which the threshold is presented is typically sufficient to determine how a threshold is reached (i.e., from below or above). In some cases when the context is not clear, what constitutes reaching the threshold may be explicitly stated. Typically, but not necessarily if reaching a threshold involves having a value lower than the threshold, reaching the threshold will be described as “falling below the threshold”.

Herein, any reference to a “threshold” or to a certain type of threshold (e.g., satisfaction-threshold, wellness-threshold, and the like), may be considered a reference to a “predetermined threshold”. A predetermined threshold is a fixed value and/or a value determined at any time before performing a calculation that compares a score with the predetermined threshold. Furthermore, a threshold may also be considered a predetermined threshold when the threshold involves a value that needs to be reached (in order for the threshold to be reached), and logic used to compute the value is known before starting the computations used to determine whether the value is reached (i.e., before starting the computations to determine whether the predetermined threshold is reached). Examples of what may be considered the logic mentioned above include circuitry, computer code, and/or steps of an algorithm.

In one embodiment, the manner in which the recommendation 179 is given may also be determined based on a significance computed for the score 164, such as significance 176 computed by score-significance module 165. Optionally, the significance 176 refers to a statistical significance of the score 164, which is computed based on various characteristics of the score 164 and/or the measurements used to compute the score 164. Optionally, when the significance 176 is below a predetermined significance level (e.g., a p-value that is above a certain value) the recommendation is made in the second manner.

A recommender module, such as the recommender module 178 or other recommender modules described in this disclosure (e.g., the recommender module 379), is a module that is configured to recommend an experience based on the value of a crowd-based result computed for the experience. For example, recommender module 178 is configured to recommend an experience based on a score computed for the experience based on measurements of affective response of us ers who had the experience.

Depending on the value of the crowd-based result computed for an experience, a recommender module may recommend the experience in various manners. In particular, the recommender module may recommend an experience in a manner that belongs to a set including first and second manners. Typically, in this disclosure, when a recommender module recommends an experience in the first manner, the recommender module provides a stronger recommendation for the experience, compared to a recommendation for the experience that the recommender module provides when recommending in the second manner. Typically, if the crowd-based result indicates a sufficiently strong (or positive) affective response to an experience, the experience is recommended the first manner. Optionally, if the result indicates a weaker affective response to an experience, which is not sufficiently strong (or positive), the experience is recommended in the second manner.

In some embodiments, a recommender module, such as recommender module 178, is configured to recommend an experience via a display of a user interface. In such embodiments, recommending an experience in the first manner may involve one or more of the following: (i) utilizing a larger icon to represent the experience on a display of the user interface, compared to the size of the icon utilized to represent the experience on the display when recommending in the second manner; (ii) presenting images representing the experience for a longer duration on the display, compared to the duration during which images representing the experience are presented when recommending in the second manner; (iii) utilizing a certain visual effect when presenting the experience on the display, which is not utilized when presenting the experience on the display when recommending the experience in the second manner; and (iv) presenting certain information related to the experience on the display, which is not presented when recommending the experience in the second manner.

In some embodiments, a recommender module, such as recommender module 178, is configured to recommend an experience to a user by sending the user a notification about the experience. In such embodiments, recommending an experience in the first manner may involve one or more of the following: (i) sending the notification to a user about the experience at a higher frequency than the frequency the notification about the experience is sent to the user when recommending the experience in the second manner; (ii) sending the notification to a larger number of users compared to the number of users the notification is sent to when recommending the experience in the second manner; and (iii) on average, sending the notification about the experience sooner than it is sent when recommending the experience in the second manner.

In some embodiments, significance of a score, such as the score 164, may be computed by the score-significance module 165. Optionally, significance of a score, such as the significance 176 of the score 164, may represent various types of values derived from statistical tests, such as p-values, q-values, and false discovery rates (FDRs). Additionally or alternatively, significance may be expressed as ranges, error-bars, and/or confidence intervals. Additional information regarding approaches for determining significance of results may be found in Section 20 (“Determining Significance of Results”) in U.S. application Ser. No. 15/051,892, published as U.S. 2016/0170996, which is incorporated herein by reference in its entirety.

Following is a discussion regarding various properties of the collection module 120. A more comprehensive discussion of the collection module may be found in Section 13 (“Collecting Measurements”), in U.S. application Ser. No. 15/051,892, published as U.S. 2016/0170996, which is incorporated herein by reference in its entirety. In embodiments described herein, measurements received by the collection module 120, which may be the measurements 110 and/or measurements of affective response designated by another reference numeral, may be forwarded to other modules to produce a crowd-based result (e.g., scoring module 150, ranking module 220, function learning module 280, and the like). The measurements received by the collection module 120 need not be the same measurements provided to the modules. For example, the measurements provided to the modules may undergo various forms of processing prior to being received by the modules. Additionally, the measurements provided to the modules may not necessarily include all the measurements received by the collection module 120. For example, the collection module 120 may receive certain measurements that are not required for computation of a certain crowd-based result (e.g., the measurements may involve an experience that is not being scored or ranked at the time). Thus, often in embodiments described herein, measurements received by the collection module 120 will be said to include a certain set (or subset) of measurements of interest (e.g., measurements of at least ten users who had a certain experience); this does not mean that these are the only measurements received by the collection module 120 in those embodiments.

The collection module 120 may receive and/or provide to other modules measurements collected over various time frames. For example, in some embodiments, measurements of affective response provided by the collection module 120 to other modules (e.g., scoring module 150, ranking module 220, etc.), are taken over a certain period that extends for at least an hour, a day, a month, or at least a year. For example, when the measurements extend for a period of at least a day, they include at least a first measurement and a second measurement, such that the first measurement is taken at least 24 hours before the second measurement is taken. In other embodiments, at least a certain portion of the measurements of affective response utilized by one of the other modules to compute crowd-based results are taken within a certain period of time. For example, the certain portion may include times at which at least 25%, at least 50%, or at least 90% of the measurements were taken. Furthermore, in this example, the certain period of time may include various windows of time, spanning periods such as at most one minute, at most 10 minutes, at most 30 minutes, at most an hour, at most 4 hours, at most a day, or at most a week.

In some embodiments, the collection module 120 may be considered a module that organizes and/or pre-processes measurements to be used for computing crowd-based results. In some embodiments, the collection module 120 may be an independent module, while in other modules it may be a module that is part of another module (e.g., it may be a component of scoring module 150). In one example, the collection module 120 includes hardware, such as a processor and memory, and includes interfaces that maintain communication routes with users (e.g., via their devices, in order to receive measurements) and/or with other modules (e.g., in order to receive requests and/or provide measurements). In another example, the collection module 120 may be implemented as, and/or be included as part of, a software module that can run on a general purpose server and/or in a distributed fashion (e.g., the collection module 120 may include modules that run on devices of users).

There are various ways in which the collection module 120 may receive the measurements of affective response. In one embodiment, the collection module 120 receives at least some of the measurements directly from the users of whom the measurements are taken. In one example, the measurements are streamed from devices of the users as they are acquired (e.g., a user's smartphone may transmit measurements acquired by one or more sensors measuring the user). In another example, a software agent operating on behalf of the user may routinely transmit descriptions of events, where each event includes a measurement and a description of a user and/or an experience the user had. In another embodiment, the collection module 120 is configured to retrieve at least some of the measurements from one or more databases that store measurements of affective response of users. Optionally, the collection module 120 submits to the one or more databases queries involving selection criteria which may include: a type of an experience, a location the experience took place, a timeframe during which the experience took place, an identity of one or more users who had the experience, and/or one or more characteristics corresponding to the users or to the experience. In yet another embodiment, the collection module 120 is configured to receive at least some of the measurements from software agents operating on behalf of the users of whom the measurements are taken. In one example, the software agents receive requests for measurements corresponding to events having certain characteristics. Based on the characteristics, a software agent may determine whether the software agent has, and/or may obtain, data corresponding to events that are relevant to the query.

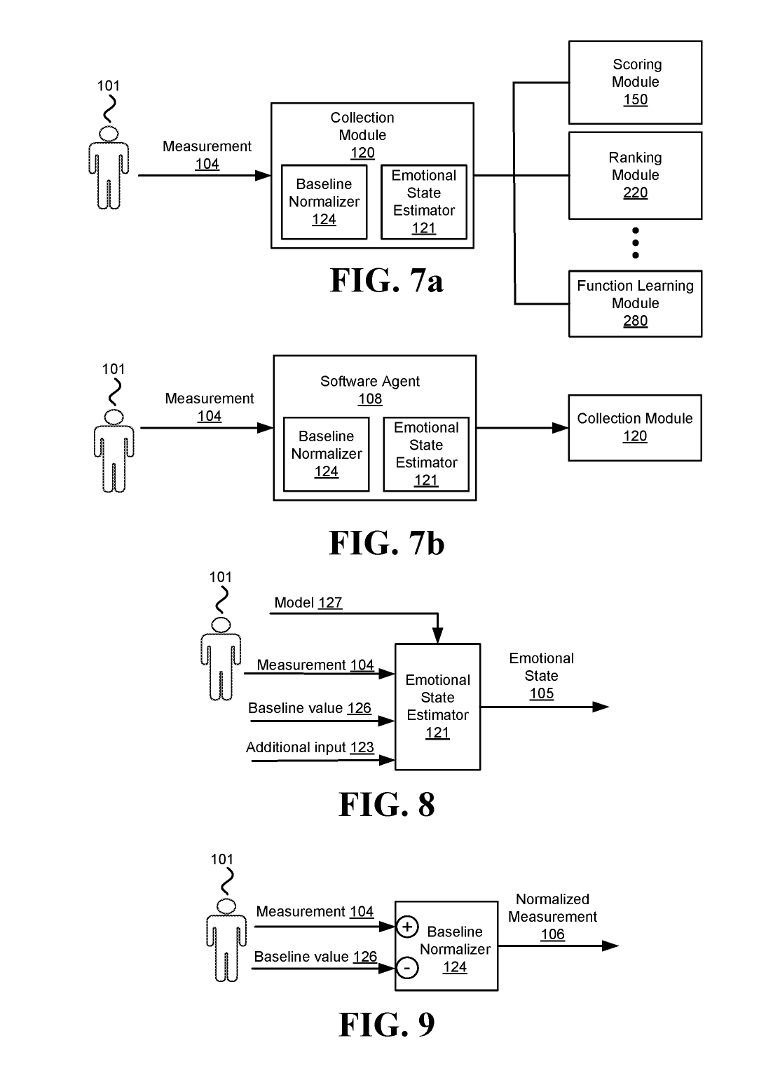

Depending on the embodiment, the processing of measurements of affective response of users may be done in a centralized manner, by the collection module 120, or in a distributed manner, e.g., by software agents operating on behalf of the users. Thus, in some embodiments, various processing methods described in this disclosure are performed in part or in full by the collection module 120, while in others the processing is done in part or in full by the software agents. FIG. 7a and FIG. 7b illustrate different scenarios that may occur in embodiments described herein, in which the bulk of the processing of measurements of affective response is done either by the collection module 120 or by the software agent 108.

FIG. 7a illustrates one embodiment in which the collection module 120 does at least some, if not most, of the processing of measurements of affective response that may be provided to various modules in order to compute crowd-based results. The user 101 provides measurement 104 of affective response to the collection module 120. Optionally, the measurement 104 may be a raw measurement (i.e., it includes values essentially as they were received from a sensor) and/or a partially processed measurement (e.g., subjected to certain filtration and/or noise removal procedures). In this embodiment, the collection module 120 may include various modules that may be used to process measurements such as Emotional State Estimator (ESE) 121 and/or baseline normalizer 124. Optionally, in addition to, or instead of, the ESE 121 and/or the baseline normalizer 124, the collection module 120 may include other modules that perform other types of processing of measurements. For example, the collection module 120 may include modules that compute other forms of affective values described in the section “Sensors and Measurements of Affective Response” and/or modules that perform various forms of preprocessing of raw data. In this embodiment, the measurement provided to other modules by the collection module 120 may be considered a processed value and/or an affective value. For example, it may be an affective value representing emotional state 105 and/or normalized measurement 106.

FIG. 7b illustrates one embodiment in which the software agent 108 does at least some, if not most, of the processing of measurements of affective response of the user 101. The user 101 provides measurement 104 of affective response to the software agent 108 which operates on behalf of the user. Optionally, the measurement 104 may be a raw measurement (i.e., it includes values essentially as they were received from a sensor) and/or a partially processed measurement (e.g., subjected to certain filtration and/or noise removal procedures). In this embodiment, the software agent 108 may include various modules that may be used to process measurements such as emotional state estimator (ESE) 121 and/or baseline normalizer 124. Optionally, in addition to, or instead of, the ESE 121 and/or the baseline normalizer 124, the software agent 108 may include other modules that perform other types of processing of measurements. For example, the software agent 108 may include modules that compute other forms of affective values described in the section “Sensors and Measurements of Affective Response” and/or modules that perform various forms of preprocessing of raw data. In this embodiment, the measurement provided to the collection module 120 may be considered a processed value and/or an affective value. For example, it may be an affective value representing emotional state 105 and/or normalized measurement 106.

FIG. 8 illustrates one embodiment of the Emotional State Estimator (ESE) 121. In FIG. 8, the user 101 provides a measurement 104 of affective response to ESE 121. Optionally, the ESE 121 may receive other inputs such as a baseline affective response value 126 and/or additional inputs 123 which may include contextual data about the measurement e.g., a situation the user was in at the time and/or contextual information about the experience to which the measurement 104 corresponds. Optionally, the ESE 121 may utilize model 127 in order to estimate the emotional state 105 of the user 101 based on the measurement 104. Optionally, the model 127 is a general model, e.g., which is trained on data collected from multiple users. Alternatively, the model 127 may be a personal model of the user 101, e.g., trained on data collected from the user 101. Additional information regarding how emotional states may be estimated and/or represented as affective values may be found elsewhere this disclosure (in the section “Sensors and Measurements of Affective Response”). A more detailed discussion regarding predictors and ESEs may be found elsewhere in this disclosure (in the section “Predictors and Emotional State Estimators”), and in Section 10 (“Predictors and Emotional State Estimators”), in U.S. application Ser. No. 15/051,892, published as U.S. 2016/0170996, which is incorporated herein by reference in its entirety.

FIG. 9 illustrates one embodiment of the baseline normalizer 124. In this embodiment, the user 101 provides a measurement 104 of affective response and the baseline affective response value 126, and the baseline normalizer 124 computes the normalized measurement 106. Optionally, normalizing a measurement of affective response utilizing a baseline affective response value involves subtracting the baseline affective response value from the measurement. Thus, after normalizing with respect to the baseline, the measurement becomes a relative value, reflecting a difference from the baseline. In another embodiment, normalizing a measurement with respect to a baseline involves computing a value based on the baseline and the measurement such as an average of both (e.g., geometric or arithmetic average).

Scoring and Personalization

Various embodiments described herein may include a module that computes a score for an experience based on measurements of affective response of users who had the experience (e.g., the measurements may correspond to events in which users have the experience).

In some embodiments, a score for an experience computed by a scoring module is computed solely based on measurements of affective response corresponding to events in which users have the experience. In other embodiments, a score computed for the experience by a scoring module may be computed based on the measurements and other values, such as baseline affective response values or prior measurements. In one example, a score computed by scoring module 150 is computed based on prior measurements, taken before users have an experience, and contemporaneous measurements, taken while the users have the experience. This score may reflect how the users feel about the experience.

When measurements of affective response correspond to a certain experience, e.g., they are taken while and/or shortly after users have the certain experience, a score computed based on the measurements may be indicative of an extent of the affective response users had to the certain experience. For example, measurements of affective response of users taken while the users were at a certain location may be used to compute a score that is indicative of the affective response of the users to being in the certain location. Optionally, the score may be indicative of the quality of the experience and/or of the emotional response users had to the experience (e.g., the score may express a level of enjoyment from having the experience).

In one embodiment, a score for an experience that is computed by a scoring module, such as the score 164, may include a value representing a quality of the experience as determined based on the measurements 110. Optionally, the score includes a value that is at least one of the following: a physiological signal, a behavioral cue, an emotional state, and an affective value. Optionally, the score includes a value that is a function of measurements of at least five users. Optionally, the score is indicative of the significance of a hypothesis that the at least five users had a certain affective response. In one example, the certain affective response is manifested through changes to values of at least one of the following: measurements of physiological signals, and measurements of behavioral cues.

In one embodiment, a score for an experience that is computed based on measurements of affective response is a statistic of the measurements. For example, the score may be the average, mean, and/or mode of the measurements. In other examples, the score may take the form of other statistics, such as the value of a certain percentile when the measurements are ordered according to their values.

In another embodiment, a score for an experience that is computed from measurements of affective response is computed utilizing a function that receives an input comprising the measurements of affective response, and returns a value that depends, at least to some extent, on the value of the measurements. Optionally, the function according to which the score is computed may be non-trivial in the sense that it does not return the same value for all inputs. Thus, it may be assumed that a score computed based on measurements of affective response utilizes at least one function for which there exist two different sets of inputs comprising measurements of affective response, such that the function produces different outputs for each set of inputs.

In yet another embodiment, a function used to compute a score for an experience based on measurements of affective response involves utilizing a machine learning-based predictor that receives as input measurements of affective response and returns a result that may be interpreted as a score. The objective (target value) computed by the predictor may take various forms, possibly extending beyond values that may be interpreted as directly stemming from emotional responses, such as a degree the experience may be considered “successful” or “profitable”. For example, with an experience that involves watching a movie or a concert, the score computed from the measurements may be indicative of how much income can be expected from the experience (e.g., box office returns for a movie or concert) or how long the experience will run (e.g., how many shows are expected before attendance dwindles below a certain level).

Some experiences may be considered complex experiences that include multiple “smaller” experiences. When computing a score for such a complex experience, there may be different approaches that may be taken. In one embodiment, the score for the complex experience is computed based on measurements of affective response corresponding to events that involve having the complex experience. For example, a measurement of affective response corresponding to an event involving a user having the complex experience may be derived from multiple measurements of the user taken during at least some of the smaller experiences comprised in the complex experience. Thus, the measurement represents the affective response of the user to the complex experience. In another embodiment, the score for the complex experience is computed by aggregating scores computed for the smaller experiences. For example, for each experience comprised in the complex experience, a separate score is computed based on measurements of users who had the complex experience, which were taken during and/or shortly after the smaller experience (i.e., they correspond to events involving the smaller experience).

Scores computed based on measurements of affective response may represent different types of values. The type of value a score represents may depend on various factors such as the type of measurements of affective response used to compute the score, the type of experience corresponding to the score, the application for which the score is used, and/or the user interface on which the score is to be presented.

In one embodiment, a score for an experience that is computed from measurements of affective response may be expressed in the same units as the measurements. Furthermore, a score for an experience may be expressed as any type of affective value that is described herein. In another embodiment, a score for an experience may be expressed in units that are different from the units in which the measurements of affective response used to compute it are expressed. Optionally, the different units may represent values that do not directly convey an affective response (e.g., a value indicating qualities such as utility, profit, and/or a probability). Optionally, the score may represent a numerical value corresponding to a quality of an experience (e.g., a value on a scale of 1 to 10, or a rating of 1 to 5 stars). Optionally, the score may represent a numerical value representing a significance of a hypothesis about the experience (e.g., a p-value of a hypothesis that the measurements of users who had the experience indicate that they enjoyed the experience). Optionally, the score may represent a numerical value representing a probability of the experience belonging to a certain category (e.g., a value indicating whether the experience belongs to the class “popular experiences”). Optionally, the score may represent a similarity level between the experience and another experience (e.g., the similarity of the experience to a certain “blockbuster” experience). Optionally, the score may represent certain performance indicator such as projected sales (e.g., for product, movie, restaurant, etc.) or projected virality (e.g., representing the likelihood that a user will share the fact of having the experience with friends). In yet another embodiment, a score for an experience may represent a typical and/or average extent of an emotional response of the users who contributed measurements used to compute the score. Optionally, the emotional response corresponds to an increase or decrease in the level of at least one of the following: pain, anxiety, annoyance, stress, aggression, aggravation, fear, sadness, drowsiness, apathy, anger, happiness, contentment, calmness, attentiveness, affection, and excitement.

A score for an experience may be expressed in various ways in the different embodiments. Optionally, expressing a score involves presenting it to a user via a user interface (e.g., a display). The way a score is expressed may depend on various factors such as the type of value the score represents, the type of experience corresponding to the score, the application for which the score is used, and/or the user interface on which the score is to be presented. In one embodiment, a score for an experience is expressed by presenting its value in essentially the same form it is received. For example, the score may include a numerical value, and the score is expressed by providing a number representing the numerical value. In another example, a score includes a categorical value (e.g., a type of emotion), and the score is expressed by conveying the emotion to the user (e.g., by presenting the name of the emotion to the user). In another embodiment, a score for an experience may be expressed as text, and it may indicate a property related to the experience such as a quality, quantity, and/or rating of the experience. In still another embodiment, a score for an experience may be expressed using an image, sound effect, music, animation effect, and/or video. For example, a score may be conveyed by various icons (e.g., “thumbs up” vs. “thumbs down”), animations (e.g., “rocket lifting off” vs. a “crash and burn”), and/or sound effects (e.g., cheering vs. booing). In one example, a score may be represented via one or more emojis, which express how the users felt about the experience. In yet another embodiment, a score for an experience may be expressed as a distribution and/or histogram that involves a plurality of affective responses (e.g., emotional states) that are associated with how the experience makes users who have it feel. Optionally, the distribution and/or histogram describe how strongly each of the affective responses is associated with having the experience.

In some embodiments, a score for an experience may be presented by overlaying the score (e.g., an image representing the score) on a map or image in which multiple experiences may be presented. For example, the map may describe multiple locations in the physical world and/or a virtual environment, and the scores are presented as an overlaid layer of icons (e.g., star ratings) representing the score of each location and/or for different experiences that a user may have at each of the locations.

In some embodiments, a measurement of affective response of a user that is used to compute a crowd-based result corresponding to the experience (e.g., a score for an experience or a ranking of experiences) may be considered “contributed” by the user to the computation of the crowd-based result. Similarly, in some embodiments, a user whose measurement of affective response is used to compute a crowd-based result may be considered as a user who contributed the measurement to the result. Optionally, the contribution of a measurement may be considered an action that is actively performed by the user (e.g., by prompting a measurement to be sent) and/or passively performed by the user (e.g., by a device of the user automatically sending data that may also be collected automatically). Optionally, the contribution of a measurement by a user may be considered an action that is done with the user's permission and/or knowledge (e.g., the measurement is taken according to a policy approved by the user), but possibly without the user being aware that it is done. For example, a measurement of affective response may be taken in a manner approved by the user, e.g., the measurement may be taken according to certain terms of use of a device and/or service that were approved by the user, and/or the measurement is taken based on a configuration or instruction of the user. Furthermore, even though a user may not be consciously aware that the measurement was taken, used for the computation of a crowd-based result like a score, and/or that the result was disclosed, in some embodiments, that measurement of affective response is considered contributed by the user.

In order to compute a score, scoring modules may utilize various types of scoring approaches. One example of a scoring approach involves generating a score from a statistical test, such as the scoring approach used by the statistical test module 152 and/or statistical test module 158. Another example of a scoring approach involves generating a score utilizing an arithmetic function, such as a function that may be employed by the arithmetic scorer 162.

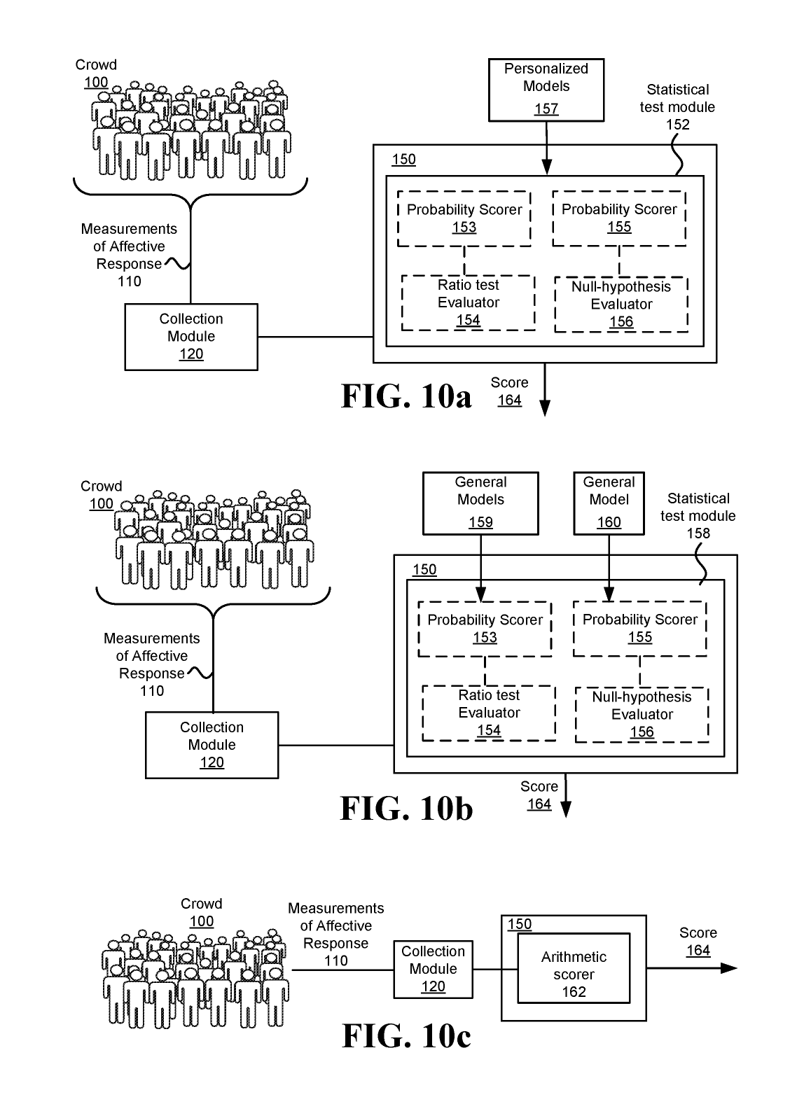

FIG. 10a and FIG. 10b each illustrates one embodiment in which a scoring module (scoring module 150 in the illustrated embodiments) utilizes a statistical test module to compute a score for an experience (the score 164 in the illustrated embodiments). In FIG. 10a, the statistical test module is statistical test module 152, while in FIG. 10b, the statistical test module is statistical test module 158. The statistical test modules 152 and 158 include similar internal components, but differ based on models they utilize to compute statistical tests. The statistical test module 152 utilizes personalized models 157 while the statistical test module 158 utilizes general models 159 (which include a first model and a second model).

In one embodiment, a personalized model of a user is trained on data comprising measurements of affective response of the user. It thus may be more suitable to interpret measurements of the user. For example, it may describe specifics of the characteristic values of the user's affective response that may be measured when the user is in certain emotional states. Optionally, a personalized model of a user is received from a software agent operating on behalf of the user. Optionally, the software agent may collect data used to train the personalized model of the user by monitoring the user. Optionally, a personalized model of a user is trained on measurements taken while the user had various experiences, which may be different than the experience for which a score is computed by the scoring module in FIG. 10a. Optionally, the various types of experiences include experience types that are different from the experience type of the experience whose score is being computed by the scoring module. In contrast to a personalized model, a general model, such as a model from among the general models 159, is trained on data collected from multiple users and may not even be trained on measurements of any specific user whose measurement is used to compute a score.

In some embodiments, the statistical test modules 152 and 158 each may perform at least one of two different statistical tests in order to compute a score based on a set of measurements of users: a hypothesis test, and a test involving rejection of a null hypothesis.

In some embodiments, performing a hypothesis test utilizing statistical test module 152, is done utilizing a probability scorer 153 and a ratio test evaluator 154. The probability scorer 153 is configured to compute for each measurement of a user, from among the users who provided measurements to compute the score, first and second corresponding values, which are indicative of respective first and second probabilities of observing the measurement based on respective first and second personalized models of the user. Optionally, the first and second personalized models of the users are from among the personalized models 157. Optionally, the first and second personalized models are trained on data comprising measurements of affective response of the user taken when the user had positive and non-positive affective responses, respectively. For example, the first model might have been trained on measurements of the user taken while the user was happy, satisfied, and/or comfortable, while the second model might have been trained on measurements of affective response taken while the user was in a neutral emotional state or a negative emotional state (e.g., angry, agitated, uncomfortable). Optionally, the higher the probability of observing a measurement based on a model, the more it is likely that the user was in the emotional state corresponding to the model.

The ratio test evaluator 154 is configured to determine the significance level for a hypothesis based on a ratio between a first set of values comprising the first value corresponding to each of the measurements, and a second set of values comprising the second value corresponding to each of the measurements. Optionally, the hypothesis supports an assumption that, on average, the users who contributed measurements to the computation of the score had a positive affective response to the experience. Optionally, the non-positive affective response is a manifestation of a neutral emotional state or a negative emotional state. Thus, if the measurements used to compute the score are better explained by the first model of each user (corresponding to the positive emotional response), then the ratio computed by the ratio test evaluator 154 will be positive and/or large. The greater the value of the ratio, the more the score will indicate that the hypothesis is true and that the measurements of the users represent a positive affective response to the experience. However, if the measurements were not positive, it is likely that the ratio will be negative and/or small, representing that the hypothesis should be rejected in favor of a competing hypothesis that states that the users had a non-positive affective response to the experience. Optionally, a score computed based on the ratio is proportional to the logarithm of the ratio. Thus, the stronger the notion to accept the hypothesis based on the hypothesis test, the greater the computed score.

In some embodiments, performing a hypothesis test utilizing statistical test module 158, is done in a similar fashion to the description given above for performing the same test with the statistical test module 152, but rather than using the personalized models 157, the general models 159 are used instead. When using the statistical test module 158, the probability scorer 153 is configured to compute for each measurement of a user, from among the users who provided measurements to compute the score, first and second corresponding values, which are indicative of respective first and second probabilities of observing the measurement based on respective first and second models belonging to the general models 159. Optionally, the first and second models are trained on data comprising measurements of affective response of users taken while the users had positive and non-positive affective responses, respectively.

The ratio test evaluator 154 is configured to determine the significance level for a hypothesis based on a ratio between a first set of values comprising the first value corresponding to each of the measurements, and a second set of values comprising the second value corresponding to each of the measurements. Optionally, the hypothesis supports an assumption that, on average, the users who contributed measurements to the computation of the score had a positive affective response to the experience. Optionally, the non-positive affective response is a manifestation of a neutral emotional state or a negative emotional state. Thus, if the measurements used to compute the score are better explained by the first model from the general models 159 (which corresponds to the positive emotional response), then the ratio computed by the ratio test evaluator 154 will be positive.

In one embodiment, the hypothesis is a supposition and/or proposed explanation used for evaluating the measurements of affective response. By stating that the hypothesis supports an assumption, it is meant that according to the hypothesis, the evidence (e.g., the measurements of affective response and/or baseline affective response values) exhibit values that correspond to the supposition and/or proposed explanation.

In one embodiment, the ratio test evaluator 154 utilizes a log-likelihood test to determine, based on the first and second sets of values, whether the hypothesis should be accepted and/or the significance level of accepting the hypothesis. If the distribution of the log-likelihood ratio corresponding to a particular null and alternative hypothesis can be explicitly determined, then it can directly be used to form decision regions (to accept/reject the null hypothesis). Alternatively or additionally, one may utilize Wilk's theorem which states that as the sample size approaches infinity, the test statistic −log(Λ), with A being the log-likelihood value, will be x²-distributed. Optionally, the score is computed by a scoring module that utilizes a hypothesis test is proportional to the test statistic −log(Λ).

In some embodiments, performing a statistical test that involves rejecting a null hypothesis utilizing statistical test module 152, is done utilizing a probability scorer 155 and a null-hypothesis evaluator 156. The probability scorer 155 is configured to compute, for each measurement of a user, from among the users who provided measurements to compute the score, a probability of observing the measurement based on a personalized model of the user. Optionally, the personalized model of the user is trained on training data comprising measurements of affective response of the user taken while the user had a certain affective response. Optionally, the certain affective response is manifested by changes to values of at least one of the following: measurements of physiological signals, and measurements of behavioral cues. Optionally, the changes to the values are manifestations of an increase or decrease, to at least a certain extent, in a level of at least one of the following emotions: happiness, contentment, calmness, attentiveness, affection, tenderness, excitement, pain, anxiety, annoyance, stress, aggression, fear, sadness, drowsiness, apathy, and anger.

The null-hypothesis evaluator 156 is configured to determine the significance level for a hypothesis based on probabilities computed by the probability scorer 155 for the measurements of the users who contributed measurements for the computation of the score. Optionally, the hypothesis is a null hypothesis that supports an assumption that the users who contributed measurements of affective response to the computation of the score had the certain affective response when their measurements were taken, and the significance level corresponds to a statistical significance of rejecting the null hypothesis. Optionally, the certain affective response is a neutral affective response. Optionally, the score is computed based on the significance which is expressed as a probability, such as a p-value. For example, the score may be proportional to the logarithm of the p-value.

In one example, the certain affective response corresponds to a manifestation of a negative emotional state. Thus, the stronger the rejection of the null hypothesis, the less likely it is that the users who contributed the measurements were in fact in a negative emotional state, and thus, the more positive the score may be (e.g., if expressed as a log of a p-value of the null hypothesis).

In some embodiments, performing a statistical test that involves rejecting a null hypothesis utilizing statistical test module 158, is done in a similar fashion to the description given above for performing the same test with the statistical test module 152, but rather than using the personalized models 157, the general model 160 is used instead.

The probability scorer 155 is configured to compute, for each measurement of a user, from among the users who provided measurements to compute the score, a probability of observing the measurement based on the general model 160. Optionally, the general model 160 is trained on training data comprising measurements of affective response of users taken while the users had the certain affective response.

The null-hypothesis evaluator 156 is configured to determine the significance level for a hypothesis based on probabilities computed by the probability scorer 155 for the measurements of the users who contributed measurements for the computation of the score. Optionally, the hypothesis is a null hypothesis that supports an assumption that the users of whom the measurements were taken had the certain affective response when their measurements were taken, and the significance level corresponds to a statistical significance of rejecting the null hypothesis.

In some embodiments, a statistical test module such as the statistical test modules 152 and/or 158 are configured to determine whether the significance level for a hypothesis reaches a certain level. Optionally, the significance level reaching the certain level indicates at least one of the following: a p-value computed for the hypothesis equals, or is below, a certain p-value, and a false discovery rate computed for the hypothesis equals, or is below, a certain rate. Optionally, the certain p-value is a value greater than 0 and below 0.33, and the certain rate is a value greater than 0 and below 0.33.

In some cases, the fact that significance for a hypothesis is computed based on measurements of a plurality of users increases the statistical significance of the results of a test of the hypothesis. For example, if the hypothesis is tested based on fewer users, a significance of the hypothesis is likely to be smaller than when it is tested based on measurements of a larger number of users. Thus, it may be possible, for example, for a first significance level for a hypothesis computed based on measurements of at least ten users to reach a certain level. However, on average, a second significance level for the hypothesis, computed based on the measurements of affective response of a randomly selected group of less than five users out of the at least ten users, will not reach the certain level. Optionally, the fact the second significance level does not reach the certain level indicates at least one of the following: a p-value computed for the hypothesis is above the certain p-value, and a false discovery rate computed for the hypothesis is above the certain rate.

FIG. 10c illustrates one embodiment in which a scoring module utilizes the arithmetic scorer 162 in order to compute a score for an experience. The arithmetic scorer 162 receives measurements of affective response from the collection module 120 and computes the score 164 by applying one or more arithmetic functions to the measurements. Optionally, the arithmetic function is a predetermined arithmetic function. For example, the logic of the function is known prior to when the function is applied to the measurements. Optionally, a score computed by the arithmetic function is expressed as a measurement value which is greater than the minimum of the measurements used to compute the score and lower than the maximum of the measurements used to compute the score. In one embodiment, applying the predetermined arithmetic function to the measurements comprises computing at least one of the following: a weighted average of the measurements, a geometric mean of the measurements, and a harmonic mean of the measurements. In another embodiment, the predetermined arithmetic function involves applying mathematical operations dictated by a machine learning model (e.g., a regression model). In some embodiments, the predetermined arithmetic function applied by the arithmetic scorer 162 is executed by a set of instructions that implements operations performed by a machine learning-based predictor that receives the measurements used to compute a score as input.

In some embodiments, a scoring module may compute a score for an experience based on measurements that have associated weights. In one example, the weights may be determined based on the age of the measurements. In another example, the weights may be assigned by the personalization module 130, and/or may be determined based on an output generated by the personalization module 130, in order for the scoring module to compute a personalized score. The scoring modules described above can easily be adapted by one skilled in the art in order to accommodate weights. For example, the statistical test modules may utilize weighted versions of the hypothesis test (i.e., a weighted version of the likelihood ratio test and/or the test for rejection of a null hypothesis). Additionally, many arithmetic functions that are used to compute scores can be easily adapted to a case where measurements have associated weights. For example, instead of a score being computed as a regular arithmetic average, it may be computed as a weighted average.

Herein, a weighted average of a plurality of measurements may be any function that can be described as a dot product between a vector of real-valued coefficients and a vector of the measurements. Optionally, the function may give at least some of the measurements a different weight (i.e., at least some of the measurements may have different valued corresponding coefficients).

The crowd-based results generated in some embodiments described in this disclosure may be personalized results. In particular, when scores are computed for experiences, e.g., by various systems such as illustrated in FIG. 6, the same set of measurements may, in some embodiments, be used to compute different scores for different users. For example, in one embodiment, a score computed by a scoring module 150 may be considered a personalized score for a certain user and/or for a certain group of users. Optionally, the personalized score is generated by providing the personalization module 130 with a profile of the certain user (or a profile corresponding to the certain group of users). The personalization module 130 compares a provided profile to profiles from among the profiles 128, which include profiles of at least some of the users belonging to the crowd 100, in order to determine similarities between the provided profile and the profiles of at least some of the users belonging to the crowd 100. Based on the similarities, the personalization module 130 produces an output indicative of a selection and/or weighting of at least some of the measurements 110. By providing the scoring module 150 with outputs indicative of different selections and/or weightings of measurements from among the measurements 110, it is possible that the scoring module 150 may compute different scores corresponding to the different selections and/or weightings of the measurements 110, which are described in the outputs.

The above scenario is illustrated in FIG. 11, where the measurements 110 of affective response are provided via network 112 to a system that computes personalized scores for experiences. The network 112 also forwards to two different users 266a and 266b respective scores 164a and 164b which have different values. Optionally, the two users 266a and 266b receive an indication of their respective scores essentially at the same time, such as at most within a few minutes of each other.

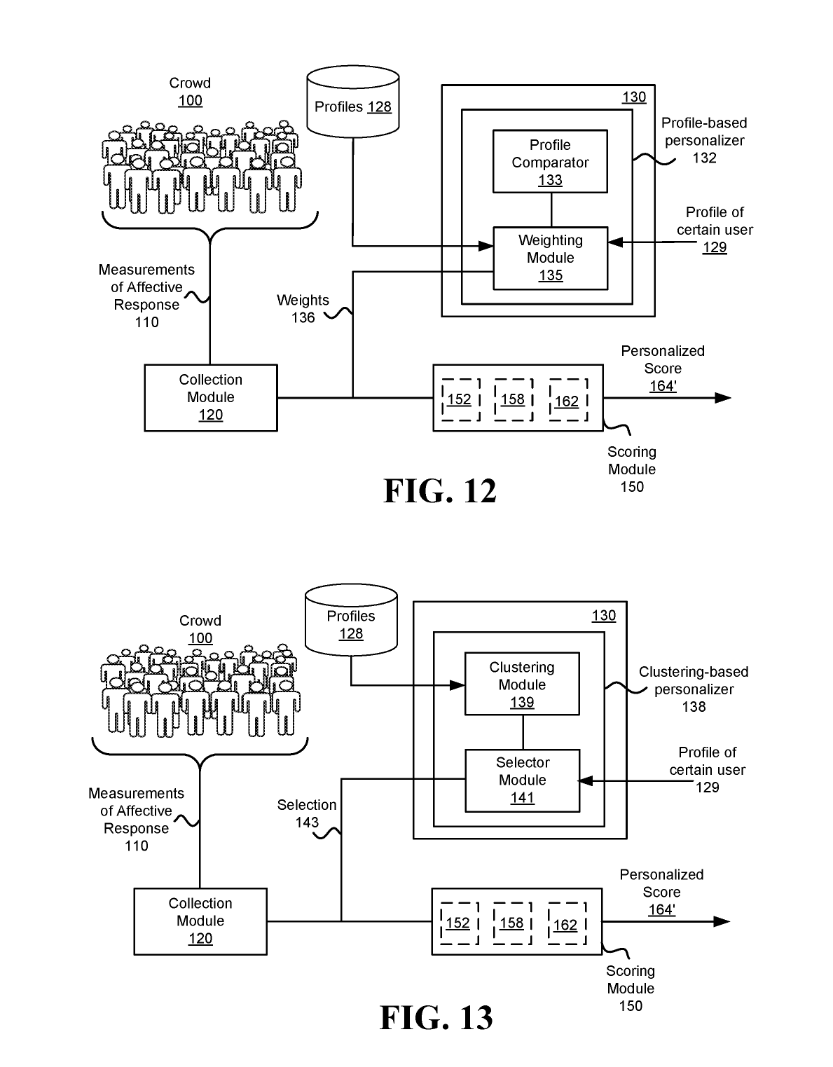

It is to be noted that in this disclosure, the personalization module 130 is typically utilized in order to generate personalized crowd-based results in some embodiments described in this disclosure. Depending on the embodiment, the personalization module 130 may have different components and/or different types of interactions with other system modules. FIG. 12 to FIG. 14 illustrate various configurations according to which personalization module 130 may be used in a system illustrated by FIG. 6. Though FIG. 12 to FIG. 14 illustrate the principles of personalization as used with respect to computing personalized scores (e.g., by a system modeled according to FIG. 6), the principles of personalization using the personalization module 130, as discussed below, are applicable to other modules, systems, and embodiments described in this disclosure (e.g., involving learning parameters of functions describing affective response).

Additionally, profiles of users belonging to the crowd 100 are typically designated by the reference numeral 128. This is not intended to mean that in all embodiments all the profiles of the users belonging to the crowd 100 are the same, rather, that the profiles 128 are profiles of users from the crowd 100, and hence may include any information described in this disclosure as possibly being included in a profile. Thus, using the reference numeral 128 for profiles signals that these profiles are for users who have an experience which may be of any type of experience described in this disclosure. Any teachings related to the profiles 128 may be applicable to other profiles described in this disclosure such as the profiles 504. The use of a different reference numeral is meant to signal that profiles 504 involve users who had a certain type of experience (in this case an experience that involves being at a location).

Furthermore, in embodiments described herein there may be various ways in which the personalization module 130 may obtain a profile of a certain user and/or profiles of other users (e.g., profiles 128 and/or profiles 504). In one embodiment, the personalization module 130 requests and/or receives profiles sent to it by other entities (e.g., by users, software agents operating on behalf of users, or entities storing information belonging to profiles of users). In another embodiment, the personalization module 130 may itself store and/or maintain information from profiles of users.

FIG. 12 illustrates a system configured to utilize comparison of profiles of users to compute personalized scores for an experience based on measurements of affective response of the users who have the experience. The system includes at least the collection module 120, the personalization module 130, and the scoring module 150. In this embodiment, the personalization module 130 utilizes profile-based personalizer 132 which comprises profile comparator 133 and weighting module 135.

The collection module 120 is configured, in one embodiment, to receive measurements 110 of affective response, which in this embodiment include measurements of at least ten users. Each measurement of a user, from among the measurements of the at least ten users, corresponds to an event in which the user has the experience. It is to be noted that the discussion below regarding the measurements of at least ten users is applicable to other numbers of users, such as at least five users.

The profile comparator 133 is configured to compute a value indicative of an extent of a similarity between a pair of profiles of users. Optionally, a profile of a user includes information that describes one or more of the following: an indication of an experience the user had, a demographic characteristic of the user, a genetic characteristic of the user, a static attribute describing the body of the user, a medical condition of the user, an indication of a content item consumed by the user, and a feature value derived from semantic analysis of a communication of the user. The profile comparator 133 does not return the same result when comparing various pairs of profiles. For example, there are at least first and second pairs of profiles, such that for the first pair of profiles, the profile comparator 133 computes a first value indicative of a first similarity between the first pair of profiles, and for the second pair of profiles, the profile comparator 133 computes a second value indicative of a second similarity between the second pair of profiles.

The weighting module 135 is configured to receive a profile 129 of a certain user and the profiles 128, which comprise profiles of the at least ten users and to generate an output that is indicative of weights 136 for the measurements of the at least ten users. Optionally, the weight for a measurement of a user, from among the at least ten users, is proportional to a similarity computed by the profile comparator 133 between a pair of profiles that includes the profile of the user and the profile 129, such that a weight generated for a measurement of a user whose profile is more similar to the profile 129 is higher than a weight generated for a measurement of a user whose profile is less similar to the profile 129. The weighting module 135 does not generate the same output for all profiles of certain users that are provided to it. That is, there are at least a first certain user and a second certain user, who have different profiles, for which the weighting module 135 produces respective first and second outputs that are different. Optionally, the first output is indicative of a first weighting for a measurement from among the measurements of the at least ten users, and the second output is indicative of a second weighting, which is different from the first weighting, for the measurement from among the measurements of the at least ten users.

Herein, a weight of a measurement determines how much the measurement's value influences a value computed based on the measurement. For example, when computing a score based on multiple measurements that include first and second measurements, if the first measurement has a higher weight than the second measurement, it will not have a lesser influence on the value of the score than the influence of the second measurement on the value of the score. Optionally, the influence of the first measurement on the value of the score will be greater than the influence of the second measurement on the value of the score.

Stating that a weight generated for a measurement of a first user whose profile is more similar to a certain profile is higher than a weight generated for a measurement of a second user whose profile is less similar to the profile of the certain user may imply different things in different embodiments. In one example, the weight generated for the measurement of the first user is at least 25% higher than the weight generated for the measurement of the second user. In another example, the weight generated for the measurement of the first user is at least double the weight generated for the measurement of the second user. And in yet another example, the weight generated for the measurement of the first user is not zero while the weight generated for the measurement of the second user is zero or essentially zero. Herein, a weight of essentially zero means that there is at least another weight generated for another sample that is much higher than the weight that is essentially zero, where much higher may be at least 50 times higher, 100 times higher, or more.

It is to be noted that in this disclosure, a profile of a certain user, such as profile 129, may not necessarily correspond to a real person and/or be derived from data of a single real person. In some embodiments, a profile of a certain user may be a profile of a representative user, which has information in it corresponding to attribute values that may characterize one or more people for whom a crowd-based result is computed.

The scoring module 150 is configured to compute a score 164′, for the experience, for the certain user based on the measurements and weights 136, which were computed based on the profile 129 of the certain user. In this case, the score 164′ may be considered a personalized score for the certain user.

When computing scores, the scoring module 150 takes into account the weightings generated by the weighting module 135 based on the profile 129. That is, it does not compute the same scores for all weightings (and/or outputs that are indicative of the weightings). In particular, at least for the first certain user and the second certain user, who have different profiles and different outputs generated by the weighting module 135, the scoring module computes different scores. Optionally, when computing a score for the first certain user, a certain measurement has a first weight, and when computing a score for the second certain user, the certain measurement has a second weight that is different from the first weight.

In one embodiment, the scoring module 150 may utilize the weights 136 directly by weighting the measurements used to compute a score. For example, if the score 164′ represents an average of the measurements, it may be computed using a weighted average instead of a regular arithmetic average. In another embodiment, the scoring module 150 may end up utilizing the weights 136 indirectly. For example, the weights may be provided to the collection module 120, which may determine based on the weights, which of the measurements 110 should be provided to the scoring module 150. In one example, the collection module 120 may provide only measurements for which associated weights determined by weighting module 135 reach a certain minimal weight.

Herein, a profile of a user may involve various forms of information storage and/or retrieval. The use of the term “profile” is not intended to mean that all the information in a profile is stored at a single location. A profile may be a collection of data records stored at various locations and/or held by various entities. Additionally, stating that a profile of a user has certain information does not imply that the information is specifically stored in a certain memory or media; rather, it may imply that the information may be obtained, e.g., by querying certain systems and/or performing computations on demand. In one example, at least some of the information in a profile of a user is stored and/or disseminated by a software agent operating on behalf of the user. In different embodiments, a profile of a user, such as a profile from among the profiles 128, may include various forms of information as elaborated on below.

In one embodiment, a profile of a user may include indications of experiences the user had. This information may include a log of experiences the user had and/or statistics derived from such a log. Information related to experiences the user had may include, for an event in which the user had an experience, attributes such as the type of experience, the duration of the experience, the location in which the user had the experience, the cost of the experience, and/or other parameters related to such an event. The profile may also include values summarizing such information, such as indications of how many times and/or how often a user has certain experiences.

In one example, indications of experiences the user had may include information regarding traveling experiences the user had. Examples of such information may include: countries and/or cities the user visited, hotels the user stayed at, modes of transportation the user used, duration of trips, and the type of trip (e.g., business trip, convention, vacation, etc.)

In one example, indications of experiences the user had may include information regarding purchases the user made. Examples of such information may include: bank and/or credit card transactions, e-commerce transactions, and/or digital wallet transactions.

In another embodiment, a profile of a user may include demographic data about the user. This information may include attributes such as age, gender, income, address, occupation, religious affiliation, political affiliation, hobbies, memberships in clubs and/or associations, and/or other attributes of the like.

In yet another embodiment, a profile of a user may include medical information about the user. The medical information may include data about properties such as age, weight, and/or diagnosed medical conditions. Additionally or alternatively, the profile may include information relating to genotypes of the user (e.g., single nucleotide polymorphisms) and/or phenotypic markers. Optionally, medical information about the user involves static attributes, or attributes whose values change very slowly (which may also be considered static). For example, genotypic data may be considered static, while weight and diagnosed medical conditions change slowly and may also be considered static. Such information pertains to a general state of the user, and does not describe the state of the user at specific time and/or when the user performs a certain activity.

The static information mentioned above may be contrasted with dynamic medical data, such as data obtained from measurements of affective response. For example, heart rate measured at a certain time, brainwave activity measured with EEG, and/or images of a user used to capture a facial expression, may be considered dynamic data. In some embodiments, a profile of a user does not include dynamic medical information. In particular, in some embodiments, a profile of a user does not include measurements of affective response and/or information derived from measurements of affective response.

In one embodiment, a profile of a user may include information regarding culinary and/or dieting habits of the user. For example, the profile may include dietary restrictions and/or allergies the user may have. In another example, the profile may include preference information (e.g., favorite cuisine, dishes, etc.) In yet another example, the profile may include data derived from monitoring food and beverages the user consumed. Such information may come from various sources, such as billing transactions and/or a camera-based system that utilizes image processing to identify food and drinks the user consumes from images taken by a camera mounted on the user and/or in the vicinity of the user.

Content a user generates and/or consumes may also be represented in a profile of a user. In one embodiment, a profile of a user may include data describing content items a user consumed (e.g., movies, music, websites, games, and/or virtual reality experiences). In another embodiment, a profile of a user may include data describing content the user generated such as images taken by the user with a camera, posts on a social network, conversations (e.g., text, voice, and/or video). Optionally, a profile may include both indications of content generated and/or consumed (e.g., files containing the content and/or pointer to the content such as URLs). Additionally or alternatively, the profile may include feature values derived from the content such as indications of various characteristics of the content (e.g., types of content, emotions expressed in the content, and the like). Optionally, the profile may include feature values derived from semantic analysis of a communication of the user. Examples of semantic analysis include: (i) Latent Semantic Analysis (LSA) or latent semantic indexing of text in order to associate a segment of content with concepts and/or categories corresponding to its meaning; and (ii) utilization of lexicons that associate words and/or phrases with core emotions, which may assist in determining which emotions are expressed in a communication.

Information included in a profile of a user may come from various sources. In one e embodiment, at least some of the information in the profile may be self-reported. For example, the user may actively enter data into the profile and/or edit data in the profile. In another embodiment, at least some of the data in the profile may be provided by a software agent operating on behalf of the user (e.g., data obtained as a result of monitoring experiences the user has and/or affective response of the users to those experiences). In another embodiment, at least some of the data in the profile may be provided by a third party, such as a party that provides experiences to the user and/or monitors the user.

There are various ways in which profile comparator 133 may compute similarities between profiles. Optionally, the profile comparator 133 may utilize a procedure that evaluates pairs of profiles independently to determine the similarity between them. Alternatively, the profile comparator 133 may utilize a procedure that evaluates similarity between multiple profiles simultaneously (e.g., produce a matrix of similarities between all pairs of profiles).

It is to be noted that when computing similarity between profiles, the profile comparator 133 may rely on a subset of the information in the profiles in order to determine similarity between the profiles. In particular, in some embodiments, a similarity determined by the profile comparator 133 may rely on the values of a small number of attributes or even on values of a single attribute. For example, in one embodiment, the profile comparator 133 may determine similarity between profiles users based solely on the age of the users as indicated in the profiles.

In one embodiment, profiles of users are represented as vectors of values that include at least some of the information in the profiles. In this embodiment, the profile comparator 133 may determine similarity between profiles by using a measure such as a dot product between the vector representations of the profiles, the Hamming distance between the vector representations of the profiles, and/or using a distance metric such as Euclidean distance between the vector representations of the profiles.

In another embodiment, profiles of users may be clustered by the profile comparator 133 into clusters using one or more clustering algorithms that are known in the art (e.g., k-means, hierarchical clustering, or distribution-based Expectation-Maximization). Optionally, profiles that fall within the same cluster are considered similar to each other, while profiles that fall in different clusters are not considered similar to each other. Optionally, the number of clusters is fixed ahead of time or is proportionate to the number of profiles. Alternatively, the number of clusters may vary and depend on criteria determined from the clustering (e.g., ratio between inter-cluster and intra-cluster distances). Optionally, a profile of a first user that falls into the same cluster to which the profile of a certain user belongs is given a higher weight than a profile of a second user, which falls into a different cluster than the one to which the profile of the certain user belongs. Optionally, the higher weight given to the profile of the first user means that a measurement of the first user is given a higher weight than a measurement of the second user, when computing a personalized score for the certain user.

In yet another embodiment, the profile comparator 133 may determine similarity between profiles by utilizing a predictor trained on data that includes samples and their corresponding labels. Each sample includes feature values derived from a certain pair of profiles of users, and the sample's corresponding label is indicative of the similarity between the certain pair of profiles. Optionally, a label indicating similarity between profiles may be determined by manual evaluation. Optionally, a label indicating similarity between profiles may be determined based on the presence of the profiles in the same cluster (as determined by a clustering algorithm) and/or based on results of a distance function applied to the profiles. Optionally, pairs of profiles that are not similar may be randomly selected. In one example, given a pair of profiles, the predictor returns a value indicative of whether they are considered similar or not.

FIG. 13 illustrates a system configured to utilize clustering of profiles of users to compute personalized scores for an experience based on measurements of affective response of the users. The system includes at least the collection module 120, the personalization module 130, and the scoring module 150. In this embodiment, the personalization module 130 utilizes clustering-based personalizer 138 which comprises clustering module 139 and selector module 141.

The collection module 120 is configured to receive measurements 110 of affective response, which in this embodiment include measurements of at least ten users. Each measurement of a user, from among the measurements of the at least ten users, corresponds to an event in which the user has an experience.

The clustering module 139 is configured to receive the profiles 128 of the at least ten users, and to cluster the at least ten users into clusters based on profile similarity, with each cluster comprising a single user or multiple users with similar profiles. Optionally, the clustering module 139 may utilize the profile comparator 133 in order to determine similarity between profiles. There are various clustering algorithms known in the art which may be utilized by the clustering module 139 to cluster users. Some examples include hierarchical clustering, partition-based clustering (e.g., k-means), and clustering utilizing an Expectation-Maximization algorithm. In one embodiment, each user may belong to a single cluster, while in another embodiment, each user may belong to multiple clusters (soft clustering). In the latter example, each user may have an affinity value to at least some clusters, where an affinity value of a user to a cluster is indicative of how strongly the user belongs to the cluster. Optionally, after performing a sot clustering of users, each user is assigned to a cluster to which the user has a strongest affinity.

The selector module 141 is configured to receive a profile 129 of a certain user, and based on the profile, to select a subset comprising at most half of the clusters of users. Optionally, the selection of the subset is such that, on average, the profile 129 is more similar to a profile of a user who is a member of a cluster in the subset, than it is to a profile of a user, from among the at least ten users, who is not a member of any of the clusters in the subset.

In one example, the selector module 141 selects the cluster to which the certain user has the strongest affinity (e.g., the profile 129 of the certain user is most similar to a profile of a representative of the cluster, compared to profiles of representatives of other clusters). In another example, the selector module 141 selects certain clusters for which the similarity between the profile of the certain user and profiles of representatives of the certain clusters is above a certain threshold. And in still another example, the selector module 141 selects a certain number of clusters to which the certain user has the strongest affinity (e.g., based on similarity of the profile 129 to profiles of representatives of the clusters).

Additionally, the selector module 141 is also configured to select at least eight users from among the users belonging to clusters in the subset. Optionally, the selector module 141 generates an output that is indicative of a selection 143 of the at least eight users. For example, the selection 143 may indicate identities of the at least eight users, or it may identify cluster representatives of clusters to which the at least eight users belong. It is to be noted that instead of selecting at least eight users, a different minimal number of users may be selected such as at least five, at least ten, and/or at least fifty different users.

Herein, a cluster representative represents other members of the cluster. The cluster representative may be one of the members of the cluster chosen to represent the other members or an average of the members of the cluster (e.g., a cluster centroid). In the latter case, a measurement of the representative of the cluster may be obtained based on a function of the measurements of the members it represents (e.g., an average of their measurements).

It is to be noted that the selector module 141 does not generate the same output for all profiles of certain users that are provided to it. That is, there are at least a first certain user and a second certain user, who have different profiles, for which the selector module 141 produces respective first and second outputs that are different. Optionally, the first output is indicative of a first selection of at least eight users from among the at least ten users, and the second output is indicative of a second selection of at least eight users from among the at least ten users, which is different from the first selection. For example, the first selection may include a user that is not included in the second selection.

The selection 143 may be provided to the collection module 120 and/or to the scoring module 150. For example, the collection module 120 may utilize the selection 143 to filter, select, and/or weight measurements of certain users, which it forwards to the scoring module 150. As explained below, the scoring module 150 may also utilize the selection 143 to perform similar actions of selecting, filtering and/or weighting measurements from among the measurements of the at least ten users which are available for it to compute the score 164′.

The scoring module 150 is configured to compute a score 164′, for the experience, for the certain user based on the measurements of the at least eight users. In this case, the score 164′ may be considered a personalized score for the certain user. When computing the scores, the scoring module 150 takes into account the selections generated by the selector module 141 based on the profile 129. In particular, at least for the first certain user and the second certain user, who have different profiles and different outputs generated by the selector module 141, the scoring module 150 computes different scores.

It is to be noted that the scoring module 150 may compute the score 164′ based on a selection 143 in various ways. In one example, the scoring module 150 may utilize measurements of the at least eight users in a similar way to the way it computes a score based on measurements of at least ten users. However, in this case it would leave out measurements of users not in the selection 143, and only use the measurements of the at least eight users. In another example, the scoring module 150 may compute the score 164′ by associating a higher weight to measurements of users that are among the at least eight users, compared to the weight it associates with measurements of users from among the at least ten users who are not among the at least eight users. In yet another example, the scoring module 150 may compute the score 164′ based on measurements of one or more cluster representatives of the clusters to which the at least eight users belong.

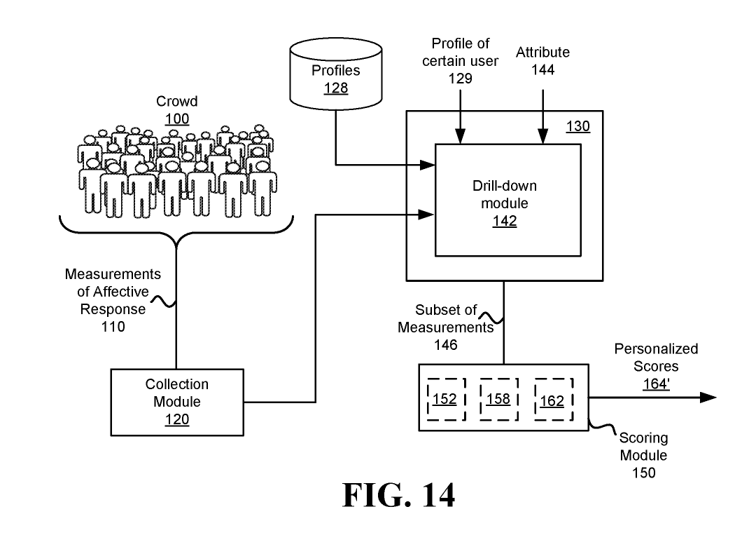

FIG. 14 illustrates a system configured to utilize comparison of profiles of users and/or selection of profiles based on attribute values, in order to compute personalized scores for an experience based on measurements of affective response of the users. The system includes at least the collection module 120, the personalization module 130, and the scoring module 150. In this embodiment, the personalization module 130 includes drill-down module 142.

In one embodiment, the drill-down module 142 serves as a filtering layer that may be part of the collection module 120 or situated after it. The drill-down module 142 receives an attribute 144 and/or a profile 129 of a certain user, and filters and/or weights the measurements of the at least ten users according to the attribute 144 and/or the profile 129 in different ways. The drill-down module 142 provides the scoring module 150 with a subset 146 of the measurement of the at least ten users, which the scoring module 150 may utilize to compute the score 164′. Thus, a drill-down may be considered a refining of a result (e.g., a score) based on a selection or weighting of the measurements according to a certain criterion.

In one example, the drill-down is performed by selecting for the subset 146 measurements of users that include the attribute 144 or have a value corresponding to a range associated with the attribute 144. For example, the attribute 144 may correspond to a certain gender and/or age group of users. In other examples, the attribute 144 may correspond to any attribute that may be included in the profiles 128. For example, the drill-down module 142 may select for the subset 146 measurements of users who have certain hobbies, have consumed certain digital content, and/or have eaten at certain restaurants.

In another example, the drill-down module 142 selects measurements of the subset 146 based on the profile 129. The drill-down module 142 may take a value of a certain attribute from the profile 129 and filter users and/or measurements based on the value of the certain attribute. Optionally, the drill-down module 142 receives an indication of which attribute to use to perform a drill-down via the attribute 144, and a certain value and/or range of values based on a value of that attribute in the profile 129. For example, the attribute 144 may indicate to perform a drill-down based on a favorite computer game, and the profile 129 includes an indication of the favorite computer game of the certain user, which is then used to filter the measurements of the at least ten users to include measurements of users who also play the certain computer game and/or for whom the certain computer game is also a favorite.

The scoring module 150 is configured, in one embodiment, to compute the score 164′ based on the measurements in the subset 146. Optionally, the subset 146 includes measurements of at least five users from among the at least ten users.

In some embodiments, systems that generate personalized crowd-based results, such as the systems illustrated in FIG. 12 to FIG. 14 may produce different results for different users based on different personalized results for the users. For example, in some embodiments, a recommender module, such as recommender module 178, may recommend an experience differently to different users because the different users received a different score for the same experience (even though the scores for the different users were computed based on the same set of measurements of at least ten users). In particular, a first user may have a first score computed for an experience while a second user may have a second score computed for the experience. The first score is such that it reaches a threshold, while the second score is lower, and does not reach the threshold. Consequently, the recommender module 178 may recommend the experience to the first user in a first manner, and to the second user in a second manner, which involves a recommendation that is not as strong as a recommendation that is made when recommending in the first manner. This may be the case, despite the first and second scores being computed around the same time and/or based on the same measurements.

Learning Function Parameters

Some embodiments in this disclosure involve functions whose targets (codomains) include values representing affective response to an experience. In various embodiments described herein, parameters of such functions are typically learned based on measurements of affective response. These functions typically describe a relationship between affective response related to an experience and a parametric value. In one example, the affective response related to an experience may be the affective response of users to the experience (e.g., as determined by measurements of the users taken with sensors while the users had the experience). In another example, the affective response related to the experience may be an aftereffect of the experience (e.g., as determined by prior and subsequent measurements of the users taken with sensors before and after the users had the experience, respectively).

In embodiments described herein, various types of domain values may be utilized for generating a function whose target includes values representing affective response to an experience. In one embodiment, the function may be a temporal function involving a domain value corresponding to a duration. This function may describe a relationship between the duration (how long) one has an experience and the expected affective response of to the experience. Another temporal domain value may be related to a duration that has elapsed since having an experience. For example, a function may describe a relationship between the time that has elapsed since having an experience and the extent of the aftereffect of the experience. In another embodiment, a domain value of a function may correspond to a period during which an experience is experienced (e.g., the time of day, the day of the week, etc.); thus, the function may be used to predict affect response to an experience based on what day a user has the experience. In still another embodiment, a domain value of a function may relate to the extent an experience has been previously experienced. In this example the function may describe the dynamics of repeated experiences (e.g., describing whether users get bored with an experience after having it multiple times). In yet another embodiment, a domain value may describe an environmental parameter (e.g., temperature, humidity, the air quality). For example, a function learned from measurements of affective response may describe the relationship between the temperature outside and how much people enjoy having certain experiences.

Below is a general discussion regarding how functions whose targets include values representing affective response to an experience may be learned from measurements of affective response. The discussion below relates to learning a function of an arbitrary domain value (e.g., one or more of the types of the domain values described above). Additionally, the function may be learned from measurements of affective response of users to experiences that may be any of the experiences described in this disclosure, such as experiences of the various types mentioned in the section “Experiences and Events” in this disclosure.

In embodiments described in this disclosure, a function whose target includes values representing affective response is characterized by one or more values of parameters (referred to as the “function parameters” and/or the “parameters of the function”). These parameters are learned from measurements of affective response of users. Optionally, the parameters of a function may include values of one or more models that are used to implement (i.e., compute) the function. Herein, “learning a function” refers to learning the function parameters that characterize the function. In such terms, “learning” may be considered to have a similar meaning to “calculating” and/or “generating”. Thus, “learning the function” may be considered equivalent to “calculating parameters that characterize the function”.

The function may be considered to be represented by a notation of the form ƒ(x) y, where y is an affective value (e.g., corresponding to a score for an experience), and x is a domain value upon which the affective value may depend (e.g., one of the domain values mentioned above). Herein, domain values that may be given as an input to a function ƒ(x) may be referred to as “input values”. In one example, “x” represents a duration of having an experience, and thus, the function ƒ(x)=y may represent affective response to an experience as a function of how long a user has the experience. In the last example, the affective value y may be referred to both as “affective response to the experience” and as “expected affective response to the experience”. The addition of the modifier “expected” is meant to indicate the affective response is a predicted value, which was not necessarily measured. However, herein the modifier “expected” may be omitted when relating to a value y of a function, without changing the meaning of the expression. In the above notation, the function ƒ may be considered to describe a relationship between x and y (e.g., a relationship between the duration of an experience and the affective response to the experience). Additionally, herein, when ƒ(x)=y this may be considered to mean that the function ƒ is indicative of the value y when the input has a value x.

It is to be noted that in the following discussion, “x” and “y” are used in their common mathematical notation roles. In descriptions of embodiments elsewhere in this disclosure, other notation may be used for values in those roles. Continuing the example given above, the “x” values may be replaced with “At” (e.g., to represent a duration of time), and the “y” values may be replaced with “v” (e.g., to represent an affective value). Thus, for example, a function describing an extent of an aftereffect to an experience based on how long it has been since a user finished having the experience, may be represented by the notation ƒ(Δt)=v.

Typically, a function of the form ƒ(x)=y may be utilized to provide values of y for at least two different values of the x in the function. The function may not necessarily describe corresponding y values to all, or even many, domain values; however, in this disclosure it is assumed that a function that is learned from measurements of affective response describes target values for at least two different domain values. For example, with a representation of functions as a (possibly infinite) set of pairs of the form (x,y), functions described in this disclosure are represented by at least two pairs (x₁,y₁) and (x₂,y₂), such that x₁≠x₂. Optionally, some functions in this disclosure may be assumed to be non-constant; in such a case, an additional assumption may be made in the latter example, which stipulates that y₁≠y₂. Optionally, when reference is made to a relationship between two or more variables described by a function, the relationship may be defined as a certain set of pairs or tuples that represent the function, such as the set of pairs of the form (x,y) described above.

It is to be noted that the functions learned based on measurements of affective response are not limited to functions of a single dimensional input. That is the domain value x in a pair of the form (x,y) mentioned above need not be a single value (e.g., a single number of category). In some embodiments, the functions may involve multidimensional inputs; thus “x” may represent a vector or some other form of a multidimensional value. Those skilled in the art may easily apply teachings in this disclosure that may be construed as relating to functions having a one-dimensional input to functions that have a multidimensional input.

Furthermore, in some embodiments, the representation of a function as having the form ƒ(x)=y is intended to signal that the dependence of the result of the function ƒ on a certain attribute x, but does not exclude the dependence of the result of the function ƒ on other attributes. In particular, the function ƒ may receive as input values additional attributes related to the user (e.g., attributes from a profile of the user, such as age, gender, and/or other attributes of profiles discussed in the section “Scoring and Personalization”) and/or attributes about the experience (e.g., level of difficulty of a game, weather at a vacation destination, etc.) Thus, in some embodiments, a function of the form fix)=y may receive additional values besides x, and consequently, may provide different target values y, for the same x, when the additional values are different. In one example, a function that computes expected affective response to an experience based on the duration (how long) a user has an experience, may also receive as input a value representing the age of the user, and thus, may return different target values for different users (of different ages) for the same duration in the input value.

In some embodiments, a certain function may be considered to behave like another function of a certain form, e.g., the form ƒ(x) y. When the certain function is said to behave like the other function of the certain form, it means that, were the inputs of the certain function projected to the domain of the other function, the resulting projection of the certain function would resemble, at least in its qualitative behavior, the behavior of the other function. For example, projecting inputs of the certain function to the plane of x, should result in a function that resembles ƒ(x) in its shape and general behavior. It is to be noted that stating that the certain function may be considered to behave like ƒ(x)=y does not imply that x need be an input of the certain function, rather, that the input of the certain function may be projected (e.g., using some form of transformation) to a value x which may be used as an input of the function ƒ.

Learning a function based on measurements of affective response may be done, in some embodiments described herein, by a function learning module, such as function learning module 280 or a function learning module denoted by another reference numeral.

The data provided to the function learning module 280 in order to learn parameters of a function typically comprises training samples of the form (x,y), where y is derived from a measurement of affective response and x is the corresponding domain value (e.g., x may be a duration of the experience to which the measurement corresponds). Since the value y in a training sample (x,y) is derived from a measurement of affective response (or may simply be a measurement of affective response that was not further processed), it may be referred to herein as “a measurement”. It is to be noted that since data provided to the function learning module 280 in embodiments described herein typically comes from multiple users, the function that is learned may be considered a crowd-based result.

In one example, a sample (x,y) provided to the function learning module 280 represents an event in which a user stayed at a hotel. In this example, x may represent the number of days a user stayed at the hotel (i.e., the duration), and y may be an affective value indicating how much the user enjoyed the stay at the hotel (e.g., y may be based on measurements of the user obtained at multiple times during the stay). In this example, the function learning module 280 may learn parameters of a function that describes the enjoyment level from staying at the hotel as a function of the duration of the stay.

There are various ways in which function learning modules described in this disclosure may be utilized to learn parameters of a function whose target includes values representing affective response to an experience. Following is a description of different exemplary approaches that may be used.

In some embodiments, the function learning module 280 utilizes an algorithm for training a predictor to learn the parameters of a function of the form ƒ(x)=y. Learning such parameters is typically performed by machine learning-based trainer 286, which typically utilizes a training algorithm to train a model for a machine learning-based predictor used predicts target values of the function (“y”) for different domain values of the function (“x”). The section “Predictors and Emotional State Estimators”, which appears above in this disclosure, includes additional information regarding various approaches known in the art that may be utilized to train a machine learning-based predictor to compute a function of the form ƒ(x)=y. Some examples of predictors that may be used for this task include regression models, neural networks, nearest neighbor predictors, support vector machines for regression, and/or decision trees.

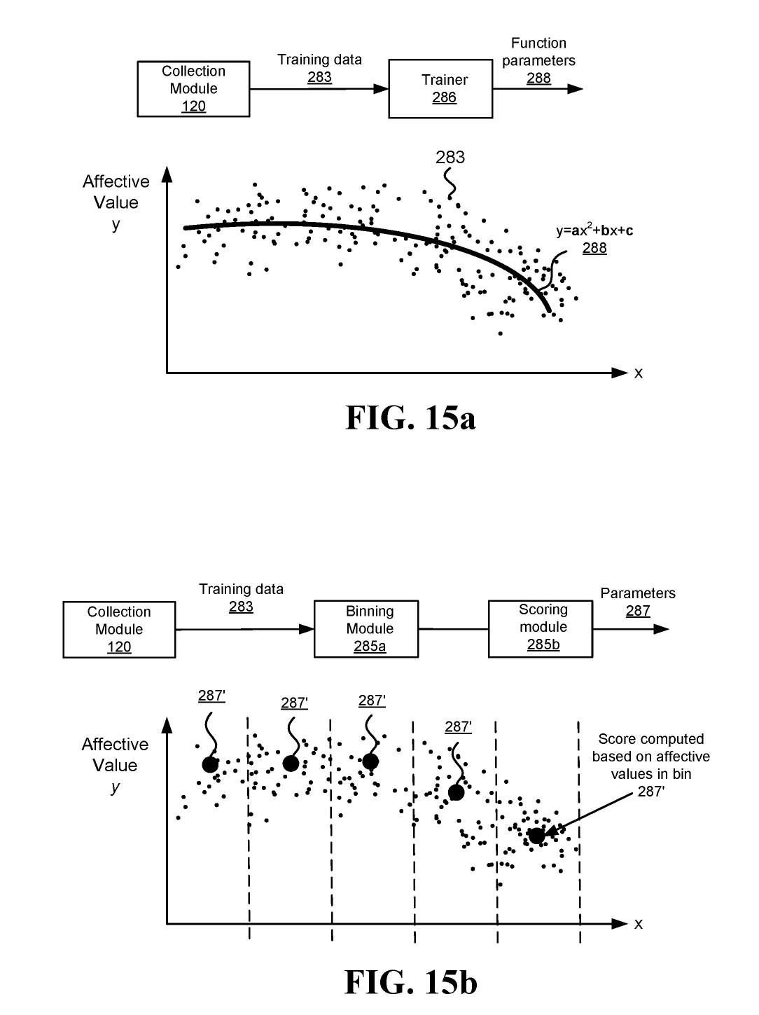

FIG. 15a illustrates one embodiment in which the machine learning-based trainer 286 is utilized to learn a function representing an expected affective response (y) that depends on a numerical value (x). For example, x may represent how long a user sits in a sauna, and y may represent how well the user is expected to feel one hour after the sauna.

The machine learning-based trainer 286 receives training data 283, which is based on events in which users have a certain experience (following the example above, each dot in between the x/y axes repents a pair of values that includes time spent by a user in the sauna (the x coordinate) and a value indicating how the user felt after an hour (the y coordinate). The training data 283 includes values derived from measurements of affective response (e.g., how a user felt after the sauna is determined by measuring the user with a sensor). The output of the machine learning-based trainer 286 includes function parameters 288 (which are illustrated by the function curve they describe). In the illustrated example, assuming the function learned by the machine learning-based trainer 286 is described as a quadratic function, the function parameters 288 may include the values of the coefficients a, b, and c corresponding to a quadratic function used to fit the training data 283. The machine learning-based trainer 286 is utilized in a similar fashion in other embodiments in this disclosure that involve learning other types of functions (with possibly other types of input data).

It is to be noted that when other types of machine-learning training algorithms are used, the function parameters 288 may be different. For example, if the machine learning-based trainer 286 utilizes a support vector machine training algorithm, the function parameters 288 may include data that describes samples from the training data that are chosen as support vectors. In another example, if the machine learning-based trainer 286 utilizes a neural network training algorithm, the function parameters 288 may include parameters of weightings of input values and/or parameters indicating a topology utilized by a neural network.

In some embodiments, some of the measurements of affective response used to derive the training data 283 may be weighted. Thus, the machine learning-based trainer 286 may utilize weighted samples to learn the function parameters 288. For example, a weighting of the measurements may be the result of an output by the personalization module 130, weighting due to the age of the measurements, and/or some other form of weighting. Learning a function when the training data is weighted is commonly known in the art, and the machine learning-based trainer 286 may be configured to handle such data if needed.

Another approach for learning functions involves binning. In some embodiments, the function learning module 280 may place measurements (or values derived from the measurements) in bins based on their corresponding domain values. Thus, for example, each training sample of the form (x,y), the value of x is used to determine what bin to place the sample in. After the training data is placed in bins, a representative value is computed for each bin; this value is computed from the y value of the samples in the bin, and typically represents some form of score for an experience. Optionally, this score may be computed by the scoring module 150.

Placing measurements into bins is typically done by a binning module (the binning module 347 or another binning module described below), which examines a value (x) associated with a measurement (y) and places it, based on the value of x, in one or more bins. For example, a binning module may place measurements into one hour bins representing the (rounded) hour during which they were taken. It is to be noted that, in some embodiments, multiple measurements may have the same associated domain value and/or a similar associated domain value and are consequently be placed in a bin together.

The number of bins in which measurements are placed may vary between embodiments. However, typically the number of bins is at least two. Additionally, bins need not have the same size. In some embodiments, bins may have different sizes (e.g., a first bin may correspond to a period of one hour, while a second bin may correspond to a period of two hours).

In some embodiments, different bins may overlap; thus, some bins may each include measurements with similar or even identical corresponding parameters values (“x” values). In other embodiments, bins do not overlap. Optionally, the different bins in which measurements may be placed may represent a partition of the space of values of the parameters (i.e., a partitioning of possible “x” values).

FIG. 15b illustrates one embodiment in which the binning approach is utilized for learning function parameters 287. The training data 283 is provided to binning module 285a, which separates the samples into different bins. In the illustration, each of the different bins falls between two vertical lines. The scoring module 285b then computes a score 287′ for each of the bins based on the measurements that were assigned to each of the bins. In this illustration, the binning module 285a may be replaced by any one of the binning modules described in this disclosure; similarly, the scoring module 285b may be replaced by another scoring module described in this disclosure (e.g., the scoring module 150). Optionally, the function parameters 287 may include scores computed by the scoring module 285b (or the module that replaces it). Additionally or alternatively, the function parameters 287 may include values indicative of the boundaries of the bins to which the binning module 285a assigns samples, such as what ranges of x values cause samples to be assigned to certain bins.

In some embodiments, some of the measurements of affective response used to compute scores for bins may have associated weights (e.g., due to weighting based on the age of the measurements and/or weights from an output of the personalization module 130). Scoring modules described in this embodiment are capable of utilizing such weights when computing scores for bins.

In some embodiments, a function whose parameters are learned by a function learning module may be displayed on the display 252, which is configured to render a representation of the function and/or its parameters. For example, the function may be rendered as a graph, plot, and/or any other image that represents values given by the function and/or parameters of the function. Optionally, when presenting personalized functions ƒ₁ and ƒ₂ to different users, a rendered representation of the function ƒ₁ that is forwarded to a first certain user is different from a rendered representation of the function ƒ₂ that is forwarded to a second certain user.

In some embodiments, function comparator 284 may receive two or more descriptions of functions and generate a comparison between the two or more functions. In one embodiment, a description of a function may include one or more values of parameters that describe the function, such as parameters of the function that were learned by the machine learning-based trainer 286. For example, the description of the function may include values of regression coefficients used by the function. In another embodiment, a description of a function may include one or more values of the function for certain input values and/or statistics regarding values the function gives to certain input values. In one example, the description of the function may include values such as pairs of the form (x,y) representing the function. In another example, the description may include statistics such as the average value y the function gives for certain ranges of values of x.

The function comparator 284 may evaluate, and optionally report, various aspects of the functions. In one embodiment, the function comparator may indicate which function has a higher (or lower) value within a certain range and/or which function has a higher (or lower) integral value over the certain range of input values. Optionally, the certain range may include input values up to a certain x value, it may include input values from a certain value x and on, and/or include input values within specified boundaries (e.g., between certain values x₁ and x₂).

Results obtained from comparing functions may be utilized in various ways. In one example, the results are forwarded to a software agent that makes a decision regarding an experience for a user (e.g., what experience to choose, which experience is better to have for a certain duration etc.) In another example, the results are forwarded and rendered on a display, such as the display 252. In still another example, the results may be forwarded to a provider of experiences, e.g., in order to determine how and/or to whom to provide experiences.

In some embodiments, the function comparator 284 may receive two or more descriptions of functions that are personalized for different users, and generate a comparison between the two or more functions. In one example, such a comparison may indicate which user is expected to have a more positive affective response under different conditions (corresponding to certain x values of the function).

Additional Considerations

FIG. 16 is a schematic illustration of a computer 400 that is able to realize one or more of the embodiments discussed herein. The computer 400 may be implemented in various ways, such as, but not limited to, a server, a client, a personal computer, a set-top box (STB), a network device, a handheld device (e.g., a smartphone), computing devices embedded in wearable devices (e.g., a smartwatch or a computer embedded in clothing), computing devices implanted in the human body, and/or any other computer form capable of executing a set of computer instructions. Further, references to a computer include any collection of one or more computers that individually or jointly execute one or more sets of computer instructions to perform any one or more of the disclosed embodiments.

The computer 400 includes one or more of the following components: processor 401, memory 402, computer-readable medium 403, user interface 404, communication interface 405, and bus 406. In one example, the processor 401 may include one or more of the following components: a general-purpose processing device, a microprocessor, a central processing unit, a complex instruction set computing (CISC) microprocessor, a reduced instruction set computing (RISC) microprocessor, a very long instruction word (VLIW) microprocessor, a special-purpose processing device, an application specific integrated circuit (ASIC), a field programmable gate array (FPGA), a digital signal processor (DSP), a distributed processing entity, and/or a network processor. Continuing the example, the memory 402 may include one or more of the following memory components: CPU cache, main memory, read-only memory (ROM), dynamic random access memory (DRAM) such as synchronous DRAM (SDRAM), flash memory, static random access memory (SRAM), and/or a data storage device. The processor 401 and the one or more memory components may communicate with each other via a bus, such as bus 406.

Still continuing the example, the communication interface 405 may include one or more components for connecting to one or more of the following: LAN, Ethernet, intranet, the Internet, a fiber communication network, a wired communication network, and/or a wireless communication network. Optionally, the communication interface 405 is used to connect with the network 112. Additionally or alternatively, the communication interface 405 may be used to connect to other networks and/or other communication interfaces. Still continuing the example, the user interface 404 may include one or more of the following components: (i) an image generation device, such as a video display, an augmented reality system, a virtual reality system, and/or a mixed reality system, (ii) an audio generation device, such as one or more speakers, (iii) an input device, such as a keyboard, a mouse, a gesture based input device that may be active or passive, and/or a brain-computer interface.

Functionality of various embodiments may be implemented in hardware, software, firmware, or any combination thereof. If implemented at least in part in software, implementing the functionality may involve a computer program that includes one or more instructions (e.g., in the form of machine code), which are stored on computer-readable medium and can be executed by one or more processors. Computer-readable media may include computer-readable storage media, which corresponds to a tangible medium such as data storage media, or communication media including any medium that facilitates transfer of a computer program from one place to another. Computer-readable medium may be any media that can be accessed by one or more computers to retrieve instructions and/or data structures for implementation of the described embodiments. A computer program product may include a computer-readable medium.

In one example, the computer-readable medium 403 may include one or more of the following: RAM, ROM, EEPROM, optical storage, magnetic storage, biologic storage, flash memory, or any other medium that can store computer-readable data. Additionally, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of a medium. It should be understood, however, that computer-readable medium does not include connections, carrier waves, signals, or other transient media, but are instead directed to non-transient, tangible storage media.

A computer program (also known as a program, software, software application, script, program code, or code) can be written in any form of programming language, including compiled or interpreted languages, declarative or procedural languages. The program can be deployed in any form, including as a standalone program or as a module, component, subroutine, object, or another unit suitable for use in a computing environment. A computer program may correspond to a file in a file system, may be stored in a portion of a file that holds other programs or data, and/or may be stored in one or more files that may be dedicated to the program. A computer program may be deployed to be executed on one or more computers that are located at one or more sites that may be interconnected by a communication network.

Computer-readable medium may include a single medium and/or multiple media (e.g., a centralized or distributed database, and/or associated caches and servers) that store the one or more sets of instructions. In various embodiments, a computer program, and/or portions of a computer program, may be stored on a non-transitory computer-readable medium. The non-transitory computer-readable medium may be implemented, for example, via one or more of a volatile computer memory, a non-volatile memory, a hard drive, a flash drive, a magnetic data storage, an optical data storage, and/or any other type of tangible computer memory to be invented that is not transitory signals per se. The computer program may be updated on the non-transitory computer-readable medium and/or downloaded to the non-transitory computer-readable medium via a communication network such as the Internet. Optionally, the computer program may be downloaded from a central repository such as Apple App Store and/or Google Play. Optionally, the computer program may be downloaded from a repository such as an open source and/or community run repository (e.g., GitHub).

At least some of the methods described in this disclosure, which may also be referred to as “computer-implemented methods”, are implemented on a computer, such as the computer 400. When implementing a method from among the at least some of the methods, at least some of the steps belonging to the method are performed by the processor 401 by executing instructions. Additionally, at least some of the instructions for running methods described in this disclosure and/or for implementing systems described in this disclosure may be stored on a non-transitory computer-readable medium.

Some of the embodiments described herein include a number of modules. Modules may also be referred to herein as “components” or “functional units”. Additionally, modules and/or components may be referred to as being “computer executed” and/or “computer implemented”; this is indicative of the modules being implemented within the context of a computer system that typically includes a processor and memory. Generally, a module is a component of a system that performs certain operations towards the implementation of a certain functionality. Examples of functionalities include receiving measurements (e.g., by a collection module), computing a score for an experience (e.g., by a scoring module), and various other functionalities described in embodiments in this disclosure. Though the name of many of the modules described herein includes the word “module” in the name (e.g., the scoring module 150), this is not the case with all modules; some names of modules described herein do not include the word “module” in their name (e.g., the profile comparator 133).

The following is a general comment about the use of reference numerals in this disclosure. It is to be noted that in this disclosure, as a general practice, the same reference numeral is used in different embodiments for a module when the module performs the same functionality (e.g., when given essentially the same type/format of data). Thus, as typically used herein, the same reference numeral may be used for a module that processes data even though the data may be collected in different ways and/or represent different things in different embodiments. For example, the reference numeral 150 is used to denote the scoring module in various embodiments described herein. The functionality may be the essentially the same in each of the different embodiments—the scoring module 150 computes a score from measurements of multiple users; however, in each embodiment, the measurements used to compute the score may be different. For example, in one embodiment, the measurements may be of users who had an experience (in general), and in another embodiment, the measurements may be of users who had a more specific experience (e.g., users who were at a hotel, users who had an experience during a certain period of time, or users who at a certain type of food). In all the examples above, the different types of measurements may be provided to the same module (possibly referred to by the same reference numeral) in order to produce a similar type of value (i.e., a score, a ranking, function parameters, a recommendation, etc.).

It is to be further noted that though the use of the convention described above that involves using the same reference numeral for modules is a general practice in this disclosure, it is not necessarily implemented with respect to all embodiments described herein. Modules referred to by different reference numerals may perform the same (or similar) functionality, and the fact that they are referred to in this disclosure by a different reference numeral does not necessarily mean that they might not have the same functionality.

Executing modules included in embodiments described in this disclosure typically involves hardware. For example, a computer system such as the computer system illustrated in FIG. 16 may be used to implement one or more modules. In another example, a module may comprise dedicated circuitry or logic that is permanently configured to perform certain operations (e.g., as a special-purpose processor, or an application-specific integrated circuit (ASIC)). Additionally or alternatively, a module may comprise programmable logic or circuitry (e.g., as encompassed within a general-purpose processor or a field programmable gate array (FPGA)) that is temporarily configured by software/firmware to perform certain operations.

In some embodiments, a module may be implemented using both dedicated circuitry and programmable circuitry. For example, a collection module may be implemented using dedicated circuitry that preprocesses signals obtained with a sensor (e.g., circuitry belonging to a device of the user) and in addition the collection module may be implemented with a general purpose processor that organizes and coalesces data received from multiple users.

It will be appreciated that the decision to implement a module in dedicated permanently configured circuitry and/or in temporarily configured circuitry (e.g., configured by software) may be driven by various considerations such as considerations of cost, time, and ease of manufacturing and/or distribution. In any case, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), not every module has to be configured or instantiated at every point in time. For example, a general-purpose processor may be configured to run different modules at different times.

In some embodiments, a processor implements a module by executing instructions that implement at least some of the functionality of the module. Optionally, a memory may store the instructions (e.g., as computer code), which are read and processed by the processor, causing the processor to perform at least some operations involved in implementing the functionality of the module. Additionally or alternatively, the memory may store data (e.g., measurements of affective response), which is read and processed by the processor in order to implement at least some of the functionality of the module. The memory may include one or more hardware elements that can store information that is accessible to a processor. In some cases, at least some of the memory may be considered part of the processor or on the same chip as the processor, while in other cases, the memory may be considered a separate physical element than the processor. Referring to FIG. 16 for example, one or more processors 401, may execute instructions stored in memory 402 (that may include one or more memory devices), which perform operations involved in implementing the functionality of a certain module.

The one or more processors 401 may also operate to support performance of the relevant operations in a “cloud computing” environment. Additionally or alternatively, some of the embodiments may be practiced in the form of a service, such Infrastructure as a Service (IaaS), Platform as a Service (PaaS), Software as a service (SaaS), and/or Network as a Service (NaaS). For example, at least some of the operations involved in implementing a module, may be performed by a group of computers accessible via a network (e.g., the Internet) and/or via one or more appropriate interfaces (e.g., Application Program Interfaces (APIs)). Optionally, some of the modules may be executed in a distributed manner among multiple processors. The one or more processors 401 may be located in a single geographic location (e.g., within a home environment, an office environment, or a server farm), and/or distributed across a number of geographic locations. Optionally, some modules may involve execution of instructions on devices that belong to the users and/or are adjacent to the users. For example, procedures that involve data preprocessing and/or presentation of results may run, in part or in full, on processors belonging to devices of the users (e.g., smartphones and/or wearable computers). In this example, preprocessed data may further be uploaded to cloud-based servers for additional processing. Additionally, preprocessing and/or presentation of results for a user may be performed by a software agent that operates on behalf of the user.

In some embodiments, modules may provide information to other modules, and/or receive information from other modules. Accordingly, such modules may be regarded as being communicatively coupled. Where multiple of such modules exist contemporaneously, communications may be achieved through signal transmission (e.g., over appropriate circuits and buses). In embodiments in which modules are configured and/or instantiated at different times, communications between such modules may be achieved, for example, through the storage and retrieval of information in memory structures to which the multiple modules have access. For example, one module may perform an operation and store the output of that operation in a memory device to which it is communicatively coupled. A different module may then, at a later time, access the memory device to retrieve and process the stored output.

It is to be noted that in the claims, when a dependent system claim is formulated according to a structure similar to the following: “further comprising module X configured to do Y”, it is to be interpreted as: “the memory is further configured to store module X, the processor is further configured to execute module X, and module X is configured to do Y”.

Modules and other system elements (e.g., databases or models) are typically illustrated in figures in this disclosure as geometric shapes (e.g., rectangles) that may be connected via lines. A line between two shapes typically indicates a relationship between the two elements the shapes represent, such as a communication that involves an exchange of information and/or control signals between the two elements. This does not imply that in every embodiment there is such a relationship between the two elements, rather, it serves to illustrate that in some embodiments such a relationship may exist. Similarly, a directional connection (e.g., an arrow) between two shapes may indicate that, in some embodiments, the relationship between the two elements represented by the shapes is directional, according the direction of the arrow (e.g., one element provides the other with information). However, the use of an arrow does not indicate that the exchange of information between the elements cannot be in the reverse direction too.

The illustrations in this disclosure depict some, but not necessarily all, the connections between modules and/or other system element. Thus, for example, a lack of a line connecting between two elements does not necessarily imply that there is no relationship between the two elements, e.g., involving some form of communication between the two. Additionally, the depiction in an illustration of modules as separate entities is done to emphasize different functionalities of the modules. In some embodiments, modules that are illustrated and/or described as separate entities may in fact be implemented via the same software program, and in other embodiments, a module that is illustrates and/or described as being a single element may in fact be implemented via multiple programs and/or involve multiple hardware elements, possibly at different locations.

With respect to computer systems described herein, various possibilities may exist regarding how to describe systems implementing a similar functionality as a collection of modules. For example, what is described as a single module in one embodiment may be described in another embodiment utilizing more than one module. Such a decision on separation of a system into modules and/or on the nature of an interaction between modules may be guided by various considerations. One consideration, which may be relevant to some embodiments, involves how to clearly and logically partition a system into several components, each performing a certain functionality. Thus, for example, hardware and/or software elements that are related to a certain functionality may belong to a single module. Another consideration that may be relevant for some embodiments, involves grouping hardware elements and/or software elements that are utilized in a certain location together. For example, elements that operate at the user end may belong to a single module, while other elements that operate on a server side may belong to a different module. Still another consideration, which may be relevant to some embodiments, involves grouping together hardware and/or software elements that operate together at a certain time and/or stage in the lifecycle of data.

As used herein, any reference to “one embodiment” or “an embodiment” means that a particular element, feature, structure, or characteristic described in connection with the embodiment is included in at least one embodiment. Moreover, separate references to “one embodiment” or “some embodiments” in this description do not necessarily refer to the same embodiment. Additionally, references to “one embodiment” and “another embodiment” may not necessarily refer to different embodiments, but may be terms used, at times, to illustrate different aspects of an embodiment. Similarly, references to “some embodiments” and “other embodiments” may refer, at times, to the same embodiments.

Herein, a predetermined value, such as a threshold, a predetermined rank, or a predetermined level, is a fixed value and/or a value determined any time before performing a calculation that compares a certain value with the predetermined value. Optionally, a first value may be considered a predetermined value when the logic (e.g., circuitry, computer code, and/or algorithm), used to compare a second value to the first value, is known before the computations used to perform the comparison are started.

Some embodiments may be described using the expression “coupled” and/or “connected”, along with their derivatives. For example, some embodiments may be described using the term “coupled” to indicate that two or more elements are in direct physical or electrical contact. The term “coupled,” however, may also mean that two or more elements are not in direct contact with each other, but yet still cooperate and/or interact with each other.

Some embodiments may be described using the verb “indicating”, the adjective “indicative”, and/or using variations thereof. Herein, sentences in the form of “X is indicative of Y” mean that X includes information correlated with Y, up to the case where X equals Y. Additionally, sentences in the form of “provide/receive an indication indicating whether X happened” refer herein to any indication method, including but not limited to: sending/receiving a signal when X happened and not sending/receiving a signal when X did not happen, not sending/receiving a signal when X happened and sending/receiving a signal when X did not happen, and/or sending/receiving a first signal when X happened and sending/receiving a second signal X did not happen.

As used herein, the terms “comprises,” “comprising,” “includes,” “including,” “has,” “having”, or any other variation thereof, indicate an open claim language that does not exclude additional limitations. As used herein “a” or “an” are employed to describe “one or more”, and reference to an element in the singular is not intended to mean “one and only one” unless specifically so stated, but rather “one or more”. Additionally, the phrase “based on” is intended to mean “based, at least in part, on”. For example, stating that a score is computed “based on measurements” means that the computation may use, in addition to the measurements, additional data that are not measurements, such as models, billing statements, and/or demographic information of users.

Though this disclosure in divided into sections having various titles, this partitioning is done just for the purpose of assisting the reader and is not meant to be limiting in any way. In particular, embodiments described in this disclosure may include elements, features, components, steps, and/or modules that may appear in various sections of this disclosure that have different titles. Furthermore, section numbering and/or location in the disclosure of subject matter are not to be interpreted as indicating order and/or importance. For example, a method may include steps described in sections having various numbers. These numbers and/or the relative location of the section in the disclosure are not to be interpreted in any way as indicating an order according to which the steps are to be performed when executing the method.

It is to be noted that essentially the same embodiments may be described in different ways. In one example, a first description of a computer system may include descriptions of modules used to implement it. A second description of essentially the same computer system may include a description of operations that a processor is configured to execute (which implement the functionality of the modules belonging to the first description). The operations recited in the second description may be viewed, in some cases, as corresponding to steps of a method that performs the functionality of the computer system. In another example, a first description of a computer-readable medium may include a description of computer code, which when executed on a processor performs operations corresponding to certain steps of a method. A second description of essentially the same computer-readable medium may include a description of modules that are to be implemented by a computer system having a processor that executes code stored on the computer-implemented medium. The modules described in the second description may be viewed, in some cases, as producing the same functionality as executing the operations corresponding to the certain steps of the method.

While the methods disclosed herein may be described and shown with reference to particular steps performed in a particular order, it is understood that these steps may be combined, sub-divided, and/or reordered to form an equivalent method without departing from the teachings of some of the embodiments. Accordingly, unless specifically indicated herein, the order and grouping of the steps is not a limitation of the embodiments. Furthermore, methods and mechanisms of some of the embodiments will sometimes be described in singular form for clarity. However, some embodiments may include multiple iterations of a method or multiple instantiations of a mechanism unless noted otherwise.

Embodiments described in conjunction with specific examples are presented by way of example, and not limitation. Moreover, it is evident that many alternatives, modifications, and variations will be apparent to those skilled in the art. It is to be understood that other embodiments may be utilized and structural changes may be made without departing from the scope of the appended claims and their equivalents.

We claim:

1. A system configured to recommend a repeated experience, comprising:
sensors configured to take measurements of affective response of users; and
a computer configured to:
collect a subset of the measurements that comprises measurements of at least five of the users who had an experience; wherein each measurement of a user is associated with a value indicative of an extent to which the user had previously experienced the experience;
calculate parameters of a function based on the measurements in the subset and their associated values; wherein the function describes, for different extents to which the experience had been previously experienced, an expected affective response to experiencing the experience again; and
responsive to determining that an expected affective response to experiencing the experience again after having experiencing it for at least a certain extent reaches a threshold, recommend the experience to a certain user.

2. The system of claim 1, wherein the experience comprises playing a game, the subset comprises measurements of affective response taken while the at least five of the users played the game, and the function describes, for different extents of having previously played the game, an expected affective response to playing the game again.

3. The system of claim 1, wherein the experience comprises utilizing a device, the subset comprises measurements of affective response taken while the at least five of the users utilized the device, and the function describes, for different extents of having previously utilized the device, an expected affective response to utilizing the device again.

4. The system of claim 1, wherein the experience comprises wearing an apparel item, the subset comprises measurements of affective response taken while the at least five of the users wore the apparel item, and the function describes, for different extents of having previously worn the apparel item, an expected affective response to wearing the apparel item again.

5. The system of claim 1, wherein the experience comprises an activity involving at least one of a certain physical exercise session and a certain biofeedback session, the subset comprises measurements of affective response the at least five of the users taken after they had the activity, and the function describe, for different extents of having performed the activity, an expected affective response after having performed the activity again.

6. The system of claim 1, wherein each measurement of a user, from among the measurements in the subset, was taken while the user had the experience, and the function describes, for different extents to which the experience had been previously experienced, an expected affective response while having the experience again.

7. The system of claim 1, wherein each measurement of a user, from among the measurements in the subset, was taken at least ten minutes after the user had the experience, and the function describes, for different extents to which the experience had been previously experienced, an expected affective response after having the experience again.

8. The system of claim 1, wherein the function is at least indicative of values v₁ and v₂ of expected affective response corresponding to extents e₁ and e₂ of previous experiencing of the experience, respectively, and e₁≠e₂ and v₁≠v₂; wherein the parameters of the function belong to a model for a predictor that predicts a value of affective response of a user based on an input indicative of an extent to which a user had previously experienced the experience; and wherein responsive to being provided inputs indicative of the extents e₁ and e₂, the predictor predicts the values v₁ and v₂, respectively.

9. The system of claim 1, wherein the function is at least indicative of values v₁ and v₂ of expected affective response corresponding to extents e₁ and e₂ of previous experiencing of the experience, respectively, and e₁≠e₂ and v₁≠v₂; and wherein the computer is configured to calculate the parameters by performing the following operations: (i) assigning measurements of affective response of users to a plurality of bins based on the values associated with the measurements;
wherein each bin corresponds to a certain range of extents of previously experiencing the experience; and (ii) calculating a plurality of scores corresponding to the plurality of bins; wherein a score corresponding to a bin is calculated based on measurements of at least three users, from the at least five of the users, selected such that associated values fall within the range corresponding to the bin; and wherein e₁ falls within a range of extents corresponding to a first bin, e₂ falls within a range of extents corresponding to a second bin, which is different from the first bin, and the values v₁ and v₂ are the scores corresponding to the first and second bins, respectively.

10. The system of claim 1, wherein the computer is further configured to: (i) receive information indicative of when the user had the experience from at least one of a financial account of a user from among the at least five of the users who had the experience and/or from a social media account of the user; and (ii) select, based on the information, at least one measurement of affective response of the user that is utilized to calculate the parameters.

11. The system of claim 1, wherein the computer is further configured to send to software agents operating on behalf of one or more of the users a request for measurements of affective response of users who had the experience; and wherein the subset comprises measurements of affective response of the one or more of the users, sent by the software agents, which the software agents determined satisfy the request.

12. The system of claim 1, wherein a measurement of affective response of a user, taken utilizing a sensor coupled to the user, comprises at least one of the following: a value representing a physiological signal of the user, and a value representing a behavioral cue of the user.

13. The system of claim 1, wherein the computer is further configured to: generate a first comparison indicative of similarities between a first profile of a first user and profiles of the at least five of the users; calculate parameters of a first function (ƒ₁) for the first user based on the first comparison and the subset; generate a second comparison indicative of similarities between a second profile of a second user, which is different from the first profile, and the profiles of the at least five of the users; and calculate a second function (ƒ₂) for the second user based on the second comparison and the subset; wherein ƒ₁ is indicative of values v₁ and v₂ of expected affective responses after extents e₁ and e₂ of having previously had the experience, respectively, and ƒ₂ is indicative of values v₃ and v₄ of expected affective responses after the having previously had the experience for the extents e₁ and e₂, respectively; and wherein e₁≠e₂, v₁≠v₂, v₃≠v₄, and v₁≠v₃.

14. A method for recommending a repeated experience, comprising:
taking, utilizing sensors, measurements of at least five users who had an experience; wherein each measurement of a user is associated with a value indicative of an extent to which the user had previously experienced the experience;
calculating parameters of a function based on the measurements and their associated values;
wherein the function describes, for different extents to which the experience had been previously experienced, an expected affective response to experiencing the experience again; and
responsive to determining that an expected affective response to experiencing the experience again after having experiencing it for at least a certain extent reaches a threshold, recommending the experience to a certain user.

15. The method of claim 14, wherein the function is indicative of values v₁ and v₂ of expected affective response corresponding to extents e₁ and e₂, respectively; wherein v₁ describes an expected affective response to experiencing the experience again, after having previously experienced the experience to the extent e₁; and v₂ describes an expected affective response to experiencing the experience again, after having previously experienced the experience to the extent e₂; and wherein e₁≠e₂ and v₁≠v₂; and further comprising calculating the parameters by utilizing the measurements and their associated values to train a model for a predictor configured to predict a value of affective response of a user to the experience based on an input indicative of a certain extent to which the experience had been previously experienced; and wherein responsive to being provided inputs indicative of the extents e₁ and e₂, the predictor predicts the affective response values v₁ and v₂, respectively.

16. The method of claim 14, wherein the function is indicative of values v₁ and v₂ of expected affective response corresponding to extents e₁ and e₂, respectively; wherein v₁ describes an expected affective response to experiencing the experience again, after having previously experienced the experience to the extent e₁; and v₂ describes an expected affective response to experiencing the experience again, after having previously experienced the experience to the extent e₂; and wherein e₁≠e₂ and v₁≠v₂; and further comprising:
assigning measurements of affective response of users to a plurality of bins based on their associated values with the measurements; wherein each bin corresponds to a certain range of extents of previously experiencing the experience; and
calculating a plurality of scores corresponding to the plurality of bins; wherein a score corresponding to a bin is calculated based on measurements more than one user, from the at least five users, for which the associated values fall within the range corresponding to the bin; and
wherein e₁ falls within a range of extents corresponding to a first bin, e₂ falls within a range of extents corresponding to a second bin, which is different from the first bin, and the values v₁ and v₂ are the scores corresponding to the first and second bins, respectively.

17. The method of claim 14, wherein the at least five users comprise at least ten users and further comprising:
generating a first comparison indicative of similarities between a first profile of a first user and profiles of the at least five of the users;
calculating parameters of a first function (ƒ₁) for the first user based on the first comparison and measurements of the at least ten users;
generating a second comparison indicative of similarities between a second profile of a second user, which is different from the first profile, and the profiles of the at least five of the users; and
calculating a second function (ƒ₂) for the second user based on the second comparison and the measurements of the at least ten users;
wherein ƒ₁ is indicative of values v₁ and v₂ of expected affective responses after extents e₁ and e₂ of having previously had the experience, respectively, and ƒ₂ is indicative of values v₃ and v₄ of expected affective responses after the having previously had the experience for the extents e₁ and e₂, respectively; and wherein e₁≠e₂, v₁≠v₂, v₃≠v₄, and v₁≠v₃.

18. The method of claim 14, further comprising: receiving information indicative of when the user had the experience from at least one of a financial account of a user from among the at least five of the users who had the experience and/or from a social media account of the user; and selecting, based on the information, at least one measurement of affective response of the user that is utilized to calculate the parameters.

19. A non-transitory computer-readable medium having instructions stored thereon that, in response to execution by a system including a processor and memory, causes the system to perform operations comprising:
taking, utilizing sensors, measurements of at least five users who had an experience; wherein each measurement of a user is associated with a value indicative of an extent to which the user had previously experienced the experience;
calculating parameters of a function based on the measurements and their associated values;
wherein the function describes, for different extents to which the experience had been previously experienced, an expected affective response to experiencing the experience again; and
responsive to determining that an expected affective response to experiencing the experience again after having experiencing it for at least a certain extent reaches a threshold, recommending the experience to a certain user.

20. The non-transitory computer-readable medium of claim 19, wherein the at least five users comprise at least ten users and further comprising additional instructions that, in response to execution, cause the system to perform operations comprising:
generating a first comparison indicative of similarities between a first profile of a first user and profiles of the at least five of the users;
calculating parameters of a first function (ƒ₁) for the first user based on the first comparison and measurements of the at least ten users;
generating a second comparison indicative of similarities between a second profile of a second user, which is different from the first profile, and the profiles of the at least five of the users; and
calculating a second function (ƒ₂) for the second user based on the second comparison and the measurements of the at least ten users;
wherein ƒ₁ is indicative of values v₁ and v₂ of expected affective responses after extents e₁ and e₂ of having previously had the experience, respectively, and ƒ₂ is indicative of values v₃ and v₄ of expected affective responses after the having previously had the experience for the extents e₁ and e₂, respectively; and wherein e₁≠e₂, v₁≠v₂, v₃≠v₄, and v₁≠v₃.
